(19) United States
(12) Patent Application Publication
(10) Pub. No.: US 2026/0198572 A1
(43) Pub. Date: Jul. 16, 2026

(54) AEROSOL-GENERATING ARTICLE COMPRISING A FRAME

(71) Applicant: Philip Morris Products S.A., Neuchatel (CH)

(72) Inventors: Matteo BOLOGNA, Lausanne (CH); Onur DAYIOGLU, Neuchatel (CH); Jean-Yves VOLLMER, Fontaines-sur-Grandson (CH)

(73) Assignee: Philip Morris Products S.A., Neuchatel (CH)

(21) Appl. No.: 19/136,953

(22) PCT Filed: Dec. 21, 2023
(86) PCT No.: PCT/EP2023/087307

§ 371 Date: Jun. 9, 2025

(30) Foreign Application Priority Data
Dec. 23, 2022 (EP) 22216422.0

(51) Int. Cl. A24F 40/42; A24B 15/12; A24F 40/20; A24F 40/30

(52) U.S. Cl. CPC A24F 40/42; A24B 15/12; A24F 40/20; A24F 40/30

(57) ABSTRACT

An aerosol-generating article for an aerosol-generating device to generate an aerosol is provided, the aerosol-generating article including: a first planar external surface; a second planar external surface; a cavity; a frame positioned between the first planar external surface and the second planar external surface, the frame at least partially defining the cavity; and one or more aerosol-generating substrates, at least one of the one or more aerosol-generating substrates having a mass of less than or equal to 500 milligrams, and the frame being made from paper, paperboard, or cardboard.

The present disclosure relates to an aerosol-generating article. The present disclosure also relates to an aerosol-generating device for use with the aerosol-generating article. The present disclosure also relates to an aerosol-generating system comprising the aerosol-generating device and the aerosol-generating article. The present disclosure also relates to a method of manufacturing the aerosol-generating article.

A typical aerosol-generating system comprises an aerosol-generating device and an aerosol-generating article comprising an aerosol-generating substrate. In use, the aerosol-generating device is arranged to heat a heating element that is positioned near, or in contact with, the aerosol-generating substrate which causes the aerosol-generating substrate to heat up and release volatile compounds. These volatile compounds are then entrained in air that is drawn through the aerosol-generating article. As the volatile compounds cool, they condense to form an aerosol that can be inhaled by a consumer.

A typical aerosol-generating article may appear similar and have similar dimensions to a conventional cigarette. For example, such an aerosol-generating article may be substantially cylindrical and comprise an aerosol-generating substrate in addition to other components such as mouthpiece filter element and a cooling element, which are arranged in the form of a rod and wrapped in a cigarette paper.

However, a significant portion of the aerosol-generating substrate in these cylindrical aerosol-generating articles may not be sufficiently heated to form an aerosol during use. This is undesirable since the insufficiently heated portion of the aerosol-generating substrate contributes to the cost of manufacture and transport of the aerosol-generating article but does not contribute to the aerosol delivered to the consumer. Moreover, the components of these cylindrical aerosol-generating articles normally need to have the same or very similar outer diameters so that they can be brought together, accurately positioned in axial alignment and wrapped in a cigarette paper. This can lead to increased cost and complexity of manufacture.

It is an objective of the present disclosure to provide an aerosol-generating article in which a greater portion of the aerosol-generating substrate is sufficiently heated to form an aerosol during use. It is also an objective of the present disclosure to provide an aerosol-generating article that can be manufactured relatively efficiently and cheaply.

According to the present disclosure, there is provided an aerosol-generating article. The aerosol-generating article may be for use with an aerosol-generating device to generate an aerosol. The aerosol-generating article comprises one or more aerosol-generating substrates. The aerosol-generating article comprises a first planar external surface and a second planar external surface.

The aerosol-generating article may comprise a cavity. The aerosol-generating article may comprise an air inlet. The aerosol-generating article may comprise an air outlet. The aerosol-generating article may comprise an airflow passage extending between the air inlet and the air outlet. The airflow passage may be positioned between the first planar external surface and the second planar external surface. The airflow passage may extend between the air inlet and the air outlet through the cavity. The aerosol-generating article may comprise a frame positioned between the first planar external surface and the second planar external surface. The frame may at least partially define the airflow passage. The frame may at least partially define the cavity.

Advantageously, the first planar external surface and the second planar external surface allow for good contact with an external heater, particularly a planar external heater, of an aerosol-generating device, thereby providing optimum heating of the aerosol-generating substrate.

Advantageously, the first planar external surface and the second planar external surface may provide a large surface area for heating by an external heater of an aerosol-generating device, thereby allowing the aerosol-generating substrate to be quickly heated to a temperature sufficient for generating an aerosol.

Advantageously, aerosol-generating articles of the present disclosure may be heated along substantially their entire length and width, thereby allowing the entire aerosol-generating substrate to be sufficiently heated to generate an aerosol.

Advantageously, aerosol-generating articles of the present disclosure may be manufactured by layering sheet materials which can be achieved through a continuous manufacturing process, thereby resulting in an aerosol-generating article that is relatively easy and cheap to manufacture.

According to the present disclosure, there is provided an aerosol-generating article. The aerosol-generating article may be for use with an aerosol-generating device to generate an aerosol. The aerosol-generating article may comprise a first planar external surface. The aerosol-generating article may comprise a second planar external surface. The aerosol-generating article may comprise a cavity. The aerosol-generating article may comprise a frame positioned between the first planar external surface and the second planar external surface. The frame may at least partially define the cavity. The aerosol-generating article may comprise one or more aerosol-generating substrates. At least one of the one or more aerosol-generating substrates may have a mass of less than or equal to 500 milligrams.

There is provided an aerosol-generating article for use with an aerosol-generating device to generate an aerosol, the aerosol-generating article comprising: a first planar external surface; a second planar external surface; a cavity; a frame positioned between the first planar external surface and the second planar external surface, the frame at least partially defining the cavity; and one or more aerosol-generating substrates. At least one of the one or more aerosol-generating substrates has a mass of less than or equal to 500 milligrams.

Advantageously, the frame may allow the aerosol-generating article to be relatively thin whilst maintaining structural rigidity.

Advantageously, providing an aerosol-generating article with a low mass of aerosol-generating substrate may result in better heating efficiency because the mass of aerosol-generating substrate to be heated is relatively low. A relatively low mass of aerosol-generating substrate is particularly advantageous during the first puff with the aerosol-generating article because the first puff can be achieved much faster than with an aerosol-generating article having a high mass of aerosol-generating substrate.

The aerosol-generating article may have a length, a width and a thickness. The aerosol-generating article may have a length extending in an x-direction. The aerosol-generating article may have a width extending in a y-direction. The aerosol-generating article may have a thickness extending in a z-direction.

The aerosol-generating article may comprise an x/y plane. The x/y plane may extend through the geometric centre of the aerosol-generating article. The x/y plane may define a plane of symmetry of the aerosol-generating article. The air inlet and air outlet may be symmetric, for example have a symmetric shape or position, about the x/y plane.

The aerosol-generating article may comprise an x/z plane. The x/z plane may extend through the geometric centre of the aerosol-generating article. The x/z plane may define a plane of symmetry of the aerosol-generating article. The air inlet and air outlet may be symmetric, for example have a symmetric shape or position, about an x/z plane.

The aerosol-generating article may comprise an y/z plane. The y/z plane may extend through the geometric centre of the aerosol-generating article. The y/z plane may define a plane of symmetry of the aerosol-generating article. The air inlet and air outlet may be symmetric, for example have a symmetric shape or positioned, about the y/z plane.

Advantageously, a symmetric aerosol-generating article or an article with a symmetrically shaped or positioned air inlet and air outlet may allow the aerosol-generating article to be inserted into an aerosol-generating device in multiple orientations.

The aerosol-generating article may be a substantially flat aerosol-generating article or a substantially planar aerosol-generating article. In particular, a thickness of the aerosol-generating article may less than 50 percent of both a length and a width of the aerosol-generating article. Advantageously, a smaller thickness may provide a small temperature gradient or difference across the thickness of the aerosol-generating substrate during heating. Advantageously, this may allow heating of a greater proportion of the aerosol-generating substrate to a temperature at which an aerosol is released whilst minimising the risk of burning the hottest portion of the aerosol-generating substrate closest to the heater. Advantageously, this may also reduce a time required to heat the aerosol-generating substrate sufficiently to release an aerosol.

The aerosol-generating article may have a 3-dimensional shape.

The aerosol-generating article may have a quadrilaterally-faced hexahedron shape. The aerosol-generating article may have a rectangular prism shape. The aerosol-generating article may have a cubic shape. The aerosol-generating article may have a cuboid shape. The aerosol-generating article may have a rectangular cuboid shape. The aerosol-generating article may have a parallelepiped shape.

The aerosol-generating article may have a cylindrical shape. The aerosol-generating article may have a right-angled cylinder shape. The aerosol-generating article may have an elliptical cylinder shape.

The aerosol-generating article may have an oblong shape.

The aerosol-generating article may have a laminated structure, for example the aerosol-generating article may comprise or be formed from at least two layers. In particular, the aerosol-generating article may comprise at least two of: a first external layer, a second external layer, a frame, a first frame layer, a second frame layer, a third frame layer, a first aerosol-generating substrate layer, and a second aerosol-generating substrate layer as discussed in more detail below.

At least 50% of the mass of the aerosol-generating article, excluding the one or more aerosol-generating substrates, may be paper or cardboard. At least 55% of the mass of the aerosol-generating article, excluding the one or more aerosol-generating substrates, may be a cellulosic material. At least 60% of the mass of the aerosol-generating article, excluding the one or more aerosol-generating substrates, may be a cellulosic material. At least 65% of the mass of the aerosol-generating article, excluding the one or more aerosol-generating substrates, may be a cellulosic material. At least 70% of the mass of the aerosol-generating article, excluding the one or more aerosol-generating substrates, may be a cellulosic material. At least 75% of the mass of the aerosol-generating article, excluding the one or more aerosol-generating substrates, may be a cellulosic material. At least 80% of the mass of the aerosol-generating article, excluding the one or more aerosol-generating substrates, may be a cellulosic material. At least 85% of the mass of the aerosol-generating article, excluding the one or more aerosol-generating substrates, may be a cellulosic material. At least 90% of the mass of the aerosol-generating article, excluding the one or more aerosol-generating substrates, may be a cellulosic material.

At least 50% of the mass of the aerosol-generating article, excluding the one or more aerosol-generating substrates, may be paper or cardboard. At least 55% of the mass of the aerosol-generating article, excluding the one or more aerosol-generating substrates, may be paper or cardboard. At least 60% of the mass of the aerosol-generating article, excluding the one or more aerosol-generating substrates, may be paper or cardboard. At least 65% of the mass of the aerosol-generating article, excluding the one or more aerosol-generating substrates, may be paper or cardboard. At least 70% of the mass of the aerosol-generating article, excluding the one or more aerosol-generating substrates, may be paper or cardboard. At least 75% of the mass of the aerosol-generating article, excluding the one or more aerosol-generating substrates, may be paper or cardboard. At least 80% of the mass of the aerosol-generating article, excluding the one or more aerosol-generating substrates, may be paper or cardboard. At least 85% of the mass of the aerosol-generating article, excluding the one or more aerosol-generating substrates, may be paper or cardboard. At least 90% of the mass of the aerosol-generating article, excluding the one or more aerosol-generating substrates, may be paper or cardboard.

Substantially the entirety of the aerosol-generating article, excluding the one or more aerosol-generating substrates and (if present) adhesive, may be paper or cardboard.

The aerosol-generating article may have a cellulose acetate content of less than 5 percent. The aerosol-generating article may have a cellulose acetate content of less than 3 percent. The aerosol-generating article may have a cellulose acetate content of less than 1 percent.

The frame may be a planar frame.

The frame may define a frame aperture extending through the thickness of the frame. The frame aperture may define or form the airflow passage of the aerosol-generating article. The frame aperture may define or form the cavity of the aerosol-generating article. For example, the frame may have a hollow cuboid shape or a square hollow tube shape. As a further example, the frame may have a cross-section that is annular in shape, preferably the cross-section in an x/y plane is annular in shape. The cross-section may have an annulus shape, such as a circular annulus shape, an elliptical annulus shape, a rectangular annulus shape, or a square annulus shape.

The frame may comprise a frame outer surface. The frame outer surface may extend in a transverse direction, for example between the first planar external surface and the second planar external surface. The frame outer surface may at least partially define or form one or more external surfaces of the aerosol-generating article. For example, the frame outer surface may at least partially define or form one or more external walls of the aerosol-generating article. The frame outer surface may circumscribe or encircle the frame aperture. The frame outer surface may circumscribe or encircle the cavity.

The frame may comprise a frame inner surface. The frame inner surface may extend in a transverse direction, for example between the first planar external surface and the second planar external surface. The frame inner surface may define or form a frame aperture outer wall. The frame inner surface may define or form a cavity outer wall. The frame inner surface may circumscribe or encircle the frame aperture extending through the thickness of the frame. The frame outer surface may circumscribe or encircle the cavity.

The frame outer surface may circumscribe or encircle the frame inner surface. The frame inner surface and the frame outer surface may be concentric with one another.

The frame may define or form at least 75 percent of a perimeter of any cross-section, in an x/y plane, of the aerosol-generating article that extends through the frame. The frame may define or form at least 80 percent of a perimeter of any cross-section, in an x/y plane, of the aerosol-generating article that extends through the frame. The frame may define or form at least 85 percent of a perimeter of any cross-section, in an x/y plane, of the aerosol-generating article that extends through the frame. The frame may define or form at least 90 percent of a perimeter of any cross-section, in an x/y plane, of the aerosol-generating article that extends through the frame. The frame may define or form at least 95 percent of a perimeter of any cross-section, in an x/y plane, of the aerosol-generating article that extends through the frame. The frame may define or form at least 99 percent of a perimeter of any cross-section, in an x/y plane, of the aerosol-generating article that extends through the frame.

Advantageously, providing a frame that forms at least 75 percent of a perimeter of any cross-section, in an x/y plane, of the aerosol-generating article that extends through the frame means that the frame extends around a significant portion of the aerosol-generating article. Therefore, the frame can provide the aerosol-generating article with good structural support.

Advantageously, providing a frame that forms at least 75 percent of a perimeter of any cross-section, in an x/y plane, of the aerosol-generating article that extends through the frame may mean that any air inlet or air outlet defined through the article is of a size that provides the aerosol-generating article with a satisfactory resistance to draw.

Advantageously, in embodiments in which an aerosol-generating substrate is positioned within the cavity, providing a frame that forms at least 75 percent of a perimeter of any cross-section, in an x/y plane, of the aerosol-generating article that extends through the frame may allow the frame to act as a barrier that prevents egress of the aerosol-generating substrate from the aerosol-generating article.

The aerosol-generating article may comprise a cross-section in a first x/y plane that extends through the frame. The frame may form at least 99 percent of a perimeter of the cross-section in the first x/y plane. The frame may form at least 100 percent of the perimeter of the cross-section in the first x/y plane.

The aerosol-generating article may comprise a cross-section in a second x/y plane, spaced from the first x/y plane in the z-direction, that extends through the frame. The frame may form at least 99 percent of a perimeter of the cross-section in the second x/y plane. The frame may form 100 percent of the perimeter of the cross-section in the second x/y plane.

The air inlet may be positioned, in the z-direction, between the first x/y plane and the second x/y plane. The air outlet may be positioned, in the z-direction, between the first x/y plane and the second x/y plane.

The frame may comprise a first portion that is at least 30 percent of a thickness of the frame. The first portion may be at least 50 percent of the thickness of the frame. The first portion may be at least 70 percent of the thickness of the frame. The first portion may be at least 90 percent of the thickness of the frame. The frame forms 100 percent of a perimeter of any cross-section, in an x/y plane, of the aerosol-generating article that extends through the first portion of the frame.

The aerosol-generating article may comprise one or more external walls extending between the first planar external surface and the second planar external surface. The one or more external walls may collectively define an entire transverse external area of the aerosol-generating article. The frame may at least partially define each of the one or more external walls.

The one or more external walls may circumscribe or encircle the cavity.

The frame may define at least 60 percent of the entire transverse external area of the aerosol-generating article. The frame may define at least 60 percent of the entire transverse external area of the aerosol-generating article. The frame may define at least 70 percent of the entire transverse external area of the aerosol-generating article. The frame may define at least 80 percent of the entire transverse external area of the aerosol-generating article. The frame may define at least 90 percent of the entire transverse external area of the aerosol-generating article.

The frame may comprise a peripheral wall. The peripheral wall may circumscribe or encircle at least a portion of the frame aperture extending through the thickness of the frame. The peripheral wall may circumscribe or encircle at least a portion of the cavity. The peripheral wall may circumscribe or encircle the frame aperture extending through the thickness of the frame. The peripheral wall may circumscribe or encircle the cavity. Advantageously, such a peripheral wall allows for a relatively large internal volume for an aerosol-generating substrate or aerosol formation whilst providing the structural strength to maintain the shape of the aerosol-generating article.

The peripheral wall may be defined or formed by the frame outer surface and the frame inner surface. The peripheral wall may at least partially define or form one or more external surfaces or walls of the aerosol-generating article. The peripheral wall may define or form a frame aperture outer wall. The peripheral wall may define or form a cavity outer wall.

The peripheral wall may have a radial thickness. The radial thickness may be defined as the minimum distance between the frame outer surface and the frame inner surface, such as in the x/y plane.

The peripheral wall may have a radial thickness greater than or equal to 0.5 millimetres. The peripheral wall may have a radial thickness greater than or equal to 1 millimetre. The peripheral wall may have a radial thickness greater than or equal to 1.5 millimetres. The peripheral wall may have a radial thickness greater than or equal to 2 millimetres. The peripheral wall may have a radial thickness greater than or equal to 2.5 millimetres.

The peripheral wall may have a radial thickness less than or equal to 4 millimetres. The peripheral wall may have a radial thickness less than or equal to 3.5 millimetres. The peripheral wall may have a radial thickness less than or equal to 3 millimetres. The peripheral wall may have a radial thickness less than or equal to 2.5 millimetres. The peripheral wall may have a radial thickness less than or equal to 2 millimetres.

The peripheral wall may have a radial thickness between 0.5 millimetres and 3.5 millimetres. The peripheral wall may have a radial thickness between 0.5 millimetres and 3 millimetres. The peripheral wall may have a radial thickness between 0.5 millimetres and 2.5 millimetres. The peripheral wall may have a radial thickness between 1 millimetre and 3 millimetres. The peripheral wall may have a radial thickness between 1 millimetres and 2 millimetres. Advantageously, the peripheral wall having a radial thickness between 0.5 millimetres and 3.5 millimetres has been found to provide good structural strength for the aerosol-generating article whilst not using excess amounts of material which may increase manufacturing costs. Advantageously, a radial thickness between 0.5 millimetres and 3.5 millimetres may limit the amount of heat that is undesirably transferred to the frame rather than the aerosol-generating substrate.

The frame may be made from or comprise a biodegradable material. The frame may be made entirely from a biodegradable material.

The frame may be made from or comprise a cellulosic material. The cellulosic material may comprise a sheet of cellulosic material. The cellulosic material may comprise cellulose fibres. The cellulosic material may be paper, paperboard, or cardboard. The frame may be made from or comprise a plant material, such as tobacco. The frame may be made entirely from a cellulosic material.

The cellulosic material may have a grammage greater than or equal to 300 grams per square metre. The cellulosic material may have a grammage greater than or equal to 350 grams per square metre. The cellulosic material may have a grammage greater than or equal to 390 grams per square metre. The cellulosic material may have a grammage greater than or equal to 420 grams per square metre. The cellulosic material may have a grammage greater than or equal to 620 grams per square metre. The cellulosic material may have a grammage greater than or equal to 720 grams per square metre. The cellulosic material may have a grammage greater than or equal to 800 grams per square metre.

The cellulosic material may have a grammage less than or equal to 900 grams per square metre. The cellulosic material may have a grammage less than or equal to 800 grams per square metre. The cellulosic material may have a grammage less than or equal to 720 grams per square metre. The cellulosic material may have a grammage less than or equal to 620 grams per square metre. The cellulosic material may have a grammage less than or equal to 420 grams per square metre. The cellulosic material may have a grammage less than or equal to 390 grams per square metre. The cellulosic material may have a grammage less than or equal to 350 grams per square metre.

The cellulosic material may have a grammage between 300 grams per square metre and 900 grams per square metre. The cellulosic material may have a grammage between 300 grams per square metre and 800 grams per square metre. The cellulosic material may have a grammage between 350 grams per square metre and 800 grams per square metre. The cellulosic material may have a grammage between 400 grams per square metre and 700 grams per square metre. The frame may be made from or comprise a fibrous material. The frame may be made from one or more of: natural fibres, synthetic fibres, polyester, bonded polyolefin, polyethylene, terylene, polypropylene, biopolymer fibres, nylon fibres, and ceramic fibres. The frame may comprise cellulosic fibres.

The frame may comprise a hydrophobic region. The hydrophobic region may comprise hydrophobic groups covalently bonded to the frame. The hydrophobic region may be positioned on, or form, at least a portion of the frame inner surface. Advantageously, a hydrophobic region may prevent or limit degradation of the frame in regions where the frame is regularly in contact with aerosol or liquids from the aerosol-generating substrate.

The hydrophobic region may be produced by a process comprising the steps of: applying a liquid composition comprising a fatty acid halide to a surface of the frame and maintaining the surface at a temperature of about 120 degrees Celsius to about 180 degrees Celsius. The fatty acid halide reacts in situ with protogenic groups of material in the hydrophobic region resulting in the formation of fatty acid esters.

The hydrophobic region may have a Cobb water absorption (ISO 535:1991) value (at 60 seconds) less than or equal to 40 grams per square metre. The hydrophobic region may have a Cobb water absorption (ISO 535:1991) value (at 60 seconds) of less than or equal to 35 grams per square metre. The hydrophobic region may have a Cobb water absorption (ISO 535:1991) value (at 60 seconds) less than or equal to 30 grams per square metre. The hydrophobic region may have a Cobb water absorption (ISO 535:1991) value (at 60 seconds) less than or equal to about 25 grams per square metre.

The hydrophobic region may have a water contact angle of greater than or equal to about 90 degrees. The hydrophobic region may have a water contact angle of greater than or equal to about 95 degrees. The hydrophobic region may have a water contact angle of greater than or equal to about 100 degrees. The hydrophobic region may have a water contact angle of greater than or equal to about 110 degrees. The hydrophobic region may have a water contact angle of greater than or equal to about 120 degrees. The hydrophobic region may have a water contact angle of greater than or equal to about 130 degrees. The hydrophobic region may have a water contact angle of greater than or equal to about 140 degrees. The hydrophobic region may have a water contact angle of greater than or equal to about 150 degrees. The hydrophobic region may have a water contact angle of greater than or equal to about 160 degrees. The hydrophobic region may have a water contact angle of greater than or equal to about 170 degrees.

Hydrophobicity is determined by utilizing the TAPPI T558 om-97 test and the result is presented as an interfacial contact angle and reported in “degrees” and can range from near zero degrees to near 180 degrees. Where no contact angle is specified along with the term hydrophobic, the water contact angle is at least 90 degrees.

The hydrophobic region may have a water contact angle of greater than or equal to 90 degrees and a Cobb water absorption (ISO 535:1991) value (at 60 seconds) less than or equal to 40 grams per square metre.

The aerosol-generating article may comprise one or more susceptor materials. The frame may comprise one or more susceptor materials. The one more susceptor materials may be in thermal contact with the aerosol-generating substrate. The one more susceptor materials may be in thermal contact with the airflow passage. The one more susceptor materials may be in thermal contact with the cavity. The one or more susceptor materials may be positioned in or on the frame inner surface. The one or more susceptor materials may be incorporated within the material of the frame. For example, the one or more susceptor material may be incorporated within the peripheral wall of the frame. Advantageously, the presence of one or more susceptor materials may allow the aerosol-generating article, and thus the aerosol-generating substrate, to be heated by engagement with a fluctuating electromagnetic field formed by an inductor.

The one or more susceptor materials may be one or more particles, strips, threads, or wires of susceptor material. The one or more susceptor materials may be one or more sheets or layers of susceptor material. The one of more sheets or layers of susceptor material may be in the form of a mesh of susceptor material.

The susceptor material, in whatever form, may comprise one or more materials selected from the list consisting of: aluminium, iron and iron alloys, nickel and nickel alloys, cobalt alloys, stainless steel alloys, copper alloys, carbon, expanded carbon, and graphite.

The frame may have a thickness greater than or equal to 50 percent of the thickness of the aerosol-generating article. The frame may have a thickness greater than or equal to 60 percent of the thickness of the aerosol-generating article. The frame may have a thickness greater than or equal to 70 percent of the thickness of the aerosol-generating article. The frame may have a thickness greater than or equal to 80 percent of the thickness of the aerosol-generating article. The frame may have a thickness greater than or equal to 90 percent of the thickness of the aerosol-generating article. The frame may have a thickness greater than or equal to 95 percent of the thickness of the aerosol-generating article.

The frame may have a thickness less than or equal to 95 percent of the thickness of the aerosol-generating article. The frame may have a thickness less than or equal to 90 percent of the thickness of the aerosol-generating article. The frame may have a thickness less than or equal to 80 percent of the thickness of the aerosol-generating article. The frame may have a thickness less than or equal to 70 percent of the thickness of the aerosol-generating article.

The frame may have a thickness between 50 percent of the thickness of the aerosol-generating article and 95 percent of the thickness of the aerosol-generating article. The frame may have a thickness between 60 percent of the thickness of the aerosol-generating article and 95 percent of the thickness of the aerosol-generating article. The frame may have a thickness between 70 percent of the thickness of the aerosol-generating article and 95 percent of the thickness of the aerosol-generating article. The frame may have a thickness between 80 percent of the thickness of the aerosol-generating article and 95 percent of the thickness of the aerosol-generating article.

The frame may have a thickness greater than or equal to 1 millimetre. The frame may have a thickness greater than or equal to 1.5 millimetres. The frame may have a thickness greater than or equal to 2 millimetres. The frame may have a thickness greater than or equal to 2.5 millimetres. The frame may have a thickness greater than or equal to 3 millimetres. The frame may have a thickness greater than or equal to 3.5 millimetres. The frame may have a thickness greater than or equal to 4 millimetres. The frame may have a thickness greater than or equal to 4.5 millimetres.

The frame may have a thickness less than or equal to 5.5 millimetres. The frame may have a thickness less than or equal to 5 millimetres. The frame may have a thickness less than or equal to 4.5 millimetres. The frame may have a thickness less than or equal to 4 millimetres. The frame may have a thickness less than or equal to 3.5 millimetres. The frame may have a thickness less than or equal to 3 millimetres. The frame may have a thickness less than 2.5 millimetres. The frame may have a thickness less than 2 millimetres. The frame may have a thickness less than 1.5 millimetres.

The frame may have a thickness between 1 millimetre and 5.5 millimetres. The frame may have a thickness between 1 millimetre and 5 millimetres. Preferably, the frame may have a thickness between 1.5 millimetres and 5 millimetres.

The frame may have a length that is equal to the length of the aerosol-generating article. The frame may have a length that is at least 90 percent of the length of the aerosol-generating article. The frame may have a length that is at least 95 percent of the length of the aerosol-generating article.

The frame may have a width that is equal to the width of the aerosol-generating article. The frame may have a width that is at least 90 percent of the width of the aerosol-generating article. The frame may have a width that is at least 90 percent of the width of the aerosol-generating article. The frame may be a unitary component. Alternatively, the frame may comprise two or more layers. That is, the frame may have a laminated structure. Advantageously, the properties of each layer may be individually optimised depending on the relative distance between the layer and aerosol-generating substrate or heater of the aerosol-generating device. Advantageously, the use of two or more layers allows producing, and rapidly adjusting, the desired thickness of the frame by adding or removing layers of sheet material. This may prevent the need to manufacture a single sheet of material having the desired thickness of the frame, which may subsequently need to be changed when the desired thickness of the frame changes.

The frame may comprise a first frame layer and a second frame layer. The first frame layer and the second frame layer may be the only layers of the frame. That is, the frame may comprise no more than two layers or may comprise exactly two layers. The first frame layer may be an upper frame layer and the second frame layer may be a lower frame layer.

The frame may have a thickness equal to a sum of a thickness of the first frame layer and a thickness of the second frame layer. The frame aperture may be defined through both the first frame layer and the second frame layer.

The frame may comprise a first frame layer, a second frame layer and a third frame layer. The second frame layer may be positioned between the first frame layer and the third frame layer. The first frame layer, the second frame layer and the third frame layer may be the only layers of the frame. That is, the frame may comprise no more than three layers or may comprise exactly three layers. The first frame layer may be an upper frame layer, the second frame layer may be an intermediate frame layer, and the third frame layer may be a lower frame layer.

The first frame layer may be in physical contact with the second frame layer. The first frame layer may be may be bonded to the second frame layer with an adhesive. A lower surface of the first frame layer may be bonded to an upper surface of the second frame layer with an adhesive. The adhesive may extend at least 90% around the periphery of the intersection between the first frame layer and the second frame layer. The adhesive may extend at least 95% around the periphery of the intersection between the first frame layer and the second frame layer. The adhesive may extend at least 99% around the periphery of the intersection between the first frame layer and the second frame layer.

The second frame layer may be in physical contact with the third frame layer. The second frame layer may be bonded to the third frame layer with an adhesive. A lower surface of the second frame layer may be bonded to an upper surface of the third frame layer with an adhesive. The adhesive may extend at least 90% around the periphery of the intersection between the second frame layer and the third frame layer. The adhesive may extend at least 95% around the periphery of the intersection between the second frame layer and the third frame layer. The adhesive may extend at least 99% around the periphery of the intersection between the second frame layer and the third frame layer.

The frame may have a thickness equal to a sum of a thickness of the first frame layer, a thickness of the second frame layer and a thickness of the third frame layer. The frame aperture may be defined through the first planar layer, the second planar layer and the third frame layer.

The first frame layer may be planar.

The first frame layer may define a first frame layer aperture extending through the thickness of the first frame layer. The first frame layer aperture may at least partially define or form the cavity of the aerosol-generating article. For example, the first frame layer may have a hollow cuboid shape or a square hollow tube shape. As a further example, the first frame layer may have a cross-section that is annular in shape, preferably the cross-section in x/y plane is annular in shape. The cross-section may have an annulus shape, such as a circular annulus shape, an elliptical annulus shape, a rectangular annulus shape, or a square annulus shape.

The first frame layer may comprise a first frame layer outer surface. The first frame layer outer surface may extend in a transverse direction, for example between the first planar external surface and the second planar external surface. The first frame layer outer surface may at least partially define or form one or more external surfaces of the aerosol-generating article. For example, the first frame layer outer surface may at least partially define or form one or more external walls of the aerosol-generating article. The first frame layer outer surface may circumscribe or encircle one or both: the first frame layer aperture and the frame aperture. The first frame layer outer surface may circumscribe or encircle the cavity.

The first frame layer may comprise a first frame layer inner surface. The first frame layer inner surface may extend in a transverse direction, for example between the first planar external surface and the second planar external surface. The first frame layer inner surface may define or form a first frame layer aperture outer wall. The first frame layer inner surface may at least partially define or form a cavity outer wall. The first frame layer inner surface may circumscribe or encircle one or both the first frame layer aperture and the frame aperture. The first frame layer outer surface may circumscribe or encircle the cavity.

The first frame layer outer surface may circumscribe or encircle the first frame layer inner surface. The first frame layer inner surface and the first frame layer outer surface may be concentric with one another.

The first frame layer may comprise a first frame layer peripheral wall. The first frame layer peripheral wall may circumscribe or encircle one or both of: the frame aperture and the first frame layer aperture. The first frame layer peripheral wall may circumscribe or encircle the cavity.

The first frame layer peripheral wall may be defined or formed by the first frame layer outer surface and the first frame layer inner surface. The first frame layer peripheral wall may at least partially define or form one or more external surfaces or walls of the aerosol-generating article. The first frame layer peripheral wall may at least partially define or form the first frame layer aperture outer wall. The first frame layer peripheral wall may at least partially define or form the cavity outer wall.

The first frame layer may be made from or comprise any of the materials described above in relation to the frame. For example, the first frame layer may comprise the one or more susceptor materials.

The first frame layer may be made from or comprise a biodegradable material. The first frame layer may be entirely made from biodegradable material.

The first frame layer may be made from or comprise a cellulosic material. The cellulosic material may comprise a sheet of cellulosic material. The cellulosic material may comprise cellulosic fibres. The cellulosic material may be paper, paperboard, or cardboard. The first frame layer may be made from or comprise a plant material, such as tobacco. The first frame layer may be made entirely from a cellulosic material.

The cellulosic material may have any grammage or range of grammages as described above in relation to the frame.

The first frame layer may be made from a fibrous material. The first frame layer may be made from one or more of: natural fibres, synthetic fibres, polyester, bonded polyolefin, polyethylene, terylene, polypropylene, biopolymer fibres, nylon fibres, and ceramic fibres.

Where the frame comprises exactly two layers, the thickness of the first frame layer may be half (50 percent) the thickness of the frame. The first frame layer may have a thickness substantially the same as the second frame layer. Where the frame comprises exactly three layers, the thickness of the first frame layer may be one third (33.33 percent) the thickness of the frame. The first frame layer may have a thickness substantially the same as each of the second frame layer and the third frame layer.

The first frame layer may have a thickness greater than or equal to 0.5 millimetres. The frame may have a thickness greater than or equal to 1 millimetre. The first frame layer may have a thickness greater than or equal to 1.5 millimetres. The first frame layer may have a thickness greater than or equal to 2 millimetres. The first frame layer may have a thickness greater than or equal to 2.5 millimetres.

The first frame layer may have a thickness less than or equal to 3 millimetres. The first frame layer may have a thickness less than or equal to 2.5 millimetres. The first frame layer may have a thickness less than or equal to 2 millimetres. The first frame layer may have a thickness less than or equal to 1.5 millimetres. The first frame layer may have a thickness less than or equal to 1 millimetres.

The first frame layer may have a thickness between 0.5 millimetres and 3 millimetres. The first frame layer may have a thickness between 0.5 millimetres and 2.5 millimetres. The first frame layer may have a thickness between 1 millimetres and 2.5 millimetres.

The second frame layer may be planar.

The second frame layer may define a second frame layer aperture extending through the thickness of the second frame layer. The second frame layer aperture may at least partially define or form the cavity of the aerosol-generating article. For example, the second frame layer may have a hollow cuboid shape or a square hollow tube shape. As a further example, the second frame layer may have a cross-section that is annular in shape, preferably the cross-section in x/y plane is annular in shape. The cross-section may have an annulus shape, such as a circular annulus shape, an elliptical annulus shape, a rectangular annulus shape, or a square annulus shape.

The second frame layer may comprise a second frame layer outer surface. The second frame layer outer surface may extend in a transverse direction, for example between the second planar external surface and the second planar external surface. The second frame layer outer surface may at least partially define or form one or more external surfaces of the aerosol-generating article. For example, the second frame layer outer surface may at least partially define or form one or more external walls of the aerosol-generating article. The second frame layer outer surface may circumscribe or encircle one or both: the second frame layer aperture and the frame aperture. The second frame layer outer surface may circumscribe or encircle the cavity.

The second frame layer may comprise a second frame layer inner surface. The second frame layer inner surface may extend in a transverse direction, for example between the second planar external surface and the second planar external surface. The second frame layer inner surface may define or form a second frame layer aperture outer wall. The second frame layer inner surface may at least partially define or form a cavity outer wall. The second frame layer inner surface may circumscribe or encircle one or both the second frame layer aperture and the frame aperture. The second frame layer outer surface may circumscribe or encircle the cavity.

The second frame layer outer surface may circumscribe or encircle the second frame layer inner surface. The second frame layer inner surface and the second frame layer outer surface may be concentric with one another.

The second frame layer may comprise a second frame layer peripheral wall. The second frame layer peripheral wall may circumscribe or encircle one or both of: the frame aperture and the second frame layer aperture. The second frame layer peripheral wall may circumscribe or encircle the cavity.

The second frame layer peripheral wall may be defined or formed by the second frame layer outer surface and the second frame layer inner surface. The second frame layer peripheral wall may at least partially define or form one or more external surfaces or walls of the aerosol-generating article. The second frame layer peripheral wall may at least partially define or form the second frame layer aperture outer wall. The second frame layer peripheral wall may at least partially define or form the cavity outer wall.

The second frame layer may be made from or comprise any of the materials described above in relation to the frame. For example, the second frame layer may comprise the one or more susceptor materials.

The second frame layer may be made from or comprise a biodegradable material. The second frame layer may be entirely made from biodegradable material.

The second frame layer may be made from or comprise a cellulosic material. as the cellulosic material may comprise a sheet of cellulosic material. The cellulosic material may be paper, paperboard, or cardboard. The second frame layer may be made from or comprise a plant material, such as tobacco. The second frame layer may be made entirely from a cellulosic material.

The cellulosic material may have any grammage or range of grammages as described above in relation to the frame.

The second frame layer may be made from a fibrous material. The second frame layer may be made from one or more of: natural fibres, synthetic fibres, polyester, bonded polyolefin, polyethylene, terylene, polypropylene, biopolymer fibres, nylon fibres, and ceramic fibres.

Where the frame comprises exactly two layers, the thickness of the second frame layer may be half (50 percent) the thickness of the frame. The second frame layer may have a thickness substantially the same as the first frame layer. Where the frame comprises exactly three layers, the thickness of the second frame layer may be one third (33.33 percent) the thickness of the frame. The second frame layer may have a thickness substantially the same as the first frame layer and the third frame layer.

The second frame layer may have a thickness greater than or equal to 0.5 millimetres. The frame may have a thickness greater than or equal to 1 millimetre. The second frame layer may have a thickness greater than or equal to 1.5 millimetres. The second frame layer may have a thickness greater than or equal to 2 millimetres. The second frame layer may have a thickness greater than or equal to 2.5 millimetres.

The second frame layer may have a thickness less than or equal to 3 millimetres. The second frame layer may have a thickness less than or equal to 2.5 millimetres. The second frame layer may have a thickness less than or equal to 2 millimetres. The second frame layer may have a thickness less than or equal to 1.5 millimetres. The second frame layer may have a thickness less than or equal to 1 millimetres.

The second frame layer may have a thickness between 0.5 millimetres and 3 millimetres. The second frame layer may have a thickness between 0.5 millimetres and 2.5 millimetres. The second frame layer may have a thickness between 1 millimetres and 2.5 millimetres.

The third frame layer may be planar.

The third frame layer may define a third frame layer aperture extending through the thickness of the third frame layer. The third frame layer aperture may at least partially define or form the cavity of the aerosol-generating article. For example, the third frame layer may have a hollow cuboid shape or a square hollow tube shape. As a further example, the third frame layer may have a cross-section that is annular in shape, preferably the cross-section in x/y plane is annular in shape. The cross-section may have an annulus shape, such as a circular annulus shape, an elliptical annulus shape, a rectangular annulus shape, or a square annulus shape.

The third frame layer may comprise a third frame layer outer surface. The third frame layer outer surface may extend in a transverse direction, for example between the third planar external surface and the third planar external surface. The third frame layer outer surface may at least partially define or form one or more external surfaces of the aerosol-generating article. For example, the third frame layer outer surface may at least partially define or form one or more external walls of the aerosol-generating article. The third frame layer outer surface may circumscribe or encircle one or both: the third frame layer aperture and the frame aperture. The third frame layer outer surface may circumscribe or encircle the cavity.

The third frame layer may comprise a third frame layer inner surface. The third frame layer inner surface may extend in a transverse direction, for example between the third planar external surface and the third planar external surface. The third frame layer inner surface may define or form a third frame layer aperture outer wall. The third frame layer inner surface may at least partially define or form a cavity outer wall. The third frame layer inner surface may circumscribe or encircle one or both the third frame layer aperture and the frame aperture. The third frame layer outer surface may circumscribe or encircle the cavity.

The third frame layer outer surface may circumscribe or encircle the third frame layer inner surface. The third frame layer inner surface and the third frame layer outer surface may be concentric with one another.

The third frame layer may comprise a third frame layer peripheral wall. The third frame layer peripheral wall may circumscribe or encircle one or both of: the frame aperture and the third frame layer aperture. The third frame layer peripheral wall may circumscribe or encircle the cavity.

The third frame layer peripheral wall may be defined or formed by the third frame layer outer surface and the third frame layer inner surface. The third frame layer peripheral wall may at least partially define or form one or more external surfaces or walls of the aerosol-generating article. The third frame layer peripheral wall may at least partially define or form the third frame layer aperture outer wall. The third frame layer peripheral wall may at least partially define or form the cavity outer wall.

The third frame layer may be made from or comprise any of the materials described above in relation to the frame. For example, the third frame layer may comprise the one or more susceptor materials.

The third frame layer may be made from or comprise a biodegradable material. The third frame layer may be entirely made from biodegradable material.

The third frame layer may be made from or comprise a cellulosic material. The cellulosic material may comprise a sheet of cellulosic material. The cellulosic material may be paper, paperboard, or cardboard. The third frame layer may be made from or comprise a plant material, such as tobacco. The third frame layer may be made entirely from a cellulosic material.

The cellulosic material may have any grammage or range of grammages as described above in relation to the frame.

The third frame layer may be made from a fibrous material. The third frame layer may be made from one or more of: natural fibres, synthetic fibres, polyester, bonded polyolefin, polyethylene, terylene, polypropylene, biopolymer fibres, nylon fibres, and ceramic fibres.

Where the frame comprises exactly three layers, the thickness of the third frame layer may be one third (33.33 percent) the thickness of the frame. The third frame layer may have a thickness substantially the same as each of the first frame layer and the second frame layer.

The third frame layer may have a thickness greater than or equal to 0.5 millimetres. The frame may have a thickness greater than or equal to 1 millimetre. The third frame layer may have a thickness greater than or equal to 1.5 millimetres. The third frame layer may have a thickness greater than or equal to 2 millimetres. The third frame layer may have a thickness greater than or equal to 2.5 millimetres.

The third frame layer may have a thickness less than or equal to 3 millimetres. The third frame layer may have a thickness less than or equal to 2.5 millimetres. The third frame layer may have a thickness less than or equal to 2 millimetres. The third frame layer may have a thickness less than or equal to 1.5 millimetres. The third frame layer may have a thickness less than or equal to 1 millimetres.

The third frame layer may have a thickness between 0.5 millimetres and 3 millimetres. The third frame layer may have a thickness between 0.5 millimetres and 2.5 millimetres. The third frame layer may have a thickness between 1 millimetres and 2.5 millimetres.

The one or more aerosol-generating substrates may comprise an aerosol-generating substrate layer. Advantageously, the aerosol-generating substrate layer can be made thin and, therefore, quickly heat up and release volatile compounds to form an aerosol. Advantageously, the aerosol-generating substrate layer can be positioned close to a heater of an aerosol-generating substrate.

The aerosol-generating substrate layer may comprise an aerosol-generating material. The aerosol-generating material may be any aerosol-generating material described herein. The aerosol-generating material may be in the form of a sheet of aerosol-generating material. The sheet of aerosol-generating material may be any sheet of aerosol-generating material described herein. The aerosol-generating substrate layer may be, and may be made entirely of, a sheet of aerosol-generating material.

The aerosol-generating substrate layer may be positioned between the frame and the first planar external surface. The aerosol-generating substrate layer may be positioned between the frame and the second planar external surface. The aerosol-generating substrate layer may be in physical contact with, and may be bonded to, the frame. The aerosol-generating substrate layer may be bonded to the frame with an adhesive.

The aerosol-generating substrate layer may be positioned between the frame and the outer wrapper. The outer wrapper is discussed in more detail below. The aerosol-generating substrate layer may in physical contact with, and may be bonded to, both the frame and the outer wrapper. The aerosol-generating substrate layer may be bonded to both the frame and the outer wrapper with an adhesive.

The aerosol-generating substrate layer may be positioned between the frame and the first planar external layer. The aerosol-generating substrate layer may be positioned between the frame and the second planar external layer. The first planar external layer and the second planar external layer are discussed in more detail below. The aerosol-generating substrate layer may in physical contact with, and may be bonded to, both the frame and the first planar external layer. The aerosol-generating substrate layer may be bonded to both the frame and the first planar external layer with an adhesive. The aerosol-generating substrate layer may in physical contact with, and may be bonded to, both the frame and the second planar external layer. The aerosol-generating substrate layer may be bonded to both the frame and the second planar external layer with an adhesive.

The aerosol-generating substrate layer may overlie an end of the cavity. The aerosol-generating substrate layer may define or form a wall of the cavity, such as the first cavity end wall or the second cavity end wall. Advantageously, the aerosol-generating substrate layer may therefore be in, or at least partially define or form, the airflow passage thereby allowing released volatile compounds to quickly form an aerosol.

The one or more aerosol-generating substrates may comprise a first aerosol-generating substrate layer and a second aerosol-generating substrate layer. Advantageously, a first and a second aerosol-generating substrate layer may allow rapid generation of a satisfactory volume of aerosol compared with using a single aerosol-generating substrate layer.

The first aerosol-generating substrate layer may comprise an aerosol-generating material. The aerosol-generating material may be any aerosol-generating material described herein. The aerosol-generating material may be in the form of a sheet of aerosol-generating material. The sheet of aerosol-generating material may be any sheet of aerosol-generating material described herein. The first aerosol-generating substrate layer may be, and may be made entirely of, a sheet of aerosol-generating material.

The second aerosol-generating substrate layer may comprise an aerosol-generating material. The aerosol-generating material may be any aerosol-generating material described herein. The aerosol-generating material may be in the form of a sheet of aerosol-generating material. The sheet of aerosol-generating material may be any sheet of aerosol-generating material described herein. The second aerosol-generating substrate layer may be, and may be made entirely of, a sheet of aerosol-generating material.

The first aerosol-generating substrate layer may be positioned between the frame and the first planar external surface. The first aerosol-generating substrate layer may be in physical contact with, and may be bonded to, the frame. For example, the first aerosol-generating substrate layer may be in physical contact with, and may be bonded to, the first frame layer. The first aerosol-generating substrate layer may be bonded to the frame with an adhesive. The first aerosol-generating substrate layer may be bonded to the first frame layer with an adhesive. A lower surface of the first aerosol-generating substrate layer may be bonded to an upper surface of the first frame layer with an adhesive.

The first aerosol-generating substrate layer may be positioned between the frame and the outer wrapper. The first aerosol-generating substrate layer may in physical contact with, and may be bonded to, both the frame and the outer wrapper. The first aerosol-generating substrate layer may be bonded to the frame and the outer wrapper with an adhesive.

The first aerosol-generating substrate layer may be positioned between the frame and the first planar external layer. The first aerosol-generating substrate layer may in physical contact with, and may be bonded to, both the frame and the first planar external layer. The first aerosol-generating substrate layer may be bonded to the frame and the first planar external layer with an adhesive.

The second aerosol-generating substrate layer may be positioned between the frame and the second planar external surface. The second aerosol-generating substrate layer may be in physical contact with, and may be bonded to, the frame. For example, the second aerosol-generating substrate layer may be in physical contact with, and may be bonded to, the second frame layer or third frame layer. The second aerosol-generating substrate layer may be bonded to the frame with an adhesive. The second aerosol-generating substrate layer may be bonded to the second frame layer or third frame layer with an adhesive. An upper surface of the second aerosol-generating substrate layer may be bonded to a lower surface of the second frame layer or third frame layer with an adhesive.

The second aerosol-generating substrate layer may be positioned between the frame and the outer wrapper. The second aerosol-generating substrate layer may in physical contact with, and may be bonded to, both the frame and the outer wrapper. The second aerosol-generating substrate layer may be bonded to the frame and the outer wrapper with an adhesive.

The second aerosol-generating substrate layer may be positioned between the frame and the second planar external layer. The second aerosol-generating substrate layer may in physical contact with, and may be bonded to, both the frame and the second planar external layer. The second aerosol-generating substrate layer may be bonded to the frame and the second planar external layer with an adhesive.

The first aerosol-generating substrate layer and the second aerosol-generating substrate layer may overlie opposing ends of the cavity. The first aerosol-generating substrate layer and the second aerosol-generating substrate layer may define or form opposing end walls of the cavity. That is, the frame, the first aerosol-generating substrate layer and the second aerosol-generating substrate layer may collectively define the cavity. In other words, the cavity is defined by the frame, the first aerosol-generating substrate layer and the second aerosol-generating substrate layer.

The aerosol-generating substrate layer may be a planar aerosol-generating substrate layer. The planar aerosol-generating substrate layer may extend in the x-direction and the y-direction. That is, the planar aerosol-generating substrate layer may extend in the x/y plane.

The first aerosol-generating substrate layer may be a first planar aerosol-generating substrate layer. The first planar aerosol-generating substrate layer may extend in the x-direction and the y-direction. That is, first the planar aerosol-generating substrate layer may extend in the x/y plane.

The second aerosol-generating substrate layer may be a second planar aerosol-generating substrate layer. The second planar aerosol-generating substrate layer may extend in the x-direction and the y-direction. That is, the second planar aerosol-generating substrate layer may extend in the x/y plane.

The aerosol-generating substrate layer may have a thickness greater than or equal to 100 micrometres. The aerosol-generating substrate layer may have a thickness greater than or equal to 200 micrometres. The aerosol-generating substrate layer may have a thickness greater than or equal to 300 micrometres. The aerosol-generating substrate layer may have a thickness greater than or equal to 400 micrometres. The aerosol-generating substrate layer may have a thickness greater than or equal to 500 micrometres.

The aerosol-generating substrate layer may have a thickness less than or equal to 600 micrometres. The aerosol-generating substrate layer may have a thickness less than or equal to 500 micrometres. The aerosol-generating substrate layer may have a thickness less than or equal to 400 micrometres. The aerosol-generating substrate layer may have a thickness less than or equal to between 300 micrometres. The aerosol-generating substrate layer may have a thickness less than or equal to 200 micrometres.

The aerosol-generating substrate layer may have a thickness between 100 micrometres and 600 micrometres. The aerosol-generating substrate layer may have a thickness of between 200 micrometres and 500 micrometres. The aerosol-generating substrate layer may have a thickness of between 200 micrometres and 400 micrometres. The aerosol-generating substrate layer may have a thickness of between 200 micrometres and 300 micrometres.

One or both the first aerosol-generating substrate layer and the second aerosol-generating substrate layer may have a thickness greater than or equal to 100 micrometres. One or both the first aerosol-generating substrate layer and the second aerosol-generating substrate layer may have a thickness greater than or equal to 200 micrometres. One or both the first aerosol-generating substrate layer and the second aerosol-generating substrate layer may have a thickness greater than or equal to 300 micrometres. One or both the first aerosol-generating substrate layer and the second aerosol-generating substrate layer may have a thickness greater than or equal to 400 micrometres. One or both the first aerosol-generating substrate layer and the second aerosol-generating substrate layer may have a thickness greater than or equal to 500 micrometres.

One or both the first aerosol-generating substrate layer and the second aerosol-generating substrate layer may have a thickness less than or equal to 600 micrometres. One or both the first aerosol-generating substrate layer and the second aerosol-generating substrate layer may have a thickness less than or equal to 500 micrometres. One or both the first aerosol-generating substrate layer and the second aerosol-generating substrate layer may have a thickness less than or equal to 400 micrometres. One or both the first aerosol-generating substrate layer and the second aerosol-generating substrate layer may have a thickness less than or equal to between 300 micrometres. One or both the first aerosol-generating substrate layer and the second aerosol-generating substrate layer may have a thickness less than or equal to 200 micrometres.

One or both the first aerosol-generating substrate layer and the second aerosol-generating substrate layer may have a thickness between 100 micrometres and 600 micrometres. One or both the first aerosol-generating substrate layer and the second aerosol-generating substrate layer may have a thickness of between 200 micrometres and 500 micrometres. One or both the first aerosol-generating substrate layer and the second aerosol-generating substrate layer may have a thickness of between 200 micrometres and 400 micrometres. One or both the first aerosol-generating substrate layer and the second aerosol-generating substrate layer may have a thickness of between 200 micrometres and 300 micrometres.

The aerosol-generating substrate layer may have a length substantially the same as the length of the frame. The aerosol-generating substrate layer may have a length substantially the same as the length of the aerosol-generating article.

The first aerosol-generating substrate layer may have a length substantially the same as the length of the frame. The first aerosol-generating substrate layer may have a length substantially the same as the length of the aerosol-generating article.

The second aerosol-generating substrate layer may have a length substantially the same as the length of the frame. The second aerosol-generating substrate layer may have a length substantially the same as the length of the aerosol-generating article.

The aerosol-generating substrate layer may have a width substantially the same as the width of the frame. The aerosol-generating substrate layer may have a width substantially the same as the width of the aerosol-generating article.

The first aerosol-generating substrate layer may have a width substantially the same as the width of the frame. The first aerosol-generating substrate layer may have a width substantially the same as the width of the aerosol-generating article.

The second aerosol-generating substrate layer may have a width substantially the same as the width of the frame. The second aerosol-generating substrate layer may have a width substantially the same as the width of the aerosol-generating article.

The first planar external surface may be a planar upper surface and the second planar external surface may be a planar lower surface. The first planar external surface may be a planar top surface and the second planar external surface may be a planar bottom surface. The first planar external surface may be a planar ceiling surface and the second planar external surface may be a planar base surface.

The first planar external surface may be positioned parallel to the second planar external surface. The first planar external surface may extend in the x-direction and the y-direction. That is, the first planar external surface may extend in the x/y plane. The second planar external surface may extend in the x-direction and the y-direction. That is, the second planar external surface may extend in the x/y plane.

The second planar external surface may be spaced from the first planar external surface in the z-direction or transverse direction. The distance between the first planar external surface and the second planar external surface in the z-direction or transverse direction may define the thickness of the aerosol-generating article. That is, a thickness of the aerosol-generating article may be defined by the perpendicular distance between the first planar external surface and the second planar external surface.

The aerosol-generating article may comprise an outer wrapper. The outer wrapper may be hydrophobic. The outer wrapper may comprise a hydrophobic material.

The outer wrapper may define or form the first planar external surface. The outer wrapper may define or form the second planar external surface. The outer wrapper may define or form both the first planar external surface and the second planar external surface.

The outer wrapper may circumscribe or encircle the frame. The outer wrapper may be in physical contact with, and may be bonded to, the frame. The outer wrapper may overlie opposing ends of the cavity. The outer wrapper may define or form opposing end walls of the cavity, such as the first cavity end wall and the second cavity end wall. That is, the frame and the outer wrapper may collectively define the cavity. In other words, the cavity is defined by the frame and the outer wrapper.

The outer wrapper may circumscribe or encircle the frame and the aerosol-generating substrate layer. The outer wrapper may be in physical contact with, and may be bonded to, both the frame and the aerosol-generating substrate layer.

The outer wrapper may circumscribe or encircle the frame, the first aerosol-generating substrate layer and the second aerosol-generating substrate layer. The outer wrapper may be in physical contact with, and may be bonded to, both the first aerosol-generating substrate layer and the second aerosol-generating substrate layer.

The aerosol-generating article may comprise a first planar external layer and a second planar external layer. The first planar external layer may be an upper layer and the second planar external layer may be a lower layer. The first planar external layer may be a top layer and the second planar external layer may be a bottom layer. The first planar external layer may be an ceiling layer and the second planar external layer may be a base layer.

The first planar external layer may define or form the first planar external surface. The first planar external layer may extend in the x-direction and the y-direction. That is, the first planar external layer may extend in the x/y plane. The second planar external layer may define or form the second planar external surface. The second planar external layer may extend in the x-direction and the y-direction. That is, the second planar external layer may extend in the x/y plane.

The first planar external layer may be in physical contact with, and may be bonded to, the frame. The first planar external layer may be bonded to the frame with an adhesive. The first planar external layer may be bonded to the first frame layer with an adhesive. A lower surface of the first planar external layer may be bonded to an upper surface of the first frame layer with an adhesive. The adhesive may extend at least 90% around the periphery of the intersection between the first planar external layer and the frame. The adhesive may extend at least 95% around the periphery of the intersection between the first planar external layer and the frame. The adhesive may extend at least 99% around the periphery of the intersection between the first planar external layer and the frame.

The first planar external layer may overlie an end of the cavity. The first planar external layer may define or form a wall of the cavity, such as the first cavity end wall.

The second planar external layer may be in physical contact with, and may be bonded to, the frame. The second planar external layer may be bonded to the frame with an adhesive. The second planar external layer may be bonded to the second frame layer with an adhesive. An upper surface of the second planar external layer may be bonded to a lower surface of the second frame layer with an adhesive. The second planar external layer may be bonded to the third frame layer with an adhesive. An upper surface of the second planar external layer may be bonded to a lower surface of the third frame layer with an adhesive. The adhesive may extend at least 90% around the periphery of the intersection between the second planar external layer and the frame. The adhesive may extend at least 95% around the periphery of the intersection between the second planar external layer and the frame. The adhesive may extend at least 99% around the periphery of the intersection between the second planar external layer and the frame.

The second planar external layer may overlie an end of the cavity. The second planar external layer may define or form a wall of the cavity, such as the second cavity end wall.

The first planar external layer and the second planar external layer may overlie opposing ends of the cavity. The first planar external layer and the second planar external layer may define or form opposing end walls of the cavity, such as the first cavity end wall and the second cavity end wall. That is, the frame, the first planar external layer and the second planar external layer may collectively define the cavity. In other words, the cavity is defined by the frame, the first planar external layer and the second planar external layer.

The first planar external layer may be spaced, such as in a transverse direction, from the frame. For example, the aerosol-generating substrate layer or the first aerosol-generating substrate layer may be positioned between the first planar external layer and the frame. The first planar external layer may be in physical contact with, and may be bonded to, the aerosol-generating substrate layer or the first aerosol-generating substrate layer. The first planar external layer may be bonded to the aerosol-generating substrate layer or the first aerosol-generating substrate layer with an adhesive.

The second planar external layer may be spaced, such as in a transverse direction, from the frame. For example, the aerosol-generating substrate layer or the second aerosol-generating substrate layer may be positioned between the second planar external layer and the frame. The second planar external layer may be in physical contact with, and may be bonded to, the aerosol-generating substrate layer or the second aerosol-generating substrate layer. The second planar external layer may be bonded to the aerosol-generating substrate layer or the second aerosol-generating substrate layer with an adhesive.

The first planar external layer may be hydrophobic. The first planar external layer may comprise a hydrophobic material. The second planar external layer may be hydrophobic. The second planar external layer may comprise a hydrophobic material.

Advantageously, adhesive bonding together components of the aerosol-generating article may provide for a tight seal between layers of the aerosol-generating article. In particular, the adhesive bonding one or both of the first planar external layer and the second planar external layer to the frame may provide for a tight seal between the first planar external layer and the frame or a tight seal between the second planar external layer and the frame.

Providing a tight seal between layers of the aerosol-generating article may improve air flow through the cavity. Improving air flow through the cavity may improve the user experience.

Advantageously, use of an adhesive to bond together components of the aerosol-generating article may provide for an aerosol-generating article having a high structural integrity.

The adhesive may comprise a gum. The adhesive may comprise guar gum. The adhesive may comprise polyvinyl alcohol. The adhesive may comprise an aerosol-generating material. The adhesive may consist of an aerosol-generating material. For example, the adhesive may be a homogenised tobacco slurry. The adhesive may be, or may comprise, a flavourant and/or an aerosol-former.

One or more of the outer wrapper, the first planar external layer and the second planar external layer may be made from a cellulosic material. One or more of the outer wrapper, the first planar external layer and the second planar external layer may comprise a cellulosic material. The cellulosic material may be paper, cardboard, wood, textile, natural fibres or artificial fibres.

One or more of the outer wrapper, the first planar external layer and the second planar external layer may be an aerosol-generating substrate comprising an aerosol-generating material. One or more of the outer wrapper, the first planar external layer and the second planar external layer may comprise an aerosol-generating material. The aerosol-generating material may be any aerosol-generating material described herein. In particular, the aerosol-generating material may be in the form of a sheet of aerosol-generating material. The sheet of aerosol-generating material may be any sheet of aerosol-generating material described herein. Alternatively, one or more of the outer wrapper, the first planar external layer and the second planar external layer may not comprise any aerosol-generating material, particularly in embodiments comprising an aerosol-generating substrate layer, a first aerosol-generating substrate layer, a second aerosol-generating substrate layer or an aerosol-generating substrate positioned within the cavity. For example, one or more of the outer wrapper, the first planar external layer and the second planar external layer may not comprise tobacco. One or more of the outer wrapper, the first planar external layer and the second planar external layer may be substantially nicotine-free.

One or more of the outer wrapper, the first planar external layer and the second planar external layer may comprise a paper material. For example, one or more of the outer wrapper, the first planar external layer and the second planar external layer may be paper, cardboard, cigarette paper or tobacco paper.

The cellulosic material may have a basis weight greater than 10 grams per square metre. The cellulosic material may have a basis weight greater than 20 grams per square metre. The cellulosic material may have a basis weight less than 30 grams per square metre. The cellulosic material may have a basis weight less than 25 grams per square metre. The cellulosic material may have a basis weight between 10 grams per square metre and 30 grams per square metre. The cellulosic material may have a basis weight between 15 grams per square metre and 25 grams per square metre.

One or more of the outer wrapper, the first planar external layer and the second planar external layer may comprise paper and non-paper components.

One or more of the outer wrapper, the first planar external layer and the second planar external layer may exhibit a range of permeabilities including not being permeable. The permeability is determined by utilizing the International Standard test method ISO 2965:2009 and the result is presented as cubic centimetres per minute per square centimetre and referred to as “CORESTA units”. One or more of the outer wrapper, the first planar external layer and the second planar external layer may have a permeability between 1 and 10 CORESTA units. T One or more of the outer wrapper, the first planar external layer and the second planar external layer may have a permeability between 1 and 5 CORESTA units. One or more of the outer wrapper, the first planar external layer and the second planar external layer may have a permeability between 5 and 20 CORESTA units.

One or more of the outer wrapper, the first planar external layer and the second planar external layer may have a thickness greater than or equal to 25 micrometres. One or more of the outer wrapper, the first planar external layer and the second planar external layer may have a thickness greater than or equal to 30 micrometres. One or more of the outer wrapper, the first planar external layer and the second planar external layer may have a thickness greater than or equal to 35 micrometres. The outer wrapper may have a thickness greater than or equal to 40 micrometres. One or more of the outer wrapper, the first planar external layer and the second planar external layer may have a thickness greater than or equal to 45 micrometres.

One or more of the outer wrapper, the first planar external layer and the second planar external layer may have a thickness less than or equal to 55 micrometres. One or more of the outer wrapper, the first planar external layer and the second planar external layer may have a thickness greater than or equal to 50 micrometres. One or more of the outer wrapper, the first planar external layer and the second planar external layer may have a thickness greater than or equal to 45 micrometres. One or more of the outer wrapper, the first planar external layer and the second planar external layer may have a thickness greater than or equal to 40 micrometres. One or more of the outer wrapper, the first planar external layer and the second planar external layer may have a thickness greater than or equal to 35 micrometres.

One or more of the outer wrapper, the first planar external layer and the second planar external layer may have a thickness between 25 micrometres and 55 micrometres. One or more of the outer wrapper, the first planar external layer and the second planar external layer may have a thickness between 25 micrometres and 45 micrometres. One or more of the outer wrapper, the first planar external layer and the second planar external layer may have a thickness between 30 micrometres and 45 micrometres.

One or more of the outer wrapper, the first planar external layer and the second planar external layer may have a length substantially the same as the length of the frame. One or more of the outer wrapper, the first planar external layer and the second planar external layer may have a length substantially the same as the length of the aerosol-generating article. One or more of the outer wrapper, the first planar external layer and the second planar external layer may have a length of greater than or equal to 90 percent of the length of the frame. One or more of the outer wrapper, the first planar external layer and the second planar external layer may have a length of greater than or equal to 95 percent of the length of the frame.

One or more of the first planar external layer and the second planar external layer may have a width substantially the same as the width of the frame. One or more of the first planar external layer and the second planar external layer may have a width substantially the same as the width of the aerosol-generating article. One or more of the outer wrapper, the first planar external layer and the second planar external layer may have a width of greater than or equal to 90 percent of the width of the frame. One or more of the outer wrapper, the first planar external layer and the second planar external layer may have a width of greater than or equal to 95 percent of the width of the frame.

The cavity may comprise a first cavity end wall and a second cavity end wall positioned opposite the first cavity end wall. The first cavity end wall may be defined, or formed, by the outer wrapper, the first planar external layer or the first aerosol-generating substrate layer. The second cavity end wall may be defined, or formed, by the outer wrapper, the second planar external layer or the second aerosol-generating substrate layer. The cavity may be enclosed by the first cavity end wall, the second cavity end wall and the frame.

The cavity may comprise a cavity outer wall. The cavity outer wall may be defined, or formed, by the frame. The cavity outer wall may extend in a transverse direction. The cavity outer wall may extend in a transverse direction between the first cavity end wall and the second cavity end wall. The cavity outer wall may be defined, or formed, by the frame inner surface. The cavity outer wall may be defined, or formed, by the peripheral wall of the frame.

The cavity may have at least two corners extending between the first planar external surface and the second planar external surface. The at least two corners may be chamfered or rounded or filleted. Preferably, all corners of the cavity extending between the first planar external surface and the second planar external surface are chamfered or rounded or filleted.

Advantageously, a cavity having chamfered, rounded or filleted corners may make the cavity easier to heat. In particular, it may make it easier to heat an aerosol-generating substrate that is positioned within the cavity. Advantageously, a cavity having chamfered, rounded or filleted corners may make the aerosol-generating article stronger and less susceptible to damage. Advantageously, a cavity having chamfered, rounded or filleted corners may make the aerosol-generating article easier to manufacture.

The cavity may have a thickness substantially the same as a thickness of the frame.

The cavity may have a thickness greater than or equal to 30 percent of the thickness of the aerosol-generating article. The cavity may have a thickness greater than or equal to 40 percent of the thickness of the aerosol-generating article. The cavity may have a thickness greater than or equal to 50 percent of the thickness of the aerosol-generating article. The cavity may have a thickness greater than or equal to 60 percent of the thickness of the aerosol-generating article. The cavity may have a thickness greater than or equal to 70 percent of the thickness of the aerosol-generating article. The cavity may have a thickness greater than or equal to 80 percent of the thickness of the aerosol-generating article. The cavity may have a thickness greater than or equal to 90 percent of the thickness of the aerosol-generating article. The cavity may have a thickness greater than or equal to 95 percent of the thickness of the aerosol-generating article.

The cavity may have a thickness less than or equal to 95 percent of the thickness of the aerosol-generating article. The cavity may have a thickness less than or equal to 90 percent of the thickness of the aerosol-generating article. The cavity may have a thickness less than or equal to 80 percent of the thickness of the aerosol-generating article. The cavity may have a thickness less than or equal to 70 percent of the thickness of the aerosol-generating article.

The cavity may have a thickness between 30 percent of the thickness of the aerosol-generating article and 95 percent of the thickness of the aerosol-generating article. The cavity may have a thickness between 40 percent of the thickness of the aerosol-generating article and 95 percent of the thickness of the aerosol-generating article. The cavity may have a thickness between 50 percent of the thickness of the aerosol-generating article and 90 percent of the thickness of the aerosol-generating article. The cavity may have a thickness between 60 percent of the thickness of the aerosol-generating article and 90 percent of the thickness of the aerosol-generating article. The cavity may have a thickness between 70 percent of the thickness of the aerosol-generating article and 90 percent of the thickness of the aerosol-generating article. The cavity may have a thickness between 80 percent of the thickness of the aerosol-generating article and 90 percent of the thickness of the aerosol-generating article.

The cavity may have a thickness greater than or equal to 0.5 millimetres. The cavity may have a thickness greater than or equal to 1 millimetre. The cavity may have a thickness greater than or equal to 1.5 millimetres. The cavity may have a thickness greater than or equal to 2 millimetres. The cavity may have a thickness greater than or equal to 2.5 millimetres. The cavity may have a thickness greater than or equal to 3 millimetres. The cavity may have a thickness greater than or equal to 3.5 millimetres. The cavity may have a thickness greater than or equal to 4 millimetres.

The cavity may have a thickness less than or equal to 4.5 millimetres. The cavity may have a thickness less than or equal to 4 millimetres. The cavity may have a thickness less than or equal to 3.5 millimetres. The cavity may have a thickness less than or equal to 2.5 millimetres. The cavity may have a thickness less than or equal to 2 millimetres. The cavity may have a thickness less than or equal to 1.5 millimetres.

The cavity may have a thickness between 0.5 millimetres and 4.5 millimetres. The cavity may have a thickness between 1 millimetre and 4.5 millimetres. The cavity may have a thickness between 2 millimetre and 4 millimetres. Preferably, the cavity may have a thickness between 2.8 millimetres and 3.3 millimetres.

The cavity may have a length greater than or equal to 30 percent of the length of the aerosol-generating article. The cavity may have a length greater than or equal to 40 percent of the length of the aerosol-generating article. The cavity may have a length greater than or equal to 50 percent of the length of the aerosol-generating article. The cavity may have a length greater than or equal to 60 percent of the length of the aerosol-generating article. The cavity may have a length greater than or equal to 70 percent of the length of the aerosol-generating article. The cavity may have a length greater than or equal to 80 percent of the length of the aerosol-generating article. The cavity may have a length greater than or equal to 90 percent of the length of the aerosol-generating article.

The cavity may have a length less than or equal to 95 percent of the length of the aerosol-generating article. The cavity may have a length less than or equal to 90 percent of the length of the aerosol-generating article. The cavity may have a length less than or equal to 80 percent of the length of the aerosol-generating article. The cavity may have a length less than or equal to 70 percent of the length of the aerosol-generating article. The cavity may have a length less than or equal to 60 percent of the length of the aerosol-generating article. The cavity may have a length less than or equal to 55 percent of the length of the aerosol-generating article.

The cavity may have a length between 30 percent and 95 percent of the length of the aerosol-generating article. The cavity may have a length between 40 percent and 95 percent of the length of the aerosol-generating article. The cavity may have a length between 50 percent and 90 percent of the length of the aerosol-generating article. The cavity may have a length between 55 percent and 90 percent of the length of the aerosol-generating article. The cavity may have a length between 60 percent and 90 percent of the length of the aerosol-generating article. The cavity may have a length between 70 percent and 90 percent of the length of the aerosol-generating article. The cavity may have a length between 80 percent and 90 percent of the length of the aerosol-generating article.

The cavity may have a length greater than or equal to 14 millimetres. The cavity may have a length equal to a greater than 16 millimetres. The cavity may have a length equal to a greater than 18 millimetres. The cavity may have a length greater than or equal to 22 millimetres. The cavity may have a thickness greater than or equal to 26 millimetres. The cavity may have a thickness greater than or equal to 30 millimetres. The cavity may have a thickness greater than or equal to 34 millimetres. The cavity may have a thickness greater than or equal to 38 millimetres.

The cavity may have a length less than or equal to 40 millimetres. The cavity may have a length less than or equal to 38 millimetres. The cavity may have a thickness less than or equal to 34 millimetres. The cavity may have a thickness less than or equal to 30 millimetres. The cavity may have a thickness less than or equal to 28 millimetres. The cavity may have a thickness less than or equal to 26 millimetres. The cavity may have a thickness less than or equal to 22 millimetres. The cavity may have a thickness less than or equal to 18 millimetres.

The cavity may have a length between 14 millimetres and 40 millimetres. The cavity may have a length between 14 millimetres and 38 millimetres. The cavity may have a length between 14 millimetres and 34 millimetres. The cavity may have a length between 14 millimetres and 30 millimetres. The cavity may have a length between 16 millimetres and 30 millimetres. The cavity may have a length between 18 millimetres and 30 millimetres. The cavity may have a length between 20 millimetres and 30 millimetres. The cavity may have a length between 24 millimetres and 28 millimetres.

The cavity may have a width greater than or equal to 30 percent of the width of the aerosol-generating article. The cavity may have a width greater than or equal to 40 percent of the width of the aerosol-generating article. The cavity may have a width greater than or equal to 50 percent of the width of the aerosol-generating article. The cavity may have a width greater than or equal to 60 percent of the width of the aerosol-generating article. The cavity may have a width greater than or equal to 70 percent of the width of the aerosol-generating article. The cavity may have a width greater than or equal to 80 percent of the width of the aerosol-generating article. The cavity may have a width greater than or equal to 90 percent of the width of the aerosol-generating article.

The cavity may have a width less than or equal to 95 percent of the width of the aerosol-generating article. The cavity may have a width less than or equal to 90 percent of the width of the aerosol-generating article. The cavity may have a width less than or equal to 80 percent of the width of the aerosol-generating article. The cavity may have a width less than or equal to 70 percent of the width of the aerosol-generating article. The cavity may have a width less than or equal to 60 percent of the width of the aerosol-generating article. The cavity may have a width less than or equal to 55 percent of the width of the aerosol-generating article.

The cavity may have a width between 30 percent and 95 percent of the width of the aerosol-generating article. The cavity may have a width between 40 percent and 95 percent of the width of the aerosol-generating article. The cavity may have a width between 50 percent and 90 percent of the width of the aerosol-generating article. The cavity may have a width between 50 percent and 95 percent of the width of the aerosol-generating article. The cavity may have a width between 60 percent and 90 percent of the width of the aerosol-generating article. The cavity may have a width between 70 percent and 90 percent of the width of the aerosol-generating article. The cavity may have a width between 80 percent and 90 percent of the width of the aerosol-generating article.

The cavity may have a width greater than or equal to 4.5 millimetres. The cavity may have a width greater than or equal to 5 millimetres. The cavity may have a width greater than or equal to 7 millimetres. The cavity may have a width greater than or equal to 9 millimetres. The cavity may have a width greater than or equal to 11 millimetres.

The cavity may have a width less than or equal to 13 millimetres. The cavity may have a width less than or equal to 13 millimetres. The cavity may have a width less than or equal to 11 millimetres. The cavity may have a width less than or equal to 9 millimetres. The cavity may have a width less than or equal to 7 millimetres. The cavity may have a width less than or equal to 5 millimetres.

The cavity may have a width between 4.5 millimetres and 13 millimetres. The cavity may have a width between 5 millimetres and 13 millimetres. The cavity may have a width between 7 millimetres and 10 millimetres. The cavity may have a width between 7.5 millimetres and 8.5 millimetres.

The cavity may have a length between 14 millimetres and 40 millimetres, a width between 4.5 millimetres and 13 millimetres, and a thickness between 0.5 millimetres and 4.5 millimetres. Preferably, the cavity may have a length between 20 millimetres and 30 millimetres, a width between 7 millimetres and 10 millimetres, and a thickness between 2.5 millimetres and 4 millimetres.

Most preferably, the cavity may have a length of 26 millimetres, a width of 8 millimetres, and a thickness of 3.1 millimetres.

The cavity may have a volume of greater than or equal to 30 cubic millimetres. The cavity may have a volume of greater than or equal to 100 cubic millimetres. The cavity may have a volume greater than or equal to 200 cubic millimetres. The cavity may have a volume greater than or equal to 300 cubic millimetres. The cavity may have a volume greater than or equal to 400 cubic millimetres. The cavity may have a volume greater than or equal to 500 cubic millimetres. The cavity may have a volume greater than or equal to 600 cubic millimetres. The cavity may have a volume greater than or equal to 700 cubic millimetres. The cavity may have a volume greater than or equal to 800 cubic millimetres. The cavity may have a volume greater than or equal to 900 cubic millimetres. The cavity may have a volume greater than or equal to 1000 cubic millimetres. The cavity may have a volume greater than or equal to 1500 cubic millimetres. The cavity may have a volume greater than or equal to 2000 cubic millimetres. The cavity may have a volume greater than or equal to 2500 cubic millimetres. The cavity may have a volume greater than or equal to 3000 cubic millimetres.

The cavity may have a volume of less than or equal to 3500 cubic millimetres. The cavity may have a volume of less than or equal to 3000 cubic millimetres. The cavity may have a volume of less than or equal to 2500 cubic millimetres. The cavity may have a volume of less than or equal to 2000 cubic millimetres. The cavity may have a volume of less than or equal to 1500 cubic millimetres. The cavity may have a volume of less than or equal to 1000 cubic millimetres. The cavity may have a volume of less than or equal to 900 cubic millimetres. The cavity may have a volume less than or equal to 800 cubic millimetres. The cavity may have a volume less than or equal to 700 cubic millimetres. The cavity may have a volume less than or equal to 600 cubic millimetres. The cavity may have a volume less than or equal to 500 cubic millimetres. The cavity may have a volume less than or equal to 400 cubic millimetres. The cavity may have a volume less than or equal to 300 cubic millimetres.

The cavity may have a volume between 30 cubic millimetres and 3000 cubic millimetres. The cavity may have a volume between 30 cubic millimetres and 3000 cubic millimetres. The cavity may have a volume between 30 cubic millimetres and 2500 cubic millimetres. The cavity may have a volume between 30 cubic millimetres and 2350 cubic millimetres. The cavity may have a volume between 100 cubic millimetres and 2000 cubic millimetres. The cavity may have a volume between 100 cubic millimetres and 1500 cubic millimetres. The cavity may have a volume between 250 cubic millimetres and 1150 cubic millimetres. The cavity may have a volume between 100 cubic millimetres and 1000 cubic millimetres. The cavity may have a volume between 100 cubic millimetres and 900 cubic millimetres. The cavity may have a volume between 200 cubic millimetres and 800 cubic millimetres. Preferably, the cavity may have a volume between 300 cubic millimetres and 700 cubic millimetres. The cavity may have a volume between 400 cubic millimetres and 700 cubic millimetres. The cavity may have a volume between 500 cubic millimetres and 700 cubic millimetres.

The cavity may have a volume greater than or equal to 1 percent of the external volume of the aerosol-generating article. The cavity may have a volume greater than or equal to 5 percent of the external volume of the aerosol-generating article. The cavity may have a volume greater than or equal to 1 percent of the external volume of the aerosol-generating article.

The cavity may have a volume less than or equal to 90 percent of the external volume of the aerosol-generating article. The cavity may have a volume less than or equal to 80 percent of the external volume of the aerosol-generating article. The cavity may have a volume less than or equal to 70 percent of the external volume of the aerosol-generating article.

The cavity may have a volume between 1 percent and 90 percent of the external volume of the aerosol-generating article. The cavity may have a volume between 5 percent and 80 percent of the external volume of the aerosol-generating article. The cavity may have a volume between 10 percent and 70 percent of the external volume of the aerosol-generating article.

The cavity may be a first cavity. The aerosol-generating article may comprise a second cavity. The second cavity may be positioned between the first planar external surface and the second planar external surface. The second cavity may have any of the features described in relation to the first cavity.

The frame may at least partially define or form the second cavity.

The frame may comprise a frame first aperture extending through the thickness of the frame. The frame first aperture may at least partially define or form the first cavity. The frame may define a frame second aperture extending through the thickness of the frame. The frame second aperture may at least partially define or form the second cavity.

The peripheral wall of the frame may comprise a frame first inner surface and a frame second inner surface. The frame first inner surface may define or form an outer wall of the first cavity. The frame second inner surface may define or form an outer wall of the second cavity.

The frame may comprise a dividing wall which separates the first cavity and the second cavity. The dividing wall may define or form an aperture. The aperture may extend from the first cavity to the second cavity. The aperture may define or form at least a portion of the airflow passage between the air inlet and the air outlet.

The outer wrapper may overlie opposing ends of the first cavity. The outer wrapper may overlie opposing ends of the second cavity. The outer wrapper may define or form opposing end walls of the first cavity. The outer wrapper may define or form opposing end walls of the second cavity. That is, the frame and the outer wrapper may collectively define the first cavity and the second cavity.

The first planar external layer and the second planar external layer may overlie opposing ends of the first cavity. The first planar external layer and the second planar external layer may overlie opposing ends of the second cavity. The first planar external layer and the second planar external layer may define or form opposing end walls of the first cavity. The first planar external layer and the second planar external layer may define or form opposing end walls of the second cavity. That is, the frame, the first planar external layer and the second planar external layer may collectively define the first cavity and the second cavity.

The first aerosol-generating substrate layer and the second aerosol-generating substrate layer may overlie opposing ends of the first cavity. The first aerosol-generating substrate layer and the second aerosol-generating substrate layer may overlie opposing ends of the second cavity. The first aerosol-generating substrate layer and the second aerosol-generating substrate layer may define or form opposing end walls of the first cavity The first aerosol-generating substrate layer and the second aerosol-generating substrate layer may define or form opposing end walls of the second cavity. That is, the frame, the first aerosol-generating substrate layer and the second aerosol-generating substrate layer may collectively define the first cavity and the second cavity.

The cavity, or the first cavity, may be substantially empty. The second cavity may be substantially empty.

The one or more aerosol-generating substrates may comprise an aerosol-generating substrate positioned within the cavity. The aerosol-generating substrate positioned within the cavity may fill the cavity. Advantageously, providing an aerosol-generating substrate which fills the cavity enables the aerosol-generating substrate to provide mechanical support to the first planar external surface and the second planar external surface. The provision of additional mechanical support to the first planar external surface and the second planar external surface may improve the rigidity of the aerosol-generating article.

The one or more aerosol-generating substrates may comprise an aerosol-generating substrate positioned within the first cavity. The aerosol-generating substrate positioned within the cavity may fill the first cavity.

The one or more aerosol-generating substrates may comprise an aerosol-generating substrate positioned within the second cavity.

The aerosol-generating substrate positioned within the cavity, the first cavity or the second cavity may comprise an aerosol-generating material. The aerosol-generating material may be any aerosol-generating material described herein. For example, the aerosol-generating material may be in the form of shredded aerosol-generating material.

The aerosol-generating material may be in the form of a sheet of aerosol-generating material. The sheet of aerosol-generating material may be any sheet of aerosol-generating material described herein. For example, the sheet of aerosol-generating material may be a sheet of homogenised tobacco material.

The sheet of aerosol-generating material may extend the entire length of the cavity, the first cavity or the second cavity. The sheet of aerosol-generating material may extend the entire width of the cavity, the first cavity or the second cavity.

The sheet of aerosol-generating material may be a gathered sheet of aerosol-generating material. That is, the sheet of aerosol-generating material may be convoluted, folded, or otherwise compressed or constricted substantially perpendicular to the transverse direction of the aerosol-generating article.

The sheet of aerosol-generating material may be a crimped sheet of aerosol-generating material. The sheet of aerosol-generating material may be a corrugated sheet of aerosol-generating material. The crimped sheet of aerosol-generating material or the corrugated sheet of aerosol-generating material may comprise a plurality of parallel corrugations. For example, the crimped sheet of aerosol-generating material may comprise a plurality of substantially parallel peaks and troughs.

The plurality of parallel corrugations may be defined by a corrugation profile, in which the corrugation profile is sinusoidal, or triangular, or rectangular, or trapezoidal, or toroidal, or parabolic The plurality of parallel corrugations may be defined by a corrugation wavelength and a corrugation amplitude. The corrugation wavelength may be between 0.5 mm and 10 mm, for example between 1 mm and 10 mm, for example between 1.5 mm and 8 mm, for example between 2 mm and 6 mm, for example between 2.5 mm and 5 mm, for example between 3 mm and 4 mm. The corrugation amplitude may be approximately the same as the thickness of the cavity.

The plurality of parallel corrugations may define, or form, a plurality of channels between the sheet of aerosol-generating material and one or more walls of the cavity, the first cavity and the second cavity. The plurality of channels may be a plurality of longitudinally extending channels. That is, the plurality of channels may extend in a longitudinal direction of the aerosol-generating article. The plurality of channels may be a plurality of laterally extending channels. That is, the plurality of channels may extend in a lateral direction of the aerosol-generating article. The plurality of channels may defined, or form, at least a portion of the airflow passage extending between the air inlet and air outlet of the aerosol-generating article.

The aerosol-generating substrate positioned within the cavity, the first cavity or the second cavity may have a bulk density of greater than or equal to 0.05 milligrams per cubic millimetre. The aerosol-generating substrate positioned within the cavity, the first cavity or the second cavity may have a bulk density of greater than or equal to 0.1 milligrams per cubic millimetre. The aerosol-generating substrate positioned within the cavity, the first cavity or the second cavity may have a bulk density of greater than or equal to 0.15 milligrams per cubic millimetre. The aerosol-generating substrate positioned within the cavity, the first cavity or the second cavity may have a bulk density of greater than or equal to 0.2 milligrams per cubic millimetre. The aerosol-generating substrate positioned within the cavity, the first cavity or the second cavity may have a bulk density of greater than or equal to 0.3 milligrams per cubic millimetre. The aerosol-generating substrate positioned within the cavity, the first cavity or the second cavity may have a bulk density of greater than or equal to 0.4 milligrams per cubic millimetre.

The aerosol-generating substrate positioned within the cavity, the first cavity or the second cavity may have a bulk density of less than or equal to 0.5 milligrams per cubic millimetre. The aerosol-generating substrate positioned within the cavity, the first cavity or the second cavity may have a bulk density of less than or equal to 0.4 milligrams per cubic millimetre. The aerosol-generating substrate positioned within the cavity, the first cavity or the second cavity may have a bulk density of less than or equal to 0.35 milligrams per cubic millimetre. The aerosol-generating substrate positioned within the cavity, the first cavity or the second cavity may have a bulk density of less than or equal to 0.3 milligrams per cubic millimetre.

The aerosol-generating substrate positioned within the cavity, the first cavity or the second cavity may have a bulk density of between 0.05 milligrams per cubic millimetre and 0.5 milligrams per cubic millimetre. The aerosol-generating substrate positioned within the cavity, the first cavity or the second cavity may have a bulk density of between 0.1 milligrams per cubic millimetre and 0.4 milligrams per cubic millimetre. The aerosol-generating substrate positioned within the cavity, the first cavity or the second cavity may have a bulk density of between 0.1 and 0.3 milligrams per cubic millimetre. The aerosol-generating substrate positioned within the cavity, the first cavity or the second cavity may have a bulk density of between 0.2 and 0.3 milligrams per cubic millimetre.

The aerosol-generating substrate positioned within the cavity, the first cavity or the second cavity may have a packing density greater than or equal to 0.3. The aerosol-generating substrate positioned within the cavity, the first cavity or the second cavity may have a packing density greater than or equal to 0.4. The aerosol-generating substrate positioned within the cavity, the first cavity or the second cavity may have a packing density greater than or equal to 0.5. The aerosol-generating substrate positioned within the cavity, the first cavity or the second cavity may have a packing density greater than or equal to 0.6. The aerosol-generating substrate positioned within the cavity, the first cavity or the second cavity may have a packing density greater than or equal to 0.7.

The aerosol-generating substrate positioned within the cavity, the first cavity or the second cavity may have a packing density less than or equal to 0.9. The aerosol-generating substrate positioned within the cavity, the first cavity or the second cavity may have a packing density less than or equal to 0.8. The aerosol-generating substrate positioned within the cavity, the first cavity or the second cavity may have a packing density less than or equal to 0.7. The aerosol-generating substrate positioned within the cavity, the first cavity or the second cavity may have a packing density less than or equal to 0.6. The aerosol-generating substrate positioned within the cavity, the first cavity or the second cavity may have a packing density less than or equal to 0.5.

The aerosol-generating substrate positioned within the cavity, the first cavity or the second cavity may have a packing density between 0.3 and 0.9. The aerosol-generating substrate positioned within the cavity, the first cavity or the second cavity may have a packing density between 0.4 and 0.9. The aerosol-generating substrate positioned within the cavity, the first cavity or the second cavity may have a packing density between 0.5 and 0.9. The aerosol-generating substrate positioned within the cavity, the first cavity or the second cavity may have a packing density between 0.5 and 0.8. The aerosol-generating substrate positioned within the cavity, the first cavity or the second cavity may have a packing density between 0.5 and 0.7.

Advantageously, providing an aerosol-generating substrate within the cavity having a high packing density may provide mechanical support to the first planar external surface and the second planar external surface. The provision of additional mechanical support to the first planar external surface and the second planar external surface may improve the rigidity of the aerosol-generating article. However, a packing density that is too high may restrict airflow through the aerosol-generating article and may provide the aerosol-generating article with an unsatisfactory resistance to draw.

Advantageously, providing an aerosol-generating substrate within the cavity having a packing density greater than or equal to 0.3 may promote heat conduction through the aerosol-generating substrate. Increased heat conduction through the aerosol-generating substrate may reduce the time require to generate an aerosol.

Advantageously, providing an aerosol-generating substrate positioned within the cavity having a packing density less than or equal to 0.9 grams per cubic centimetre may promote the formation of air flow channels within the aerosol-generating substrate during use of the aerosol-generating article. Increased provision of air flow channels within the aerosol-generating substrate may improve the vaporisation of the aerosol-generating substrate. Increased provision of air flow channels within the aerosol-generating substrate may also provide a satisfactory resistance to draw.

Advantageously, providing an aerosol-generating substrate positioned within the cavity having a packing density less than or equal to 0.9 grams per cubic centimetre may reduce the likelihood of the aerosol-generating substrate becoming compacted. Compaction of the aerosol-generating substrate may increase the power required to heat the aerosol-generating substrate to a temperature sufficient to cause vaporisation.

Thus, the packing density may be a trade-off between heat conduction through the aerosol-generating substrate, the provision of mechanical support for the first and second planar external surfaces, the promotion of air flow channels within the aerosol-generating substrate, and providing the aerosol-generating article with a satisfactory resistance to draw.

The aerosol-generating substrate positioned within the cavity, the first cavity or the second cavity may have may have a volume greater than or equal to 150 cubic millimetres. The aerosol-generating substrate positioned within the cavity, the first cavity or the second cavity may have may have a volume greater than or equal to 200 cubic millimetres. The aerosol-generating substrate positioned within the cavity, the first cavity or the second cavity may have may have a volume greater than or equal to 250 cubic millimetres. The aerosol-generating substrate positioned within the cavity, the first cavity or the second cavity may have may have a volume greater than or equal to 350 cubic millimetres.

The aerosol-generating substrate positioned within the cavity, the first cavity or the second cavity may have less than or equal to 1000 cubic millimetres. The aerosol-generating substrate positioned within the cavity, the first cavity or the second cavity may have less than or equal to 900 cubic millimetres. The aerosol-generating substrate positioned within the cavity, the first cavity or the second cavity may have less than or equal to 800 cubic millimetres. The aerosol-generating substrate positioned within the cavity, the first cavity or the second cavity may have less than or equal to 700 cubic millimetres.

The aerosol-generating substrate positioned within the cavity, the first cavity or the second cavity may have a volume between 100 cubic millimetres and 1000 cubic millimetres. The aerosol-generating substrate positioned within the cavity, the first cavity or the second cavity may have a volume between 200 cubic millimetres and 1000 cubic millimetres. The aerosol-generating substrate positioned within the cavity, the first cavity or the second cavity may have a volume between 350 cubic millimetres and 650 cubic millimetres.

At least one of the one or more aerosol-generating substrates may have a density greater than or equal to 0.05 grams per cubic centimetre. At least one of the one or more aerosol-generating substrates may have a density greater than or equal to 0.1 grams per cubic centimetre. At least one of the one or more aerosol-generating substrates may have a density greater than or equal to 0.2 grams per cubic centimetre. At least one of the one or more aerosol-generating substrates may have a density greater than or equal to 0.3 grams per cubic centimetre. At least one of the one or more aerosol-generating substrates may have a density greater than or equal to 0.4 grams per cubic centimetre.

At least one of the one or more aerosol-generating substrates may have a density less than or equal to 0.9 grams per cubic centimetre. At least one of the one or more aerosol-generating substrates may have a density less than or equal to 0.8 grams per cubic centimetre. At least one of the one or more aerosol-generating substrates may have a density less than or equal to 0.7 grams per cubic centimetre. At least one of the one or more aerosol-generating substrates may have a density less than or equal to 0.6 grams per cubic centimetre. At least one of the one or more aerosol-generating substrates may have a density less than or equal to 0.5 grams per cubic centimetre. At least one of the one or more aerosol-generating substrates may have a density less than or equal to 0.4 grams per cubic centimetre. At least one of the one or more aerosol-generating substrates may have a density less than or equal to 0.3 grams per cubic centimetre.

At least one of the one or more aerosol-generating substrates may have a density between 0.05 grams and 0.9 grams per cubic centimetre. At least one of the one or more aerosol-generating substrates may have a density between 0.05 grams per cubic centimetre and 0.9 grams per cubic centimetre. At least one of the one or more aerosol-generating substrates may have a density between 0.1 grams per cubic centimetre and 0.8 grams per cubic centimetre. At least one of the one or more aerosol-generating substrates may have a density between 0.2 grams per cubic centimetre and 0.7 grams per cubic centimetre. At least one of the one or more aerosol-generating substrates may have a density between 0.2 grams per cubic centimetre and 0.6 grams per cubic centimetre. At least one of the one or more aerosol-generating substrates may have a density between 0.2 grams per cubic centimetre and 0.5 grams per cubic centimetre. At least one of the one or more aerosol-generating substrates may have a density between 0.2 grams per cubic centimetre and 0.4 grams per cubic centimetre.

The at least one of the one or more aerosol-generating substrates referred to above with respect to density may be, or may be at least one of, the aerosol-generating substrate layer, the first aerosol-generating substrate layer, the second aerosol-generating substrate layer, the aerosol-generating substrate positioned within the cavity or the first cavity, or the aerosol-generating substrate positioned with the second cavity. Preferably, the at least one of the one or more aerosol-generating substrates referred to above with respect to density may be, or may be at least one of, the aerosol-generating substrate positioned within the cavity or the first cavity, or the aerosol-generating substrate positioned with the second cavity.

Aerosol-generating substrates in aerosol-generating articles typically have a high density in order to promote heat conduction through the aerosol-generating substrate.

Advantageously, providing an aerosol-generating article with an aerosol-generating substrate having a relatively low density of less than or equal to 0.9 grams per cubic centimetre may allow for the aerosol-generating article to contain a reduced mass of the aerosol-generating article. A reduce mass of aerosol-generating substrate may make the aerosol-generating article more convenient to handle and easier to manufacture.

Advantageously, providing a low density aerosol-generating substrate in the cavity of an aerosol-generating article comprising a first planar external surface, a second planar external surface and a frame positioned between the first planar external surface and the second planar external surface may allow for efficient heating of the aerosol-generating substrate while still providing the advantages of a low density aerosol-generating substrate as described above.

At least one of the one or more aerosol-generating substrates may have a mass greater than or equal to 50 milligrams. At least one of the one or more aerosol-generating substrates may have a mass greater than or equal to 80 milligrams. At least one of the one or more aerosol-generating substrates may have a mass greater than or equal to 110 milligrams. At least one of the one or more aerosol-generating substrates may have a mass greater than or equal to 150 milligrams. At least one of the one or more aerosol-generating substrates may have a mass greater than or equal to 170 milligrams. At least one of the one or more aerosol-generating substrates may have a mass greater than or equal to 180 milligrams. At least one of the one or more aerosol-generating substrates may have a mass greater than or equal to 200 milligrams. At least one of the one or more aerosol-generating substrates may have a mass greater than or equal to 230 milligrams. At least one of the one or more aerosol-generating substrates may have a mass greater than or equal to 250 milligrams. At least one of the one or more aerosol-generating substrates may have a mass greater than or equal to 300 milligrams. At least one of the one or more aerosol-generating substrates may have a mass greater than or equal to 400 milligrams.

At least one of the one or more aerosol-generating substrates may have a mass less than or equal to 500 milligrams. At least one of the one or more aerosol-generating substrates may have a mass less than or equal to 400 milligrams. At least one of the one or more aerosol-generating substrates may have a mass less than or equal to 300 milligrams. At least one of the one or more aerosol-generating substrates may have a mass less than or equal to 250 milligrams. At least one of the one or more aerosol-generating substrates may have a mass less than or equal to 230 milligrams. At least one of the one or more aerosol-generating substrates may have a mass less than or equal to 200 milligrams. At least one of the one or more aerosol-generating substrates may have a mass less than or equal to 180 milligrams. At least one of the one or more aerosol-generating substrates may have a mass less than or equal to 170 milligrams. At least one of the one or more aerosol-generating substrates may have a mass less than or equal to 150 milligrams. At least one of the one or more aerosol-generating substrates may have a mass less than or equal to 110 milligrams. At least one of the one or more aerosol-generating substrates may have a mass less than or equal to 80 milligrams. At least one of the one or more aerosol-generating substrates may have a mass less than or equal to 50 milligrams.

At least one of the one or more aerosol-generating substrates may have a mass between 50 milligrams and 500 milligrams. At least one of the one or more aerosol-generating substrates may have a mass between 80 milligrams and 500 milligrams. At least one of the one or more aerosol-generating substrates may have a mass between 80 milligrams and 400 milligrams. At least one of the one or more aerosol-generating substrates may have a mass between 80 milligrams and 300 milligrams. At least one of the one or more aerosol-generating substrates may have a mass between 80 milligrams and 250 milligrams. At least one of the one or more aerosol-generating substrates may have a mass between 80 milligrams and 200 milligrams. At least one of the one or more aerosol-generating substrates may have a mass between 80 milligrams and 150 milligrams.

The at least one of the one or more aerosol-generating substrates referred to above with respect to mass may be, or may be at least one of, the aerosol-generating substrate layer, the first aerosol-generating substrate layer, the second aerosol-generating substrate layer, the aerosol-generating substrate positioned within the cavity or the first cavity, or the aerosol-generating substrate positioned with the second cavity. Preferably, the at least one of the one or more aerosol-generating substrates referred to above with respect to mass may be, or may be at least one of, the aerosol-generating substrate positioned within the cavity or the first cavity, or the aerosol-generating substrate positioned with the second cavity.

Advantageously, providing an aerosol-generating article with an aerosol-generating substrate less than or equal to 500 milligrams may reduce the amount of structural support that needs to be provided to the aerosol-generating article.

Advantageously, providing an aerosol-generating article with an aerosol-generating substrate greater than or equal 50 milligrams may allow the aerosol-generating substrate to provide some structural support to the aerosol-generating article.

Advantageously, providing an aerosol-generating article with a low mass of aerosol-generating substrate may result in better heating efficiency because the mass of aerosol-generating substrate to be heated is relatively low. A relatively low mass of aerosol-generating substrate is particularly advantageous during the first puff with the aerosol-generating article because the first puff can be achieved much faster than with an aerosol-generating article having a high mass of aerosol-generating substrate.

Advantageously, providing an aerosol-generating article with a low mass of aerosol-generating substrate may reduce the total water content of the aerosol-generating substrate. Reducing the total water content of the aerosol-generating substrate may reduce the temperature of the first puff.

The length of the aerosol-generating article may be defined in an x direction between a distal end and a proximal end of the aerosol-generating article. The aerosol-generating article may be divided over its length into a distal end portion and a proximal end portion. The distal end portion may extend from the distal end for 50% of the length of the aerosol-generating article and the proximal end portion may extend from the proximal end for 50% of the length of the aerosol-generating article.

A ratio of the mass of the one or more aerosol-generating substrates in the proximal end portion to the mass of the one or more aerosol-generating substrates in the distal end portion may be within a range of between 0.77 and 1.30.

A ratio of the mass of the one or more aerosol-generating substrates in the proximal end portion to the mass of the one or more aerosol-generating substrates in the distal end portion may be within a range of between 0.80 and 1.25, or between 0.83 and 1.2, or between 0.87 and 1.15; or between 0.91 and 1.10; or between 0.95 and 1.05.

The mass distribution of the one or more aerosol-generating substrates in the proximal end portion in a lengthwise direction of the proximal end portion may be symmetric with the mass distribution of the one or more aerosol-generating substrates in the distal end portion in a lengthwise direction of the distal end portion, relative to a midpoint of the length of the aerosol-generating article.

The one or more aerosol-generating substrates in the proximal end portion may be arranged across a width of proximal end portion in first and second halves of the width of the proximal end portion, wherein the ratio of the mass of the one or more aerosol-generating substrates in the first half of the width of the proximal end portion to the mass of aerosol-forming substrate in the second half of the width of the proximal end portion may be within a range of between 0.77 and 1.30, or between 0.80 and 1.25, or between 0.83 and 1.2, or between 0.87 and 1.15; or between 0.91 and 1.10; or between 0.95 and 1.05.

The one or more aerosol-generating substrates in the distal end portion may be arranged across a width of distal end portion in first and second halves of the width of the distal end portion. The ratio of the mass of the one or more aerosol-generating substrates in the first half of the width of the distal end portion to the mass of the one or more aerosol-generating substrates in the second half of the width of the distal end portion may be within a range of between 0.77 and 1.30, or between 0.80 and 1.25, or between 0.83 and 1.2, or between 0.87 and 1.15; or between 0.91 and 1.10; or between 0.95 and 1.05.

The one or more aerosol-generating substrates in the proximal end portion may be arranged across a height of proximal end portion in first and second halves of the height of the proximal end portion. The ratio of the mass of the one or more aerosol-generating substrates in the first half of the height of the proximal end portion to the mass of the one or more aerosol-generating substrates in the second half of the height of the proximal end portion may be within a range of between 0.77 and 1.30, or between 0.80 and 1.25, or between 0.83 and 1.2, or between 0.87 and 1.15; or between 0.91 and 1.10; or between 0.95 and 1.05.

The one or more aerosol-generating substrates in the distal end portion may be arranged across a height of distal end portion in first and second halves of the height of the distal end portion. The ratio of the mass of the one or more aerosol-generating substrates in the first half of the height of the distal end portion to the mass of the one or more aerosol-generating substrates in the second half of the height of the distal end portion may be within a range of between 0.77 and 1.30, or between 0.80 and 1.25, or between 0.83 and 1.2, or between 0.87 and 1.15; or between 0.91 and 1.10; or between 0.95 and 1.05.

The structure of the proximal end portion may be symmetric with the structure of the distal end portion, relative to a midpoint of the length of the aerosol-generating article.

The aerosol-generating article may comprise the outer wrapper and an aerosol-generating substrate as described herein positioned within the cavity.

The aerosol-generating article may comprise the outer wrapper, the frame, and an aerosol-generating substrate as described herein positioned within the cavity.

The aerosol-generating article may comprise the outer wrapper and the aerosol-generating substrate layer. The cavity may be empty or an aerosol-generating substrate as described herein may be positioned within the cavity.

The aerosol-generating article may comprise the outer wrapper, the frame, and the aerosol-generating substrate layer. The cavity may be empty or an aerosol-generating substrate as described herein may be positioned within the cavity.

The aerosol-generating article may comprise the outer wrapper, the first cavity, the second cavity and the aerosol-generating substrate layer. The first cavity may be empty or an aerosol-generating substrate as described herein may be positioned within the first cavity. The second cavity may be empty or an aerosol-generating substrate as described herein may be positioned within the second cavity.

The aerosol-generating article may comprise the outer wrapper, the frame, a first cavity, a second cavity and the aerosol-generating substrate layer. The first cavity may be empty or an aerosol-generating substrate as described herein may be positioned within the first cavity. The second cavity may be empty or an aerosol-generating substrate as described herein may be positioned within the second cavity.

The aerosol-generating article may comprise the outer wrapper, the first aerosol-generating substrate layer, and the second aerosol-generating substrate layer. The cavity may be empty or an aerosol-generating substrate as described herein may be positioned within the cavity.

The aerosol-generating article may comprise the outer wrapper, the frame, the first aerosol-generating substrate layer, and the second aerosol-generating substrate layer. The cavity may be empty or an aerosol-generating substrate as described herein may be positioned within the cavity.

The aerosol-generating article may comprise the outer wrapper, the first aerosol-generating substrate layer, the second aerosol-generating substrate layer, the first cavity, and the second cavity. The first cavity may be empty or an aerosol-generating substrate as described herein may be positioned within the first cavity. The second cavity may be empty or an aerosol-generating substrate as described herein may be positioned within the second cavity.

The aerosol-generating article may comprise the outer wrapper, the frame, the first aerosol-generating substrate layer, the second aerosol-generating substrate layer, the first cavity, and the second cavity. The first cavity may be empty or an aerosol-generating substrate as described herein may be positioned within the first cavity. The second cavity may be empty or an aerosol-generating substrate as described herein may be positioned within the second cavity.

The aerosol-generating article may comprise the first planar external layer, the second planar external layer, and the aerosol-generating substrate layer. The cavity may be empty or an aerosol-generating substrate as described herein may be positioned within the cavity.

The aerosol-generating article may comprise the first planar external layer, the second planar external layer, the frame, and the aerosol-generating substrate layer. The cavity may be empty or an aerosol-generating substrate as described herein may be positioned within the cavity.

The aerosol-generating article may comprise the first planar external layer, the second planar external layer, the aerosol-generating substrate layer, the first cavity, and the second cavity. The first cavity may be empty or an aerosol-generating substrate as described herein may be positioned within the first cavity. The second cavity may be empty or an aerosol-generating substrate as described herein may be positioned within the second cavity.

The aerosol-generating article may comprise the first planar external layer, the second planar external layer, the frame, the aerosol-generating substrate layer, a first cavity, and a second cavity. The first cavity may be empty or an aerosol-generating substrate as described herein may be positioned within the first cavity. The second cavity may be empty or an aerosol-generating substrate as described herein may be positioned within the second cavity.

The aerosol-generating article may comprise the first planar external layer, the second planar external layer, the first aerosol-generating substrate layer, and the second aerosol-generating substrate layer. The cavity may be empty or an aerosol-generating substrate as described herein may be positioned within the cavity.

The aerosol-generating article may comprise the first planar external layer, the second planar external layer, the frame, the first aerosol-generating substrate layer, and the second aerosol-generating substrate layer. The cavity may be empty or an aerosol-generating substrate as described herein may be positioned within the cavity.

The aerosol-generating article may comprise the first planar external layer, the second planar external layer, the first aerosol-generating substrate layer, the second aerosol-generating substrate layer, the first cavity and the second cavity. The first cavity may be empty or an aerosol-generating substrate as described herein may be positioned within the first cavity. The second cavity may be empty or an aerosol-generating substrate as described herein may be positioned within the second cavity.

The aerosol-generating article may comprise the first planar external layer, the second planar external layer, the frame, the first aerosol-generating substrate layer, the second aerosol-generating substrate layer, the first cavity and the second cavity. The first cavity may be empty or an aerosol-generating substrate as described herein may be positioned within the first cavity. The second cavity may be empty or an aerosol-generating substrate as described herein may be positioned within the second cavity.

The aerosol-generating material may comprise one or more organic materials such as tobacco, mint, tea and cloves. The aerosol-generating material may comprise one or more of: herb leaf, tobacco leaf, fragments of tobacco ribs, reconstituted tobacco, homogenised tobacco such as cast leaf, extruded tobacco, expanded tobacco, aerosol-generating films and gel compositions. The aerosol-generating material may be in the form of shredded aerosol-generating material. The shredded aerosol-generating material may comprise one or more of: strips and strands of aerosol-generating material, such as strips and strands of tobacco or homogenised tobacco material. The shredded aerosol-generating material may be in the form of a shredded sheet of homogenised tobacco material.

The aerosol-generating material may be cut filler. The aerosol-generating material may be tobacco cut filler. The cut filler may comprise one or more of bright tobacco, dark tobacco, aromatic tobacco and filler tobacco. Examples of bright tobaccos are Flue-Cured Brazil, Indian Flue-Cured, Chinese Flue-Cured, US Flue-Cured such as Virginia tobacco, and Flue-Cured from Tanzania. Examples of aromatic tobaccos are Oriental Turkey, Greek Oriental, semi-oriental tobacco but also Fire Cured, US Burley, such as Perique, and Rustica. Examples of dark tobacco are Dark Cured Brazil Galpao, Burley Malawi or other African Burley, Sun Cured or Air Cured Indonesian Kasturi. As used herein, the term “cut filler” is used to describe to a blend of shredded plant material, such as tobacco plant material, including, in particular, one or more of leaf lamina, processed stems and ribs, homogenised plant material.

The cut filler suitable to be used with the present invention generally may resemble cut filler used for conventional smoking articles. The cut width of the cut filler preferably may be between 0.3 millimetres and 2.0 millimetres, or between 0.5 millimetres and 1.2 millimetres, or between 0.6 millimetres and 0.9 millimetres. Preferably, the strands have a length of between about 10 millimetres and about 40 millimetres.

Preferably, the cut filler is soaked with the aerosol former. Soaking the cut filler can be done by spraying or by other suitable application methods. Preferably, the aerosol former in the cut filler comprises one or more of glycerol and propylene glycol. The aerosol former may consist of glycerol or propylene glycol or of a combination of glycerol and propylene glycol.

The aerosol-generating material may comprise homogenised plant material, preferably a homogenised tobacco material.

As used herein, the term “homogenised plant material” encompasses any plant material formed by the agglomeration of particles of plant. For example, sheets or webs of homogenised tobacco material for the aerosol-generating substrates of the present invention may be formed by agglomerating particles of tobacco material obtained by pulverising, grinding or comminuting plant material and optionally one or more of tobacco leaf lamina and tobacco leaf stems. The homogenised plant material may be produced by casting, extrusion, paper making processes or other any other suitable processes known in the art.

The homogenised plant material may be in the form of one or more sheets.

The homogenised plant material may be in the form of a plurality of pellets or granules.

The homogenised plant material may be in the form of a plurality of strands, strips or shreds. As used herein, the term “strand” describes an elongate element of material having a length that is substantially greater than the width and thickness thereof.

The aerosol-generating material may be in the form of a sheet of aerosol-generating material. As used herein, the term “sheet” describes a laminar element having a width and length substantially greater than the thickness thereof. The sheet of aerosol-generating material may be a sheet of plant material. The sheet of aerosol-generating material may be a sheet of tobacco material. The sheet of aerosol-generating material may be a sheet of homogenised tobacco material, such as a cast leaf sheet.

The sheet of aerosol-generating material may have a grammage of between 100 grams per square metre and 600 grams per square metre. The sheet of aerosol-generating material may have a grammage of between 100 grams per square metre and 300 grams per square metre.

The sheet of aerosol-generating material may have a density greater than or equal to 0.3 grams per cubic centimetre. The sheet of aerosol-generating material may have a density greater than or equal to 0.4 grams per cubic centimetre. The sheet of aerosol-generating material may have a density greater than or equal to 0.5 grams per cubic centimetre. The sheet of aerosol-generating material may have a density greater than or equal to 0.6 grams per cubic centimetre. The sheet of aerosol-generating material may have a density greater than or equal to 0.7 grams per cubic centimetre. The sheet of aerosol-generating material may have a density less than or equal to 0.8 grams per cubic centimetre.

The sheet of aerosol-generating material may have a density less than or equal to 1.0 grams per cubic centimetre. The sheet of aerosol-generating material may have a density less than or equal to 0.9 grams per cubic centimetre. The sheet of aerosol-generating material may have a density less than or equal to 0.8 grams per cubic centimetre. The sheet of aerosol-generating material may have a density less than or equal to 0.7 grams per cubic centimetre. The sheet of aerosol-generating material may have a density less than or equal to 0.6 grams per cubic centimetre. The sheet of aerosol-generating material may have a density less than or equal to 0.5 grams per cubic centimetre. The sheet of aerosol-generating material may have a density less than or equal to 0.4 grams per cubic centimetre.

The sheet of aerosol-generating material may have a density between 0.3 grams per cubic centimetre and 1.3 grams per cubic centimetre. The sheet of aerosol-generating material may have a density between 0.3 grams per cubic centimetre and 1.0 gram per cubic centimetre. The sheet of aerosol-generating material may have a density between 0.4 grams per cubic centimetre and 1.0 grams per cubic centimetre. The sheet of aerosol-generating material may have a density between 0.4 grams per cubic centimetre and 0.9 grams per cubic centimetre. The sheet of aerosol-generating material may have a density between 0.5 grams per cubic centimetre and 0.9 grams per cubic centimetre.

The sheet of aerosol-generating material may comprise between 2.5 percent and 95 percent by weight of plant particles on a dry weight basis. The sheet of aerosol-generating material may comprise between 5 percent and 90 percent by weight of plant particles on a dry weight basis. The sheet of aerosol-generating material may comprise between 10 percent and 80 percent by weight of plant particles on a dry weight basis. The sheet of aerosol-generating material may comprise between 15 percent and 70 percent by weight of plant particles on a dry weight basis. The sheet of aerosol-generating material may comprise between 20 percent and 60 percent by weight of plant particles on a dry weight basis. The sheet of aerosol-generating material may comprise between 30 percent and 50 percent by weight of plant particles on a dry weight basis. The sheet of aerosol-generating material may be a sheet of homogenised tobacco material comprising tobacco particles. The sheet of homogenised tobacco material may have a tobacco content of at least about 40 percent by weight on a dry weight basis. The sheet of homogenised tobacco material may have a tobacco content of at least about 50 percent by weight on a dry weight basis. The sheet of homogenised tobacco material may have a tobacco content of at least about 70 percent by weight on a dry weight basis. The sheet of homogenised tobacco material may have a tobacco content of at least about 90 percent by weight on a dry weight basis.

As used herein, the term “tobacco particles” may describe particles of any plant member of the genus Nicotiana. The term “tobacco particles” encompasses ground or powdered tobacco leaf lamina, ground or powdered tobacco leaf stems, tobacco dust, tobacco fines, and other particulate tobacco by-products formed during the treating, handling and shipping of tobacco. In a preferred embodiment, the tobacco particles are substantially all derived from tobacco leaf lamina. By contrast, isolated nicotine and nicotine salts are compounds derived from tobacco but are not considered tobacco particles for purposes of this disclosure and are not included in the percentage of particulate plant material.

The tobacco particles may be prepared from one or more varieties of tobacco plants. Any type of tobacco may be used in a blend. Examples of tobacco types that may be used include, but are not limited to, sun-cured tobacco, flue-cured tobacco, Burley tobacco, Maryland tobacco, Oriental tobacco, Virginia tobacco, and other speciality tobaccos.

Flue-curing is a method of curing tobacco, which is particularly used with Virginia tobaccos. During the flue-curing process, heated air is circulated through densely packed tobacco. During a first stage, the tobacco leaves turn yellow and wilt. During a second stage, the laminae of the leaves are completely dried. During a third stage, the leaf stems are completely dried.

Burley tobacco plays a significant role in many tobacco blends. Burley tobacco has a distinctive flavour and aroma and also has an ability to absorb large amounts of casing.

Oriental is a type of tobacco which has small leaves, and high aromatic qualities. However, Oriental tobacco has a milder flavour than, for example, Burley. Generally, therefore, Oriental tobacco is used in relatively small proportions in tobacco blends.

Kasturi, Madura and Jatim are subtypes of sun-cured tobacco that can be used. Preferably, Kasturi tobacco and flue-cured tobacco may be used in a blend to produce the tobacco particles. Accordingly, the tobacco particles in the particulate plant material may comprise a blend of Kasturi tobacco and flue-cured tobacco.

The tobacco particles may have a nicotine content of at least about 2.5 percent by weight, based on dry weight. More preferably, the tobacco particles may have a nicotine content of at least about 3 percent, even more preferably at least about 3.2 percent, even more preferably at least about 3.5 percent, most preferably at least about 4 percent by weight, based on dry weight.

The aerosol-generating material may comprise one or more cannabinoid compounds such as one or more of: tetrahydrocannabinol (THC), tetrahydrocannabinolic acid (THCA), cannabidiol (CBD), cannabidiolic acid (CBDA), cannabinol (CBN), cannabigerol (CBG), cannabigerol monomethyl ether (CBGM), cannabivarin (CBV), cannabidivarin (CBDV), tetrahydrocannabivarin (THCV), cannabichromene (CBC), cannabicyclol (CBL), cannabichromevarin (CBCV), cannabigerovarin (CBGV), cannabielsoin (CBE), cannabicitran (CBT). It may be preferable that the cannabinoid compound is CBD or THC. It may be particularly preferable that the cannabinoid compound is CBD.

The aerosol-generating material may comprise one or more aerosol-formers. Suitable aerosol-formers are well known in the art and include, but are not limited to, one or more aerosol-formers selected from: polyhydric alcohols, such as propylene glycol, polyethylene glycol, triethylene glycol, 1, 3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. It may be particularly preferable for the aerosol-former to be or comprise one or both of glycerine and propylene glycol. The aerosol former may consist of glycerine or propylene glycol or of a combination of glycerine and propylene glycol.

The aerosol-generating material may have an aerosol-former content greater than or equal to 1, 2, 5, 10, or 15 percent by weight on a dry weight basis. The aerosol-generating material may have an aerosol-former content greater than or equal to 15 percent by weight on a dry weight basis, for example greater than 20 by weight on a dry weight basis, or greater than 25 by weight on a dry weight basis, or greater than 30 by weight on a dry weight basis, or greater than 40 by weight on a dry weight basis, or greater than 50 by weight on a dry weight basis.

The aerosol-generating material may have an aerosol-former content less than or equal to 30 percent by weight on a dry weight basis, less than or equal to 25 percent by weight on a dry weight basis, or less than or equal to 20 percent by weight on a dry weight basis. That is, the aerosol-generating material may have an aerosol-former content less than or equal to 30 by weight on a dry weight basis, less than or equal to 25 by weight on a dry weight basis, or less than or equal to 20 by weight on a dry weight basis.

The aerosol-generating material may have an aerosol-former content between 1 percent and 30 percent by weight on a dry weight basis, between 1 percent and 25 percent by weight on a dry weight basis, or between 1 percent and 20 percent by weight on a dry weight basis.

The aerosol-generating material may have an aerosol-former content between 5 percent and 30 percent by weight on a dry weight basis, between 5 percent and 25 percent by weight on a dry weight basis, or between 5 percent and 20 percent by weight on a dry weight basis.

The aerosol-generating material may have an aerosol-former content between 10 percent and 30 percent by weight on a dry weight basis, between 10 percent and 25 percent by weight on a dry weight basis, or between 10 percent and 20 percent by weight on a dry weight basis.

The aerosol-generating material may have an aerosol-former content between 15 percent and 30 percent by weight on a dry weight basis, between 15 percent and 25 by weight on a dry weight basis, or between 15 percent and 20 percent by weight on a dry weight basis.

The aerosol-generating material may have an aerosol-former content of at least 50 percent by weight on a dry weight basis, at least 60 percent by weight on a dry weight basis, or at least 70 percent by weight on a dry weight basis.

The aerosol-generating material may comprise an aerosol-former content less than or equal to 85 percent by weight on a dry weight basis, less than or equal to 80 percent by weight on a dry weight basis, or less than or equal to 75 percent by weight on a dry weight basis.

The aerosol-generating material may comprise an aerosol-former content between 50 percent and 85 percent by weight on a dry weight basis, between 50 percent and 80 percent by weight on a dry weight basis, or between 50 percent and 75 percent by weight on a dry weight basis.

The aerosol-generating material may comprise an aerosol-former content between 60 percent and 85 by weight on a dry weight basis, between 60 percent and 80 percent by weight on a dry weight basis, or between 60 percent and 75 percent by weight on a dry weight basis.

The aerosol-generating material may comprise an aerosol-former content between 70 percent and 85 percent by weight on a dry weight basis, between 70 percent and 80 percent by weight on a dry weight basis, or between 70 percent and 75 percent by weight on a dry weight basis.

The aerosol-generating material may comprise hydroxypropylmethyl cellulose.

Advantageously, the inclusion of hydroxypropylmethyl cellulose in the aerosol-generating material may help in improving the manufacturing process of the aerosol-generating material. For example, hydroxypropylmethyl cellulose may reduce the overall viscosity of the slurry that is mixed when making the aerosol-generating material. A lower viscosity slurry may flow more easily compared to conventional slurries, and a lower viscosity slurry is easier to mix, transfer and handle during the manufacturing process.

The aerosol-generating material may comprise a hydroxypropylmethyl cellulose content of greater than or equal to 0.5 percent by weight. The aerosol-generating material may comprise a hydroxypropylmethyl cellulose content of greater than or equal to 1 percent by weight. The aerosol-generating material may comprise a hydroxypropylmethyl cellulose content of greater than or equal to 5 percent by weight. The aerosol-generating material may comprise a hydroxypropylmethyl cellulose content of greater than or equal to 10 percent by weight. The aerosol-generating material may comprise a hydroxypropylmethyl cellulose content of greater than or equal to 15 percent by weight. The aerosol-generating material may comprise a hydroxypropylmethyl cellulose content of greater than or equal to 20 percent by weight.

The aerosol-generating material may comprise a hydroxypropylmethyl cellulose content of less than or equal to 50 percent by weight. The aerosol-generating material may comprise a hydroxypropylmethyl cellulose content of less than or equal to 45 percent by weight. The aerosol-generating material may comprise a hydroxypropylmethyl cellulose content of less than or equal to 40 percent by weight. The aerosol-generating material may comprise a hydroxypropylmethyl cellulose content of less than or equal to 35 percent by weight. The aerosol-generating material may comprise a hydroxypropylmethyl cellulose content of less than or equal to 30 percent by weight. The aerosol-generating material may comprise a hydroxypropylmethyl cellulose content of less than or equal to 25 percent by weight. The aerosol-generating material may comprise a hydroxypropylmethyl cellulose content of less than or equal to 20 percent by weight.

The aerosol-generating material may comprise a hydroxypropylmethyl cellulose content of between 0.5 percent by weight and 50 percent by weight.

The aerosol-generating material may comprise one or more cellulose based strengthening agents. Advantageously, the inclusion of a cellulose based strengthening agent in the aerosol-generating material may increase the tensile strength of the aerosol-generating material. An aerosol-generating material with a higher tensile strength may be less likely to deteriorate or break, for example during transit or during the manufacturing process.

The aerosol-generating material may have a cellulose based strengthening agent content of greater than or equal to 0.5 percent by weight. The aerosol-generating material may have a cellulose based strengthening agent content of greater than or equal to 1 percent by weight. The aerosol-generating material may have a cellulose based strengthening agent content of greater than or equal to 0.5 percent by weight. The aerosol-generating material may have a cellulose based strengthening agent content of greater than or equal to 5 percent by weight. The aerosol-generating material may have a cellulose based strengthening agent content of greater than or equal to 10 percent by weight. The aerosol-generating material may have a cellulose based strengthening agent content of greater than or equal to 15 percent by weight. The aerosol-generating material may have a cellulose based strengthening agent content of greater than or equal to 20 percent by weight.

The aerosol-generating material may have a cellulose based strengthening agent content less than or equal to 50 percent by weight. The aerosol-generating material may have a cellulose based strengthening agent content less than or equal to 45 percent by weight. The aerosol-generating material may have a cellulose based strengthening agent content less than or equal to 40 percent by weight. The aerosol-generating material may have a cellulose based strengthening agent content less than or equal to 35 percent by weight. The aerosol-generating material may have a cellulose based strengthening agent content less than or equal to 30 percent by weight. The aerosol-generating material may have a cellulose based strengthening agent content less than or equal to 25 percent by weight.

The aerosol-generating material may have a cellulose based strengthening agent content of between 0.5 percent by weight and 50 percent by weight. The aerosol-generating material may have a cellulose based strengthening agent content of between 0.5 percent by weight and 40 percent by weight.

The one or more cellulose based strengthening agents may comprise cellulose fibres. Advantageously, the present inventors have found that cellulose fibres may be a cellulose based strengthening agent that is particularly effective at increasing the tensile strength of an aerosol-generating material.

The aerosol-generating material may have a cellulose fibres content of greater than or equal to 0.5 percent by weight. The aerosol-generating material may have a cellulose fibres content of greater than or equal to 1 percent by weight. The aerosol-generating material may have a cellulose fibres content of greater than or equal to 5 percent by weight. The aerosol-generating material may have a cellulose fibres content of greater than or equal to 10 percent by weight. The aerosol-generating material may have a cellulose fibres content of greater than or equal to 15 percent by weight. The aerosol-generating material may have a cellulose fibres content of greater than or equal to 20 percent by weight.

The aerosol-generating material may have a cellulose fibres content of less than or equal to 50 percent by weight. The aerosol-generating material may have a cellulose fibres content of less than or equal to 45 percent by weight. The aerosol-generating material may have a cellulose fibres content of less than or equal to 40 percent by weight. The aerosol-generating material may have a cellulose fibres content of less than or equal to 35 percent by weight. The aerosol-generating material may have a cellulose fibres content of less than or equal to 30 percent by weight. The aerosol-generating material may have a cellulose fibres content I of ess than or equal to 25 percent by weight.

The aerosol-generating material may have a cellulose fibres content of between 0.5 percent by weight and 50 percent by weight. The aerosol-generating material may have a cellulose fibres content of between 0.5 percent by weight and 40 percent by weight.

The one or more cellulose based strengthening agents may comprise microcrystalline cellulose. Advantageously, the present inventors have found that microcrystalline cellulose may be a cellulose based strengthening agent that is particularly effective at increasing the tensile strength of an aerosol-generating material.

The aerosol-generating material may have a microcrystalline cellulose content of greater than or equal to 0.5 percent by weight. The aerosol-generating material may have a microcrystalline cellulose content of greater than or equal to 1 percent by weight. The aerosol-generating material may have a microcrystalline cellulose content of greater than or equal to 5 percent by weight. The aerosol-generating material may have a microcrystalline cellulose content of greater than or equal to 10 percent by weight. The aerosol-generating material may have a microcrystalline cellulose content of greater than or equal to 15 percent by weight. The aerosol-generating material may have microcrystalline cellulose content of greater than or equal to 20 percent by weight.

The aerosol-generating material may have a microcrystalline cellulose content of less than or equal to 50 percent by weight. The aerosol-generating material may have a microcrystalline cellulose content of less than or equal to 45 percent by weight. The aerosol-generating material may have a microcrystalline cellulose content of less than or equal to 40 percent by weight. The aerosol-generating material may have a microcrystalline cellulose content of less than or equal to 35 percent by weight. The aerosol-generating material may have a microcrystalline cellulose content of less than or equal to 30 percent by weight. The aerosol-generating material may have a microcrystalline cellulose content of less than or equal to 25 percent by weight.

The aerosol-generating material may have a microcrystalline cellulose content of between 0.5 percent by weight and 50 percent by weight. The aerosol-generating material may have a microcrystalline cellulose content of between 0.5 percent by weight and 40 percent by weight.

The one or more cellulose based strengthening agents may comprise cellulose powder. Advantageously, the present inventors have found that cellulose powder may be a cellulose based strengthening agent that is particularly effective at increasing the tensile strength of an aerosol-generating material.

The aerosol-generating material may have a cellulose powder content of greater than or equal to 0.5 percent by weight. The aerosol-generating material may have a cellulose powder content of greater than or equal to 1 percent by weight. The aerosol-generating material may have a cellulose powder content of greater than or equal to 0.5 percent by weight. The aerosol-generating material may have a cellulose powder content of greater than or equal to 5 percent by weight. The aerosol-generating material may have a cellulose powder content of greater than or equal to 10 percent by weight. The aerosol-generating material may have a cellulose powder content of greater than or equal to 15 percent by weight. The aerosol-generating material may have a cellulose powder content of greater than or equal to 20 percent by weight.

The aerosol-generating material may have a cellulose powder content of less than or equal to 50 percent by weight. The aerosol-generating material may have a cellulose powder content of less than or equal to 45 percent by weight. The aerosol-generating material may have a cellulose powder of content less than or equal to 40 percent by weight. The aerosol-generating material may have a cellulose powder content of less than or equal to 35 percent by weight. The aerosol-generating material may have a cellulose powder content of less than or equal to 30 percent by weight. The aerosol-generating material may have a cellulose powder content of less than or equal to 25 percent by weight.

The aerosol-generating material may have a cellulose powder content of between 0.5 percent by weight and 50 percent by weight. The aerosol-generating material may have a cellulose powder content of between 0.5 percent by weight and 40 percent by weight.

The aerosol-generating material may comprise a carboxymethyl cellulose.

Advantageously, the present inventors have found that using a carboxymethyl cellulose may help to reduce crusting of the aerosol-generating material when used in an aerosol-generating article.

The carboxymethyl cellulose may comprise sodium carboxymethyl cellulose. Advantageously, the present inventors have found that sodium carboxymethyl cellulose is a carboxymethyl cellulose that may be particularly effective at preventing the above mentioned problem of crusting.

The aerosol-generating material may have a carboxymethyl cellulose content of greater than or equal to 0.5 percent by weight. The aerosol-generating material may have a carboxymethyl cellulose content of greater than or equal to 1 percent by weight. The aerosol-generating material may have a carboxymethyl cellulose content of greater than or equal to 5 percent by weight. The aerosol-generating material may have a carboxymethyl cellulose content of greater than or equal to 10 percent by weight.

The aerosol-generating material may have a carboxymethyl cellulose content of less than or equal to 20 percent by weight. The aerosol-generating material may have a carboxymethyl cellulose content of less than or equal to 15 percent by weight. The aerosol-generating material may have a carboxymethyl cellulose content of less than or equal to 10 percent by weight. The aerosol-generating material may have a carboxymethyl cellulose content of less than or equal to 8 percent by weight. The aerosol-generating material may have a carboxymethyl cellulose content of less than or equal to 5 percent by weight.

The aerosol-generating material may have a carboxymethyl cellulose content of between 0.5 percent by weight and 20 percent by weight.

The aerosol-generating material may comprise nicotine. The aerosol-generating material may comprise natural nicotine, or synthetic nicotine, or a combination of natural nicotine and synthetic nicotine.

The aerosol-generating material may comprise at least 0.5 percent by weight of nicotine, at least 1 percent by weight of nicotine, at least 1.5 percent by weight of nicotine, or at least 2 percent by weight of nicotine. That is, The aerosol-generating material may have a nicotine content of at least 0.5 percent by weight, at least 1 percent by weight, at least 1.5 percent by weight, or at least 2 percent by weight.

The aerosol-generating material may comprise one or more flavourants. The one or more flavourants may comprise one or more of: one or more essential oils such as eugenol, peppermint oil and spearmint oil; one or both of menthol and eugenol; one or both of anethole and linalool; and a herbaceous material. Suitable herbaceous material includes herb leaf or other herbaceous material from herbaceous plants including, but not limited to, mints, such as peppermint and spearmint, lemon balm, basil, cinnamon, lemon basil, chive, coriander, lavender, sage, tea, thyme, and caraway. The one or more flavourants may comprise a tobacco material.

The aerosol-generating material may have a moisture content of about 5 to 25%, preferably of about 7 to 15%, at final product state. For example, the aerosol-generating material may be a homogenised tobacco material with a moisture of about 5 to 25%, preferably of about 7 to 15%, at final product state.

The aerosol-generating material may comprise Cellulose fibres. For example, the aerosol-generating material may comprise about 1 to 15% of cellulose fibres, preferably of about 3 to 7% of cellulose fibres. Preferably, cellulose fibres may have a length of about 10 to 250 μm, preferably of about 10 to 120 μm.

The aerosol-generating material may comprise organic fibres such as non-tobacco fibres, or tobacco fibres. For example The aerosol-generating material may comprise about 5 to 20%, preferably about 7 to 15% of tobacco fibres. Tobacco fibres are preferably derived from stems and/or or stalks, graded to fibres of a length of about 10 to 350 μm, preferably of about 10 to 180 μm. The aerosol-generating material may comprise about 10 to 30 %, preferably of about 15 to 25%, of a non-tobacco organic fibre. For example, organic fibres may derive from cellulose, cotton, wood, tea botanical varieties as sub-products, and sub-processed waste, the tea industry. Organic fibres are preferably of a length of about 10 to 400 μm, preferably of about 10 to 200 μm.

The aerosol-generating material may comprise a binder. For example, The aerosol-generating material may comprise about 1 to 10%, preferably of about 1 to 5%, of a binder such as any of common gums or pectins used in food and beverage (F&B) industries. Preferred binders may be natural pectins, such as fruit, for example citrus, or tobacco pectins; guar gums, land locust bean gums, such as hydroxyethyl and/or hydroxypropyl of those; starches, such as modified or derivatized starches; alginate; methyl, ethyl, ethylhydroxymethyl and carboxymethyl, celluloses; dextran; and xanthan gum. A preferable binder is guar. The binder may be a polyvinyl alcohol (PVOH).

The aerosol-generating material may comprise one or more botanicals. For example, the aerosol-generating material may comprise about 15 to 55 %, preferably of about 20 to 35 %, of botanicals such as Clove, Echinacea sp., Fennel, Ginger, Hawthorn berry, Elderberry, Monarda, Mullein leaves, Nettle, Plantain, Turmeric, Yarrow, and compounds of those.

The aerosol-generating material may comprise organic botanical extracts. For example, the aerosol-generating material may comprise about 1 to 15 %, preferably of about 2 to 7 %, of any of the previously referred botanicals, as well as menthol (dl-Menthol, C10H20O, 2-Isopropyl-5-methylcyclohexanol) such as obtained from Chaerophyllum macrospermum, Mesosphaerum sidifolium, or other related botanic varieties, as well as P-menthan-3-ol, as any secondary alcohol as diastereoisomers of 5-methyl-2-(propan-2-yl)cyclohexan-1-ol.

The aerosol-generating material may comprise botanical essential oils, for example about 0.5 to 5 %, preferably of about 1 to 3 %, of a botanical essential oil, for example a botanical essential oil such as of palm, coconut, and wooden-based essential oils.

The aerosol-generating material may comprise particles of a functional material, for example particles of carbon, graphite, activated carbon, or expanded graphite. Such materials may, for example, increase the thermal conductivity of the aerosol-forming material and improve efficiency of aerosol generation.

The aerosol-generating material may be in the form of an aerosol-generating film comprising a cellulosic based film-forming agent, nicotine and the aerosol former. The aerosol-generating film may further comprise a cellulose based strengthening agent. The aerosol-generating film may further comprise water, preferably 30 percent by weight of less of water.

As used herein, the term “film” is used to describe a solid laminar element having a thickness that is less than the width or length thereof. The film may be self-supporting.

In the context of the present disclosure the term “cellulose based film-forming agent” is used to describe a cellulosic polymer capable, by itself or in the presence of an auxiliary thickening agent, of forming a continuous film. Preferably, the cellulose based film-forming agent is selected from the group consisting of hydroxypropyl methylcellulose (HPMC), methylcellulose (MC), ethylcellulose (EC), hydroxyethyl methyl cellulose (HEMC), hydroxyethyl cellulose (HEC), hydroxypropyl cellulose (HPC), and combinations thereof. In particularly preferred embodiments, the cellulose based film-forming agent is HPMC.

Suitable aerosol-generating films are described in WO-A-2020/207733 and WO-A-2022/074157.

Preferably, the aerosol-generating film comprises between 0.5 percent and 10 percent by weight of nicotine, or between 1 percent and 8 percent by weight of nicotine, or between 2 percent and 6 percent by weight of nicotine, on a dry weight basis.

The aerosol-generating film may be a substantially tobacco-free aerosol-generating film.

The aerosol-generating material may comprise a gel composition that includes nicotine, at least one gelling agent and the aerosol former. The gel composition is preferably substantially tobacco free.

The preferred weight ranges for nicotine in the gel composition are the same as those defined above in relation to aerosol-generating films.

Suitable gel compositions are described in WO-A-2021/170642.

The gel composition preferably comprises at least 50 percent by weight of aerosol former, more preferably at least 60 percent by weight, more preferably at least 70 percent by weight of aerosol former, on a dry weight basis. The gel composition may comprise up to 80 percent by weight of aerosol former. The aerosol former in the gel composition is preferably glycerol.

The air inlet may be defined by the front wall of the aerosol-generating article. The air inlet may be defined by, and may extend through, the frame. The air inlet may be defined by the peripheral wall of the frame. The air inlet may extend through the peripheral wall of the frame. The air outlet may be defined by the back wall of the aerosol-generating article. The air outlet may be defined by, and may extend through, the frame. The air outlet may be defined by the peripheral wall of the frame. The outlet may extend though the peripheral wall of the frame.

The air inlet may have a round cross-section, a circular cross-section, an oval cross-section, a square cross-section, or a rectangular cross-section. The air outlet may have a round cross-section, a circular cross-section, an oval cross-section, a square cross-section, or a rectangular cross-section.

The air inlet may be defined by, or through, the first frame layer, the second frame layer or the third frame layer. The air inlet may be defined by, or through, the first frame layer and the second frame layer. The air inlet may be defined by, or through, the second frame layer and the third frame layer. The air inlet may be defined by, or through, the first frame layer, the second frame layer and the third frame layer.

The air outlet may be defined by, or through, the first frame layer, the second frame layer or the third frame layer. The air outlet may be defined by, or through, the first frame layer and the second frame layer. The air outlet may be defined by, or through, the second frame layer and the third frame layer. The air outlet may be defined by, or through, the first frame layer, the second frame layer and the third frame layer.

The air inlet may be defined by, and may extend through, the first planar external surface. The air inlet may be defined by, and may extend through, the outer wrapper. The air inlet may be defined by, and may extend through, the outer wrapper and the aerosol-generating substrate layer. The air inlet may be defined by, and may extend through, the outer wrapper and the first aerosol-generating substrate layer. The air inlet may be defined by, and may extend through, the first planar external layer and the aerosol-generating substrate layer. The air inlet may be defined by, and may extend through, the first planar external layer and the first aerosol-generating substrate layer.

The air inlet may be defined by, and may extend through, the second planar external surface. The air inlet may be defined by, and may extend through, the outer wrapper and the second aerosol-generating substrate layer. The air inlet may be defined by, and may extend through, the second planar external layer and the aerosol-generating substrate layer. The air inlet may be defined by, and may extend through, the second planar external layer and the second aerosol-generating substrate layer.

The air outlet may be defined by, and may extend through, the first planar external surface. The air outlet may be defined by, and may extend through, the outer wrapper. The air outlet may be defined by, and may extend through, the outer wrapper and the aerosol-generating substrate layer. The air outlet may be defined by, and may extend through, the outer wrapper and the first aerosol-generating substrate layer. The air outlet may be defined by, and may extend through, the first planar external layer and the aerosol-generating substrate layer. The air outlet may be defined by, and may extend through, the first planar external layer and the first aerosol-generating substrate layer.

The air outlet may be defined by, and may extend through, the second planar external surface. The air outlet may be defined by, and may extend through, the outer wrapper and the second aerosol-generating substrate layer. The air outlet may be defined by, and may extend through, the second planar external layer and the aerosol-generating substrate layer. The air outlet may be defined by, and may extend through, the second planar external layer and the second aerosol-generating substrate layer. The air inlet may have an equivalent diameter greater than or equal to 0.1 millimetres. The air inlet may have an equivalent diameter greater than or equal to 0.4 millimetres. The air inlet may have an equivalent diameter greater than or equal to 0.7 millimetres. The air inlet may have an equivalent diameter greater than or equal to 1.0 millimetres.

The air inlet may have an equivalent diameter less than or equal to 3 millimetres. The air inlet may have an equivalent diameter less than or equal to 2.7 millimetres. The air inlet may have an equivalent diameter less than or equal to 2.4 millimetres. The air inlet may have an equivalent diameter less than or equal to 2.1 millimetres. The air inlet may have an equivalent diameter less than or equal to 1.8 millimetres. The air inlet may have an equivalent diameter less than or equal to 1.5 millimetres.

The air inlet may have an equivalent diameter between 0.1 millimetres and 3 millimetres. The air inlet may have an equivalent diameter between 0.1 millimetres and 2.4 millimetres. The air inlet may have an equivalent diameter between 0.4 millimetres and 2.1 millimetres. The air inlet may have an equivalent diameter between 0.4 millimetres and 1.8 millimetres. The air inlet may have an equivalent diameter between 0.7 millimetres and 1.5 millimetres. The air inlet may have an equivalent diameter between 1.0 millimetres and 1.5 millimetres.

The air outlet may have an equivalent diameter greater than or equal to 0.1 millimetres. The air outlet may have an equivalent diameter greater than or equal to 0.4 millimetres. The air outlet may have an equivalent diameter greater than or equal to 0.7 millimetres. The air outlet may have an equivalent diameter greater than or equal to 1.0 millimetres.

The air outlet may have an equivalent diameter less than or equal to 3 millimetres. The air outlet may have an equivalent diameter less than or equal to 2.7 millimetres. The air outlet may have an equivalent diameter less than or equal to 2.4 millimetres. The air outlet may have an equivalent diameter less than or equal to 2.1 millimetres. The air outlet may have an equivalent diameter less than or equal to 1.8 millimetres. The air outlet may have an equivalent diameter less than or equal to 1.5 millimetres.

The air outlet may have an equivalent diameter between 0.1 millimetres and 3 millimetres. The air outlet may have an equivalent diameter between 0.1 millimetres and 2.4 millimetres. The air outlet may have an equivalent diameter between 0.4 millimetres and 2.1 millimetres. The air outlet may have an equivalent diameter between 0.4 millimetres and 1.8 millimetres. The air outlet may have an equivalent diameter between 0.7 millimetres and 1.5 millimetres. The air outlet may have an equivalent diameter between 1.0 millimetres and 1.5 millimetres.

The air inlet may have a width less than a width of the cavity. The air outlet may have a width less than a width of the cavity. The air inlet may have a thickness less than a thickness of the cavity. The air outlet may have a thickness less than a thickness of the cavity.

The air inlet may a width of between 0.3 millimetres and 3 millimetres. The air inlet may a width of between 0.5 millimetres and 2 millimetres.

The air inlet may have a thickness of between 0.3 millimetres and 3 millimetres. The air outlet may have a thickness of between 0.5 millimetres and 2 millimetres

Preferably, the air inlet may have a width of between 0.3 millimetres and 3 millimetres, and a thickness of between 0.3 millimetres and 3 millimetres.

The air outlet may a width of between 0.3 millimetres and 3 millimetres. The air outlet may a width of between 0.5 millimetres and 2 millimetres.

The air outlet may have a thickness of between 0.3 millimetres and 3 millimetres. The air outlet may have a thickness of between 0.5 millimetres and 2 millimetres

Preferably, the air outlet may have a width of between 0.3 millimetres and 3 millimetres, and a thickness of between 0.3 millimetres and 3 millimetres.

Advantageously, an aerosol-generating article having an air inlet or an air outlet with a width of between 0.3 millimetres and 3 millimetres and a thickness of between 0.3 millimetres and 3 millimetres may provide for a good resistance to draw through the aerosol-generating article.

Advantageously, an aerosol-generating article having an air outlet or air inlet with a width of between 0.3 millimetres and 3 millimetres and a thickness of between 0.3 millimetres and 3 millimetres may provide for a relatively large inlet or outlet opening while allowing for improved retention of the aerosol-generating substrate within the aerosol-generating article. Improved retention of the aerosol-generating substrate within the aerosol-generating article may reduce the risk of aerosol-generating substrate falling out of the aerosol-generating article.

A ratio of the width of the air inlet to the thickness of the air inlet may be between 0.33 and 3. A ratio of the width of the air inlet to the thickness of the air inlet may be between 0.5 and 1.5. A ratio of the width of the air inlet to the thickness of the air inlet may be between 0.75 and 1.25.

A ratio of the width of the air outlet to the thickness of the air outlet may be between 0.33 and 3. A ratio of the width of the air outlet to the thickness of the air outlet may be between 0.5 and 1.5. A ratio of the width of the air outlet to the thickness of the air outlet may be between 0.75 and 1.25.

The aerosol-generating article may comprise one or more air inlets. The aerosol-generating article may comprise a plurality of air inlets. One or each of the air inlets may have one or more of the features of the air inlet described herein.

The aerosol-generating article may comprise one or more air outlets. The aerosol-generating article may comprise a plurality of air outlets. One or each of the air outlets may have one or more of the features of the air outlet described herein.

The aerosol-generating article may comprise a filter element positioned downstream of the aerosol-forming substrate. The aerosol-generating article may comprise a filter element positioned downstream of the cavity. The aerosol-generating article may comprise a filter element at least partially positioned within the air outlet. The aerosol-generating article may comprise a filter element positioned within, and may be positioned at a downstream end of, the cavity.

The aerosol-generating article may comprise a filter element positioned upstream of the aerosol-forming substrate. The aerosol-generating article may comprise a filter element positioned upstream of the cavity. The aerosol-generating article may comprise a filter element at least partially positioned within the air inlet. The aerosol-generating article may comprise a filter element positioned within, and may be positioned at an upstream end of, the cavity.

The filter element may comprise one or more segments of a fibrous filtration material. Suitable fibrous filtration materials would be known to the skilled person. The filter element may comprise a cellulose acetate.

The aerosol-generating article may comprise a front wall. The front wall may extend from the first planar external surface to the second planar external surface. That is, the front wall extends in a transverse direction. The front wall may be a downstream wall and may be referred to as the downstream wall. The front wall may be defined by the frame, for example by the peripheral wall of the frame.

The aerosol-generating article may comprise a back wall. The back wall may extend from the first planar external surface to the second planar external surface. That is, the back wall extends in a transverse direction. The back wall may be a upstream wall and may be referred to as the upstream wall. The back wall may be defined by the frame, for example by the peripheral wall of the frame.

The aerosol-generating article may comprise one or more side walls. The one or more side walls may comprise a first side wall and a second side wall, such as a left side wall and a right side wall. The first side wall and the second side wall may oppose one another. The one or more side walls may extend from the front wall to the back wall. The one or more side walls may extend from the first planar external surface to the second planar external surface. The one or more side walls, such as the first side wall and the second side wall, may be defined by the frame, for example by the peripheral wall of the frame.

Any two or more of the front wall, the back wall, the one or more side walls may be integral with one another. Advantageously, this structure may provide a robust article which is easy to manufacture.

The aerosol-generating article may comprise a first end face. The first end face may extend from the first planar external surface to the second planar external surface. The first end face may be defined or formed by an external wall of the aerosol-generating article, such as the front wall or the back wall.

The aerosol-generating article may comprise a second end face. The second end face may extend from the first planar external surface to the second planar external surface. The second end face may be defined or formed by an external wall or surface of the aerosol-generating article, such as the front wall or the back wall. The second end face may be positioned opposite the first end face. The second end face may be parallel to the first end face.

The aerosol-generating article may comprise a first side face. The first side face may extend from the first planar external surface to the second planar external surface. The first side face may be defined or formed by an external wall of the aerosol-generating article, such as the first side wall or the second side wall. The first side face may extend from the first end face to the second end face.

The aerosol-generating article may comprise a second side face. The second side face may extend from the first planar external surface to the second planar external surface. The second side face may be defined or formed by an external wall of the aerosol-generating article, such as the first side wall or the second side wall. The second side face may extend from the first end face to the second end face. The second side face may be positioned opposite the first side face. The second side face may be parallel to the first side face.

The first end face and the first side face may form an internal angle equal to or less than 90 degrees. The first end face and the second side face may form an internal angle equal to or less than 90 degrees.

The aerosol-generating article may comprise a first external corner extending from the first planar external surface to the second planar external surface. The first external corner may connect the first end face of the aerosol-generating article and the first side face of the aerosol-generating article.

The first external corner may be chamfered or rounded.

In embodiments where the first external corner is rounded, the first external corner may have a radius of curvature. The radius of curvature of the first external corner may be measured in the x/y plane. The radius of curvature of the first external corner may be between 1.25 millimetres and 6.5 millimetres.

The radius of curvature of the first external corner may be less than or equal to 50 percent of the width of the aerosol-generating article. The radius of curvature of the first external corner may be less than or equal to 30 percent of the width of the aerosol-generating article. The radius of curvature of the first external corner may be less than or equal to 20 percent of the width of the aerosol-generating article. The radius of curvature of the first external corner may be less than or equal to 10 percent of the width of the aerosol-generating article.

The radius of curvature of the first external corner may be greater than or equal to 1 percent of the width of the aerosol-generating article. The radius of curvature of the first external corner may be greater than or equal to 5 percent of the width of the aerosol-generating article. The radius of curvature of the first external corner may be greater than or equal to 10 percent of the width of the aerosol-generating article.

The radius of curvature of the first external corner may be between 1 percent and 50 percent of the width of the aerosol-generating article. The radius of curvature of the first external corner may be between 1 percent and 30 percent of the width of the aerosol-generating article. The radius of curvature of the first external corner may be between 5 percent and 30 percent of the width of the aerosol-generating article. The radius of curvature of the first external corner may be between 5 percent and 20 percent of the width of the aerosol-generating article.

In embodiments where the first external corner is chamfered, the first external corner may be chamfered at an angle between 30 degrees and 60 degrees as measured from the first end face. The first external corner may be chamfered at an angle between 40 degrees and 50 degrees as measured from the first end face. The first external corner may be chamfered at an angle of 45 degrees as measured from the first end face.

The first external corner may comprise a first corner surface connecting the first end face to the second side face. The first end face may connect to the first corner surface at a first corner transition region and, in any x/y plane, a first corner internal angle formed between a tangent of the first end face at the first corner transition region and a tangent of the first corner surface at the first corner transition region may be between 90 degrees and 180 degrees. The first corner internal angle may be between 120 degrees and 180 degrees. The first corner internal angle may be between 130 degrees and 180 degrees.

The aerosol-generating article may comprise a second external corner extending from the first planar external surface to the second planar external surface. The second external corner may connect the first end face of the aerosol-generating article and the second side face of the aerosol-generating article.

The second external corner may be chamfered or rounded.

In embodiments where the second external corner is rounded, the second external corner may have a radius of curvature. The radius of curvature of the second external corner may be measured in the x/y plane. The radius of curvature of the second external corner may be between 1.25 millimetres and 6.5 millimetres.

The radius of curvature of the second external corner may be less than or equal to 50 percent of the width of the aerosol-generating article. The radius of curvature of the second external corner may be less than or equal to 30 percent of the width of the aerosol-generating article. The radius of curvature of the second external corner may be less than or equal to 20 percent of the width of the aerosol-generating article. The radius of curvature of the second external corner may be less than or equal to 10 percent of the width of the aerosol-generating article.

The radius of curvature of the second external corner may be greater than or equal to 1 percent of the width of the aerosol-generating article. The radius of curvature of the second external corner may be greater than or equal to 5 percent of the width of the aerosol-generating article. The radius of curvature of the second external corner may be greater than or equal to 10 percent of the width of the aerosol-generating article.

The radius of curvature of the second external corner may be between 1 percent and 50 percent of the width of the aerosol-generating article. The radius of curvature of the second external corner may be between 1 percent and 30 percent of the width of the aerosol-generating article. The radius of curvature of the second external corner may be between 5 percent and 30 percent of the width of the aerosol-generating article. The radius of curvature of the second external corner may be between 5 percent and 20 percent of the width of the aerosol-generating article.

In embodiments where both first external corner and the second external corner are rounded, a radius of curvature of the first external corner may be the same as a radius of curvature of the second external corner.

In embodiments where the second external corner is chamfered, the second external corner may be chamfered at an angle between 30 degrees and 60 degrees as measured from the first end face. The second external corner may be chamfered at an angle between 40 degrees and 50 degrees as measured from the first end face. The second external corner may be chamfered at an angle of 45 degrees as measured from the first end face.

The second external corner may comprise a second corner surface connecting the first end face to the second side face. The first end face may connect to the second corner surface at a second corner transition region and, in any x/y plane, a second corner internal angle formed between a tangent of the first end face at the second corner transition region and a tangent of the second corner surface at the second corner transition region may be between 90 degrees and 180 degrees. The second corner internal angle may be between 120 degrees and 180 degrees. The second corner internal angle may be between 130 degrees and 180 degrees.

The aerosol-generating article may comprise a third external corner extending from the first planar external surface to the second planar external surface. The third external corner may connect the second end face of the aerosol-generating article and the first side face of the aerosol-generating article.

The third external corner may be chamfered or rounded.

In embodiments where the third external corner is rounded, the third external corner may have a radius of curvature. The radius of curvature of the third external corner may be measured in the x/y plane. The radius of curvature of the third external corner may be between 1.25 millimetres and 6.5 millimetres.

The radius of curvature of the third external corner may be less than or equal to 50 percent of the width of the aerosol-generating article. The radius of curvature of the third external corner may be less than or equal to 30 percent of the width of the aerosol-generating article. The radius of curvature of the third external corner may be less than or equal to 20 percent of the width of the aerosol-generating article. The radius of curvature of the third external corner may be less than or equal to 10 percent of the width of the aerosol-generating article.

The radius of curvature of the third external corner may be greater than or equal to 1 percent of the width of the aerosol-generating article. The radius of curvature of the third external corner may be greater than or equal to 5 percent of the width of the aerosol-generating article. The radius of curvature of the third external corner may be greater than or equal to 10 percent of the width of the aerosol-generating article.

The radius of curvature of the third external corner may be between 1 percent and 50 percent of the width of the aerosol-generating article. The radius of curvature of the third external corner may be between 1 percent and 30 percent of the width of the aerosol-generating article. The radius of curvature of the third external corner may be between 5 percent and 30 percent of the width of the aerosol-generating article. The radius of curvature of the third external corner may be between 5 percent and 20 percent of the width of the aerosol-generating article.

In embodiments where the third external corner is chamfered, the third external corner may be chamfered at an angle between 30 degrees and 60 degrees as measured from the second end face. The third external corner may be chamfered at an angle between 40 degrees and 50 degrees as measured from the third end face. The third external corner may be chamfered at an angle of 45 degrees as measured from the third end face.

The aerosol-generating article may comprise a fourth external corner extending from the first planar external surface to the second planar external surface. The fourth external corner may connect the second end face of the aerosol-generating article and the second side face of the aerosol-generating article.

The fourth external corner may be chamfered or rounded.

In embodiments where the fourth external corner is rounded, the fourth external corner may have a radius of curvature. The radius of curvature of the fourth external corner may be measured in the x/y plane. The radius of curvature of the fourth external corner may be between 1.25 millimetres and 6.5 millimetres.

The radius of curvature of the fourth external corner may be less than or equal to 50 percent of the width of the aerosol-generating article. The radius of curvature of the fourth external corner may be less than or equal to 30 percent of the width of the aerosol-generating article. The radius of curvature of the fourth external corner may be less than or equal to 20 percent of the width of the aerosol-generating article. The radius of curvature of the fourth external corner may be less than or equal to 10 percent of the width of the aerosol-generating article.

The radius of curvature of the fourth external corner may be greater than or equal to 1 percent of the width of the aerosol-generating article. The radius of curvature of the fourth external corner may be greater than or equal to 5 percent of the width of the aerosol-generating article. The radius of curvature of the fourth external corner may be greater than or equal to 10 percent of the width of the aerosol-generating article.

The radius of curvature of the fourth external corner may be between 1 percent and 50 percent of the width of the aerosol-generating article. The radius of curvature of the fourth external corner may be between 1 percent and 30 percent of the width of the aerosol-generating article. The radius of curvature of the fourth external corner may be between 5 percent and 30 percent of the width of the aerosol-generating article. The radius of curvature of the fourth external corner may be between 5 percent and 20 percent of the width of the aerosol-generating article.

In embodiments where the fourth external corner is chamfered, the fourth external corner may be chamfered at an angle between 30 degrees and 60 degrees as measured from the second end face. The fourth external corner may be chamfered at an angle between 40 degrees and 50 degrees as measured from the third end face. The fourth external corner may be chamfered at an angle of 45 degrees as measured from the third end face.

Advantageously, providing an aerosol-generating article having at least one external corner extending from the first planar external surface to the second planar external surface that is rounded or chamfered may make the aerosol-generating article easier to insert into an aerosol-generating device.

Advantageously, providing an aerosol-generating article having at least one external corner extending from the first planar external surface to the second planar external surface that is rounded or chamfered may make the aerosol-generating article less susceptible to damage, particularly during insertion of the aerosol-generating article into an aerosol-generating device.

Advantageously, providing an aerosol-generating article having at least one external corner extending from the first planar external surface to the second planar external surface that is rounded or chamfered may make the aerosol-generating article easier to manufacture.

A ratio between the length and the thickness of the aerosol-generating article, and between the width and the thickness of the aerosol-generating article may be greater than 2:1. A ratio between the length and the thickness of the aerosol-generating article, and between the width and the thickness of the aerosol-generating article may be greater than 3:1. A ratio between the length and the thickness of the aerosol-generating article, and between the width and the thickness of the aerosol-generating article may be greater than 4:1. A ratio between the length and the thickness of the aerosol-generating article, and between the width and the thickness of the aerosol-generating article may be greater than 5:1. A ratio between the length and the thickness of the aerosol-generating article, and between the width and the thickness of the aerosol-generating article may be greater than 10:1. A ratio between the length and the thickness of the aerosol-generating article, and between the width and the thickness of the aerosol-generating article may be greater than 12:1. A ratio between the length and the thickness of the aerosol-generating article, and between the width and the thickness of the aerosol-generating article may be greater than 15:1.

A ratio between the length and the thickness of the aerosol-generating article, and between the width and the thickness of the aerosol-generating article may be less than 15:1. A ratio between the length and the thickness of the aerosol-generating article, and between the width and the thickness of the aerosol-generating article may be less than 12:1. A ratio between the length and the thickness of the aerosol-generating article, and between the width and the thickness of the aerosol-generating article may be less than 10:1. A ratio between the length and the thickness of the aerosol-generating article, and between the width and the thickness of the aerosol-generating article may be less than 5:1. A ratio between the length and the thickness of the aerosol-generating article, and between the width and the thickness of the aerosol-generating article may be less than 4:1. A ratio between the length and the thickness of the aerosol-generating article, and between the width and the thickness of the aerosol-generating article may be less than 3:1. A ratio between the length and the thickness of the aerosol-generating article, and between the width and the thickness of the aerosol-generating article is less than 2.5:1.

A ratio between the length and the thickness of the aerosol-generating article, and between the width and the thickness of the aerosol-generating article may be between 2:1 and 15:1. A ratio between the length and the thickness of the aerosol-generating article, and between the width and the thickness of the aerosol-generating article may be between 2:1 and 12:1. A ratio between the length and the thickness of the aerosol-generating article, and between the width and the thickness of the aerosol-generating article may be between 2:1 and 10:1. A ratio between the length and the thickness of the aerosol-generating article, and between the width and the thickness of the aerosol-generating article may be between 3:1 and 10:1. A ratio between the length and the thickness of the aerosol-generating article, and between the width and the thickness of the aerosol-generating article may be between 4:1 and 10:1. A ratio between the length and the thickness of the aerosol-generating article, and between the width and the thickness of the aerosol-generating article may be between 5:1 and 10:1.

A ratio between the length and the width of the aerosol-generating article may be greater than 1:1. A ratio between the length and the width of the aerosol-generating article may be greater than 1.25:1. A ratio between the length and the width of the aerosol-generating article may be greater than 1.5:1. A ratio between the length and the width of the aerosol-generating article may be greater than 2:1. A ratio between the length and the width of the aerosol-generating article may be greater than 2.5:1. A ratio between the length and the width of the aerosol-generating article may be greater than 3:1. A ratio between the length and the width of the aerosol-generating article may be greater than 4:1. A ratio between the length and the width of the aerosol-generating article may be greater than 5:1.

A ratio between the length and the width of the aerosol-generating article may be less than 10:1. A ratio between the length and the width of the aerosol-generating article may be less than 8:1. A ratio between the length and the width of the aerosol-generating article may be less than 5:1. A ratio between the length and the width of the aerosol-generating article may be less than 4:1. A ratio between the length and the width of the aerosol-generating article may be less than 3.5:1. A ratio between the length and the width of the aerosol-generating article may be less than 3:1. A ratio between the length and the width of the aerosol-generating article may be less than 2.5:1. A ratio between the length and the width of the aerosol-generating article may be less than 2:1.

A ratio between the length and the width of the aerosol-generating article may be between 1:1 and 10:1. A ratio between the length and the width of the aerosol-generating article may be between 1.5:1 and 5:1. A ratio between the length and the width of the aerosol-generating article may be between 1.5:1 and 4:1. A ratio between the length and the width of the aerosol-generating article may be between 1.5:1 and 3:1. A ratio between the length and the width of the aerosol-generating article may be between 2:1 and 4:1. A ratio between the length and the width of the aerosol-generating article may be between 2:1 and 3:1.

The aerosol-generating article may have a length greater than or equal to 15 millimetres. The aerosol-generating article may have a length greater than or equal to 20 millimetres. The aerosol-generating article may have a length greater than or equal to 25 millimetres. The aerosol-generating article may have a length greater than or equal to 30 millimetres. The aerosol-generating article may have a length greater than or equal to 35 millimetres. The aerosol-generating article may have a length greater than or equal to 40 millimetres.

The aerosol-generating article may have a length less than or equal to 45 millimetres. The aerosol-generating article may have a length less than or equal to 40 millimetres. The aerosol-generating article may have a length less than or equal to 35 millimetres. The aerosol-generating article may have a length less than or equal to 30 millimetres.

The aerosol-generating article may have a length between 15 millimetres and 45 millimetres. The aerosol-generating article may have a length between 20 millimetres and 40 millimetres. The aerosol-generating article may have a length between 20 millimetres and 35 millimetres. The aerosol-generating article may have a length between 25 millimetres and 30 millimetres.

The aerosol-generating article may have a width equal to greater than 3 millimetres. The aerosol-generating article may have a width greater than or equal to 5 millimetres. The aerosol-generating article may have a width greater than or equal to 7.5 millimetres. The aerosol-generating article may have a width greater than or equal to 9 millimetres. The aerosol-generating article may have a width greater than or equal to 11 millimetres. The aerosol-generating article may have a width greater than or equal to 13 millimetres.

The aerosol-generating article may have a width less than or equal to or equal to 17 millimetres. The aerosol-generating article may have a width less than or equal to 15 millimetres. The aerosol-generating article may have a width less than or equal to 12.5 millimetres. The aerosol-generating article may have a width less than or equal to 11 millimetres. The aerosol-generating article may have a width less than or equal to 9 millimetres.

The aerosol-generating article may have a width between 3 millimetres and 17 millimetres. The aerosol-generating article may have a width between 5 millimetres and 15 millimetres. The aerosol-generating article may have a width between 7.5 millimetres and 12.5 millimetres. The aerosol-generating article may have a width between 9 millimetres and 11 millimetres.

The aerosol-generating article may have a thickness equal to greater than 1 millimetre. The aerosol-generating article may have a thickness greater than or equal to 1.5 millimetres. The aerosol-generating article may have a thickness greater than or equal to 2 millimetres. The aerosol-generating article may have a thickness greater than or equal to 2.5 millimetres. The aerosol-generating article may have a thickness greater than or equal to 3 millimetres. The aerosol-generating article may have a thickness greater than or equal to 3.5 millimetres. The aerosol-generating article may have a thickness greater than or equal to 4 millimetres. The aerosol-generating article may have a thickness greater than or equal to 4.5 millimetres.

The aerosol-generating article may have a thickness less than or equal to 5.5 millimetres. The aerosol-generating article may have a thickness less than or equal to 5 millimetres. The aerosol-generating article may have a thickness less than or equal to 4.5 millimetres. The aerosol-generating article may have a thickness less than or equal to 4 millimetres. The aerosol-generating article may have a thickness less than or equal to 3.5 millimetres. The aerosol-generating article may have a thickness less than or equal to 3 millimetres. The aerosol-generating article may have a thickness less than 2.5 millimetres. The aerosol-generating article may have a thickness less than 2 millimetres.

The aerosol-generating article may have a thickness between 1 millimetres and 5 millimetres. The aerosol-generating article may have a thickness between 1.5 millimetres and 5 millimetres. The aerosol-generating article may have a thickness between 2 millimetres and 4.5 millimetres. The aerosol-generating article may have a thickness between 2.5 millimetres and 4 millimetres. The aerosol-generating article may have a thickness between 3 millimetres and 3.5 millimetres.

The aerosol-generating article may have a length between 15 millimetres and 45 millimetres, a width between 5 millimetres and 15 millimetres, and a thickness between 1 millimetres and 5 millimetres.

Preferably, the aerosol-generating article may have a length between 20 millimetres and 30 millimetres, a width between 7.5 millimetres and 12.5 millimetres, and a thickness between 2.5 millimetres and 4 millimetres.

More preferably, the aerosol-generating article may have a length of 30 millimetres, a width of 10 millimetres and a thickness of 3.1 millimetres.

Advantageously, providing an aerosol-generating article having a length of between 15 millimetres and 45 millimetres, a width of between 5 millimetres and 15 millimetres, and a thickness of between 1 millimetre and 5 millimetres may result in an aerosol-generating article that has a high ratio of external surface to volume. An aerosol-generating article having a high ratio of external surface to volume may be more efficiently heated, which may result in better vaporisation of an aerosol-generating substrate stored within the aerosol-generating article. Better vaporisation of an aerosol-generating substrate stored within the aerosol-generating article may lead to an improved user experience.

Advantageously, providing an aerosol-generating article having a length of between 15 millimetres and 45 millimetres, a width of between 5 millimetres and 15 millimetres, and a thickness of between 1 millimetre and 5 millimetres, with a cavity having a length of between 14 millimetres and 40 millimetres, a width of between 4.5 millimetres and 13 millimetres, and a thickness of between 0.5 millimetres and 4.5 millimetres, may result in the aerosol-generating article containing a large cavity and having a high cavity volume in proportion to external volume of the aerosol-generating article.

The aerosol-generating article may have an external volume of between 75 cubic millimetres and 3375 cubic millimetres. The aerosol-generating article may have an external volume of between 375 cubic millimetres and 1750 cubic millimetres.

The aerosol-generating article may have a resistance to draw (RTD) of less than or equal to 20 millimetre H₂O. The aerosol-generating article may have a resistance to draw (RTD) of less than or equal to 10 millimetre H₂O. The aerosol-generating article may have a resistance to draw (RTD) of less than or equal to 8 millimetre H₂O. The aerosol-generating article may have a resistance to draw (RTD) of less than or equal to 6 millimetre H₂O. The aerosol-generating article may have a resistance to draw (RTD) of less than or equal to 4 millimetre H₂O. The aerosol-generating article may have a resistance to draw (RTD) of less than or equal to 2 millimetre H₂O. The aerosol-generating article may have a resistance to draw (RTD) equal to, or close to, zero millimetres H₂O.

The aerosol-generating article may have a resistance to draw (RTD) between 0 millimetres H₂O and 9.9 millimetres H₂O. The aerosol-generating article may have a resistance to draw (RTD) between 1 millimetre H₂O and 8 millimetres H₂O. The aerosol-generating article may have a resistance to draw (RTD) between 2 millimetres H₂O and 6 millimetres H₂O. The aerosol-generating article may have a resistance to draw (RTD) between 3 millimetres H₂O and 5 millimetres H₂O.

Unless otherwise specified, the resistance to draw (RTD) is measured in accordance with ISO 6565-2015. The RTD refers to the pressure required to force air through the aerosol-generating article between the air inlet and the air outlet. The terms “pressure drop” or “draw resistance” of a component or article may also refer to the “resistance to draw”. Such terms generally refer to the measurements in accordance with ISO 6565-2015 are normally carried out at under test at a volumetric flow rate of about 17.5 millilitres per second at the output or downstream end of the measured component at a temperature of about 22 degrees Celsius, a pressure of about 101 kPa (about 760 Torr) and a relative humidity of about 60%.

According to the present disclosure, there is provided a method of manufacturing an aerosol-generating article as described herein. The method comprises: providing a first sheet of material, a second sheet of material and a third sheet of material; forming an aperture through the first sheet of material to form a frame; positioning the aperture between the second sheet of material and the third sheet of material; and bonding the first sheet of material, the second sheet of material, and the third sheet of material to form the aerosol-generating article.

According to the present disclosure, there is provided a method of manufacturing an aerosol-generating article as described herein. The method comprises providing sheet material comprising: a first sheet of frame material, a first sheet of external layer material, and a second sheet of external layer material. The method comprises forming an aperture through the first sheet of frame material. The method comprises positioning the first sheet of frame material and the aperture between the first sheet of external layer material and the second sheet of external layer material. The method comprises bonding the sheet material to one another.

According to the present disclosure, there is provided a method of manufacturing an aerosol-generating article as described herein. The method comprises providing sheet material comprising: a first sheet of frame material, a first sheet of aerosol-generating material, a second sheet of aerosol-generating material, a first sheet of external layer material, and a second sheet of external layer material. The method comprises forming an aperture through the first sheet of frame material. The method comprises positioning the first sheet of frame material and the aperture between the first sheet of aerosol-generating material and the second sheet of aerosol-generating material. The method comprises positioning the first sheet of frame material, the aperture, the first sheet of aerosol-generating material and the second sheet of aerosol-generating material between the first sheet of external layer material and the second sheet of external layer material. The method comprises bonding the sheet material to one another.

According to the present disclosure, there is provided a method of manufacturing an aerosol-generating article as described herein. The method comprises providing sheet material comprising: a first sheet of frame material, a second sheet of frame material, a first sheet of external layer material, and a second sheet of external layer material. The method may comprise bonding the first sheet of frame material and the second sheet of frame material to one another. The method comprises forming an aperture through the first sheet of frame material and the second sheet of frame material, for example after they have been bonded. The method comprises positioning the first sheet of frame material, the second sheet of frame material and the aperture between the first sheet of external layer material and the second sheet of external layer material. The method comprises bonding the sheet material to one another.

According to the present disclosure, there is provided a method of manufacturing an aerosol-generating article as described herein. The method comprises providing sheet material comprising: a first sheet of frame material, a second sheet of frame material, a first sheet of aerosol-generating material, a second sheet of aerosol-generating material, a first sheet of external layer material, and a second sheet of external layer material. The method may comprise bonding the first sheet of frame material and the second sheet of frame material to one another. The method comprises forming an aperture through the first sheet of frame material and the second sheet of frame material, for example after they have been bonded. The method comprises positioning the first sheet of frame material, the second sheet of frame material, and the aperture between the first sheet of aerosol-generating material and the second sheet of aerosol-generating material. The method comprises positioning the first sheet of frame material, the second sheet of frame material, the aperture, the first sheet of aerosol-generating material and the second sheet of aerosol-generating material between the first sheet of external layer material and the second sheet of external layer material. The method comprises bonding the sheet material to one another.

According to the present disclosure, there is provided a method of manufacturing an aerosol-generating article as described herein. The method comprises providing sheet material comprising: a first sheet of frame material, a second sheet of frame material, a third sheet of frame material, a first sheet of external layer material, and a second sheet of external layer material. The method may comprise bonding the first sheet of frame material, the second sheet of frame material and the third sheet of frame material to one another. The method comprises forming an aperture through the first sheet of frame material, the second sheet of frame material and the third sheet of frame material, for example after they have been bonded. The method comprises positioning the first sheet of frame material, the second sheet of frame material, the third sheet of frame material and the aperture between the first sheet of external layer material and the second sheet of external layer material. The method comprises bonding the sheet material to one another.

According to the present disclosure, there is provided a method of manufacturing an aerosol-generating article as described herein. The method comprises providing sheet material comprising: a first sheet of frame material, a second sheet of frame material, a third sheet of frame material, a first sheet of aerosol-generating material, a second sheet of aerosol-generating material, a first sheet of external layer material, and a second sheet of external layer material. The method may comprise bonding the first sheet of frame material, the second sheet of frame material and the third sheet of frame material to one another. The method comprises forming an aperture through the first sheet of frame material, the second sheet of frame material and the third sheet of frame material, for example after they have been bonded. The method comprises positioning the first sheet of frame material, the second sheet of frame material, the third sheet of frame material and the aperture between the first sheet of aerosol-generating material and the second sheet of aerosol-generating material. The method comprises positioning the first sheet of frame material, the second sheet of frame material, the second sheet of aerosol-generating material, the aperture, the first sheet of aerosol-generating material and the second sheet of aerosol-generating material between the first sheet of external layer material and the second sheet of external layer material. The method comprises bonding the sheet material to one another.

The methods of manufacturing an aerosol-generating article described herein may comprise a step of positioning an aerosol-generating substrate within the aperture.

One or more of the first sheet of frame material, the second sheet of frame material, the third sheet of frame material in the methods of manufacturing described herein may be a sheet of paper or cardboard.

One or more of the first sheet of aerosol-generating material and the second sheet of aerosol-generating material in the methods of manufacturing described herein may be a sheet of homogenised tobacco material.

One or more of the first sheet of external layer material and the second sheet of external layer material in the methods of manufacturing described herein may be a sheet of cigarette paper. According to the present disclosure, there is provided an aerosol-generating device for receiving an aerosol-generating article as disclosed herein. The aerosol-generating device comprises a cavity dimensioned to receive at least a portion of the aerosol-generating article. The aerosol-generating device comprises a heater or heating means, a power source for supplying power to the heater or heating means, and a controller to control a supply of power to the heater or heating means. The aerosol-generating device is configured to heat at least one of the one or more aerosol-generating substrates to form an aerosol, for example an inhalable aerosol. The aerosol-generating device may be configured to heat each of the one or more aerosol-generating substrates to form an aerosol, for example an inhalable aerosol.

The cavity of the aerosol-generating device may comprise an opening into which an end, such as a longitudinal end, of the aerosol-generating article can be inserted. The cavity of the aerosol-generating device may have any suitable cross-sectional shape. For example, the cavity of the aerosol-generating device may have a rectangular transverse cross-section, for example a rectangular cross-section having opposing top and bottom sides that are greater in length than left and right sides.

Preferably, at least one internal surface of the cavity of the aerosol-generating device is a heating surface configured to heat the aerosol-generating article. The heating surface may comprise a heater, for example a resistance heater, or an infra-red heater, or a susceptor configured to be heated by engagement with an inductor. The heating surface may comprise an inductor, for example the surface may comprise a coil arranged to generate a fluctuating electromagnetic field within a space of the cavity of the aerosol-generating device. The heating surface may be a surface that is permeable to a fluctuating electromagnetic field, such that an inductor arranged outside the cavity can project a fluctuating electromagnetic field through the heating surface to engage with a susceptor arranged within the cavity of the aerosol-generating device.

Preferably, at least a lower surface of the cavity of the aerosol-generating device is a heating surface configured to heat an aerosol-generating article. Optionally, both the lower and an upper surface of the cavity of the aerosol-generating device are heating surfaces configured to heat an aerosol-generating article.

Preferably, at least a lower internal surface of the cavity of the aerosol-generating device is a substantially planar surface, preferably in which both lower and upper internal surfaces of the cavity of the aerosol-generating device are substantially planar. Preferably, upper and lower internal surfaces of the cavity of the aerosol-generating device are arranged in parallel relationship to one another.

Optionally, upper and lower internal surfaces may converge along a length of the cavity of the aerosol-generating device such that they are slightly closer spaced at a distal end of the cavity than at a proximal end of the cavity. This may allow the cavity of the aerosol-generating device to grip an aerosol-generating article inserted therein. Side internals surfaces may converge in a similar manner to achieve the result of gripping an aerosol-generating article. The upper and lower internal surfaces of the cavity of the aerosol-generating device, and/or opposing side surfaces of the cavity of the aerosol-generating device, may converge by between 1 degree and 10 degrees between the proximal end of the cavity and the distal end of the cavity, for example between 2 and 8 degrees, for example between 3 and 6 degree, for example between 4 and 5 degrees.

In some example, the lower internal surface and the upper internal surface may be movable relative to each other. For example, the lower internal surface and the upper internal surface may be configured to pivot relative to one another, or to move upward and downward relative to one another. This may allow an aerosol-generating article to be easily inserted into the cavity of the aerosol-generating device, while allowing the cavity walls of the aerosol-generating device to move to retain the substrate or article in position to be heated. For example, relative movement of upper and lower internal surfaces may result in an aerosol-generating article being gripped between the two surfaces to facilitate heating of the article and to help position the article appropriately within the device.

The cavity of the aerosol-generating device may be defined by a longitudinal dimension or length, a transverse dimension or width, and a depth dimension or height. The length and width are preferably greater in magnitude than the height, for example at least twice the magnitude of the height.

The aerosol-generating device may comprise a heating surface comprising a plurality of separately operable heating zones, for example two separately operable heating zones, or three separately operable heating zones, or four separately operable heating zones, or five separately operable heating zones, or six separately operable heating zones. The plurality of separably operable heating zones may be configured to be operated individually, or in any combination of two or more zones at once. In some examples, the plurality of separably operable heating zones may be longitudinally spaced within the cavity. In some example, the plurality of separably operable heating zones may be transversely spaced within the cavity. Different heating zones may be both transversely and longitudinally spaced from one another. Different heating zones may be arranged concentrically relative to one another.

The aerosol-generating device may comprise one or more resistance heaters, for example one or more resistance heaters integrated into walls of the cavity.

The device may comprises one or more inductors, for example one or more inductors integrated into walls of the cavity of the aerosol-generating device, or arranged to generate a fluctuating electromagnetic field in walls of the cavity of the aerosol-generating device, or within the cavity of the aerosol-generating device. One or more walls of the cavity of the aerosol-generating device comprise or consist of susceptor material, such that the one or more walls of the cavity heat up on engagement with a fluctuating electromagnetic field, thereby heating an aerosol-generating article inserted within the cavity.

The aerosol-generating device may comprise one or more insertable heating elements arranged to project into the cavity of the aerosol-generating device for insertion into an aerosol-generating article. The insertable heating elements may be resistance heaters. The insertable heating elements may be susceptors.

The aerosol-generating device may comprise a device body. The device body may comprise the heater. The aerosol-generating device may comprise a mouthpiece element. The device body may comprise a device body housing. The device body housing may define the cavity for receiving at least a portion of the aerosol-generating article. The device body and the mouthpiece element may be releasably connectable. The mouthpiece element may be releasably connectable with the device body, for example the device body housing.

The mouthpiece element may be releasably connectable with the device body, for example the device body housing, between a connected position and a disconnected position. In the connected position, the cavity of the aerosol-generating device may be at least partially covered, for example by the mouthpiece element. In the disconnected position, the cavity of the aerosol-generating device may be at least partially exposed, for example so as to allow insertion of the article into the cavity of the aerosol-generating device. The mouthpiece element may be moveable, for example pivotable about a hinge, relative to the device body, for example between a first position and a second position. In the first position, the cavity of the aerosol-generating device may be at least partially covered, for example by the mouthpiece element. In the second position, the cavity may be at least partially exposed, for example so as to allow insertion of the article into the cavity of the aerosol-generating device. Advantageously, covering the cavity of the aerosol-generating device, or the article in the cavity of the aerosol-generating device, may ensure most aerosol from the article travels along the desired flow path to the user, rather than escaping to the external environment.

The aerosol-generating device, for example the device body, may comprise a power source such as a battery. In use, the power source may provide power to the heater. The device, for example the device body, may comprise a controller. The controller may be configured to control power from the power supply to the heater.

The device body may comprise a distal end and a proximal end. The cavity of the aerosol-generating device may be defined at the proximal end of the device body. The mouthpiece element may comprise a distal end and a proximal end. The distal end of the mouthpiece element may be configured to releasably connect to the proximal end of the device body.

The mouthpiece element, or at least a portion of the mouthpiece element, may be configured to be inserted into a mouth of a user. The proximal end of the mouthpiece element may be configured to be inserted into a mouth of a user.

The aerosol-generating device, for example one or both of the device body and the mouthpiece element, may comprise an air inlet. The device, for example the mouthpiece element, may comprise an air outlet. The device may comprise an air flow path fluidly connecting the air inlet to the air outlet. The air flow path may extend one or both of through and past the cavity of the aerosol-generating device. As such, in use, the device may be configured such that, when a negative pressure is applied to the air outlet, for example by a user drawing on the air outlet, air is drawn in through the air inlet, then past or through an aerosol-generating article received in the cavity, thereby entraining aerosol released from the aerosol-forming substrate of the article, then out through the air outlet.

According to the present disclosure, an aerosol-generating system comprises an aerosol-generating device as disclosed herein and an aerosol-generating article as disclosed herein. The system may comprise a plurality of such articles for use with the aerosol-generating device.

As used herein, the term “aerosol-generating article” refers to an article comprising an aerosol-generating substrate. The article may be heated in use to produce and deliver an inhalable aerosol to a consumer.

As used herein, the term “aerosol-generating substrate” refers to a substrate capable of releasing volatile compounds upon heating, for example compounds which, in use, cool and condense to generate an aerosol.

As used herein, the term “aerosol-generating device” refers to a device that, in use, interacts with, for example heats, an aerosol-generating substrate of an aerosol-generating article to generate an aerosol.

As used herein, the term “planar” refers to a feature generally formed in a single Euclidean plane and not wrapped around or otherwise conformed to fit a curved or other non-planar shape. A planar surface may extend in two dimensions in a single Euclidean plane. A planar object may extend in two dimensions in a single Euclidean plane substantially more than in a third dimension perpendicular to the plane. More specifically, a planar object may extend in a first dimension and a second dimension perpendicular to the first dimension at least two, five or ten times further than the object extends in a third dimension perpendicular to the first and second dimensions.

As used herein, the term “transverse” refers to a direction extending between the first planar external surface and the second planar external surface.

As used herein, the term “longitudinal” refers to a direction that is perpendicular to the transverse direction. For example, a direction between the front wall and the back wall of the aerosol-generating article.

As used herein, the term “lateral” refers to a direction that is perpendicular to the transverse direction and the longitudinal direction. For example, a direction from a first side wall to a second side wall of the aerosol-generating article.

As used herein, the term “thickness” refers to a maximum dimension of the aerosol-generating article or a component of the aerosol-generating article in the transverse direction.

As used herein, the term “length” refers to a maximum dimension of the aerosol-generating article or a component of the aerosol-generating article in the longitudinal direction.

As used herein, the term “width” refers to a maximum dimension of the aerosol-generating article or a component of the aerosol-generating article in the lateral direction.

As used herein, the terms “upstream” and “downstream” refer to the relative positions of components, or portions of components, of the aerosol-generating article in relation to the direction in which the air or aerosol is transported through the aerosol-generating article during use.

As used herein, the term “bulk density” may refer to the total weight of the aerosol-generating substrate divided by the bulk volume of the aerosol-generating substrate.

As used herein, the term “aerosol former” may refer to any suitable known compound or mixture of compounds that, in use, facilitates formation of an aerosol. The aerosol may be a dense and stable aerosol. The aerosol may be substantially resistant to thermal degradation at the operating temperature of the aerosol-generating substrate or aerosol-generating article.

As used herein, the term “aerosol former content” may refer to aerosol former content in percent on a dry weight basis, unless otherwise specified.

As used herein, a “susceptor” refers to a conductive element that heats up when subjected to a changing magnetic field. This may be the result of eddy currents induced in the susceptor element and/or hysteresis losses.

As used herein, the term “hydrophobic” refers to a surface exhibiting water repelling properties. One useful way to determine this is to measure the water contact angle. The “water contact angle” is the angle, conventionally measured through the liquid, where a liquid/vapour interface meets a solid surface. It quantifies the wettability of a solid surface by a liquid via the Young equation.

As used herein, the term “equivalent diameter” of an opening or an aperture is used herein to denote the diameter of a circular opening or aperture having the same cross-sectional area as the opening or aperture.

As used herein, the term “packing density” refers to a ratio of the total volume of the components, such as solid and liquid components, of an aerosol-generating substrate positioned within the cavity, the first cavity or the second cavity to the volume of the cavity that the aerosol-generating substrate is positioned within.

The invention is defined in the claims. However, below there is provided a non-exhaustive list of non-limiting examples. Any one or more of the features of these examples may be combined with any one or more features of another example, embodiment, or aspect described herein.
Ex1. An aerosol-generating article for use with an aerosol-generating device to generate an aerosol, the aerosol-generating article comprising:
a first planar external surface;
a second planar external surface;
a cavity;
a frame positioned between the first planar external surface and the second planar external surface, the frame at least partially defining the cavity; and
one or more aerosol-generating substrates,
wherein at least one of the one or more aerosol-generating substrates has a mass of less than or equal to 500 milligrams.
Ex2. An aerosol-generating article according to Ex1, wherein the at least one of the one or more aerosol-generating substrates has a mass of less than or equal to 400 milligrams.
Ex3. An aerosol-generating article according to Ex1 or Ex2, wherein the at least one of the one or more aerosol-generating substrates has a mass of between 50 milligrams and 500 milligrams.
Ex4. An aerosol-generating article according to Ex3, wherein the at least one of the one or more aerosol-generating substrate has a mass of between 80 milligrams and 250 milligrams.
Ex5. An aerosol-generating article according to any one of Ex1 to Ex4, wherein the at least one of the aerosol-generating substrates comprise an aerosol-generating substrate positioned within the cavity.
Ex6. An aerosol-generating article according to Ex5, wherein the aerosol-generating substrate positioned within the cavity comprises tobacco cut filler.
Ex7. An aerosol-generating article according to Ex5 or Ex6, wherein the aerosol-generating substrate positioned within the cavity has a mass of between 80 milligrams and 250 milligrams.
Ex8. An aerosol-generating article according to Ex7, wherein the aerosol-generating substrate positioned within the cavity has a mass of between 80 milligrams and 200 milligrams.
Ex9. An aerosol-generating article according to any one of Ex1 to Ex8 wherein the one or more aerosol-generating substrates comprise a first aerosol-generating substrate layer positioned between the first planar external surface and the frame, and a second aerosol-generating substrate layer positioned between the second external surface and the frame.
Ex10. An aerosol-generating article according to Ex9, wherein the first aerosol-generating substrate layer is a sheet of aerosol-generating material and the second aerosol-generating substrate layer is a sheet of aerosol-generating material.
Ex11. An aerosol-generating article according to Ex9 or Ex10, wherein the first aerosol-generating substrate layer has a mass between 80 milligrams and 250 milligrams and the second aerosol-generating substrate layer has a mass between 80 milligrams and 250 milligrams.
Ex12. An aerosol-generating article according to Ex11, wherein the first aerosol-generating substrate layer has a mass between 80 milligrams and 150 milligrams and the second aerosol-generating substrate layer has a mass between 80 milligrams and 150 milligrams.
Ex13. An aerosol-generating article according to any one of Ex1 to Ex12 comprising a first planar external layer and a second planar external layer, wherein the first planar external layer defines the first planar external surface and the second planar external layer defines the second planar external surface.
Ex14. An aerosol-generating article according to any one of Ex1 to Ex13, wherein a thickness of the aerosol-generating article is less than 50 percent of both a length and a width of the aerosol-generating article.
Ex15. An aerosol-generating article according to any one of Ex1 to Ex14, wherein the frame the frame is made from paper, paperboard, or cardboard.
Ex16. An aerosol-generating article according to any one of Ex1 to Ex15, comprising an air inlet and an air outlet, and an airflow passage extending between the air inlet and the air outlet through the cavity.
Ex17. An aerosol-generating article according to any one of Ex1 to Ex16, wherein the frame comprises a peripheral wall circumscribing or encircling the cavity.
Ex18. An aerosol-generating article according to Ex17, wherein the peripheral wall is formed by a frame inner surface and a frame outer surface, and wherein the frame inner surface defines a cavity outer wall and the frame outer surface at least partially defines one or more external walls of the aerosol-generating article.
Ex19. An aerosol-generating article according to Ex17 or Ex18, wherein the peripheral wall has a radial thickness between 1 millimetre and 3 millimetres.
Ex20. An aerosol-generating article according to any one of Ex1 to Ex19, wherein the frame has a thickness greater than or equal to 80 percent of the thickness of the aerosol-generating article.
Ex21. An aerosol-generating article according to any one of Ex1 to Ex20, wherein the frame has a thickness between 80 percent and 95 percent of the thickness of the aerosol-generating article.
Ex22. An aerosol-generating article according to any one of Ex1 to Ex21, wherein the frame has a thickness between 1 millimetre and 5.5 millimetres.
Ex23. An aerosol-generating article according to any one of Ex1 to Ex22, wherein the frame is a unitary component.
Ex24. An aerosol-generating article according to any one of Ex1 to Ex23, wherein the frame comprises a first frame layer and a second frame layer.
Ex25. An aerosol-generating article according to Ex24, wherein the first frame layer is bonded to the second frame layer with an adhesive.
Ex26. An aerosol-generating article according to Ex24 or Ex25, wherein the frame comprises a third frame layer.
Ex27. An aerosol-generating article according to Ex26, wherein the second frame layer is positioned between the first frame layer and the third frame layer.
Ex28. An aerosol-generating article according to Ex26 or Ex27, wherein the second frame layer is bonded to the third frame layer with an adhesive.
Ex29. An aerosol-generating article according to Ex10, wherein the sheet of aerosol-generating material is a sheet of homogenised tobacco material.
Ex30. An aerosol-generating article according to Ex29, wherein the sheet of aerosol-generating material comprises one or more aerosol-formers, such as one or both of glycerine and propylene glycol.
Ex31. An aerosol-generating article according to any one of Ex9, Ex10, Ex29 or Ex30, wherein the first aerosol-generating substrate layer and the second aerosol-generating substrate layer define opposing end walls of the cavity.
Ex32. An aerosol-generating article according to any one of Ex9, Ex10, Ex29 to Ex31, wherein one or both the first aerosol-generating substrate layer and the second aerosol-generating substrate layer has a thickness between 100 micrometres and 600 micrometres.
Ex33. An aerosol-generating article according to any one of Ex9, Ex10, Ex29 to Ex32, wherein one or both the first aerosol-generating substrate layer and the second aerosol-generating substrate layer has a length substantially the same as the length of the aerosol-generating article.
Ex34. An aerosol-generating article according to any one of Ex9, Ex10, Ex29 to Ex33, wherein one or both the first aerosol-generating substrate layer and the second aerosol-generating substrate layer has a width substantially the same as the width of the aerosol-generating article.
Ex35. An aerosol-generating article according to any one of Ex1 to Ex34 comprising an outer wrapper defining the first planar external surface and the second planar external surface.
Ex36. An aerosol-generating article according to any one of Ex1 to Ex34 comprising a first planar external layer and a second planar external layer, wherein the first planar external layer defines the first planar external surface and the second planar external layer defines the second planar external surface.
Ex37. An aerosol-generating article according to Ex36, wherein the first planar external layer and the second planar external layer overlie opposing ends of the cavity.
Ex38. An aerosol-generating article according to Ex36 or Ex37, wherein one or both of the first planar external layer and the second planar external layer comprise a cellulosic material.
Ex39. An aerosol-generating article according to Ex38, wherein the cellulosic material is paper or cardboard.
Ex40. An aerosol-generating article according to any one of Ex36 to Ex39, wherein one or both of the first planar external layer and the second planar external layer has a length substantially the same as the length of the aerosol-generating article.
Ex41. An aerosol-generating article according to any one of Ex36 to Ex40, wherein one or both of the first planar external layer and the second planar external layer has a width substantially the same as the width of the aerosol-generating article.
Ex42. An aerosol-generating article according to any one of Ex1 to Ex41, wherein the cavity has a length between 30 percent and 95 percent of the length of the aerosol-generating article.
Ex43. An aerosol-generating article according to any one of Ex1 to Ex42, wherein the cavity has a width between 30 percent and 95 percent of the width of the aerosol-generating article.
Ex44. An aerosol-generating article according to any one of Ex1 to Ex43, wherein the cavity has a thickness between 30 percent and 95 percent of the thickness of the aerosol-generating article.
Ex45. An aerosol-generating article according to any one of Ex1 to Ex44, wherein the cavity has a length between 14 millimetres and 40 millimetres, a width between 4.5 millimetres and 13 millimetres, and a thickness between 0.5 millimetres and 4.5 millimetres.
Ex46. An aerosol-generating article according to any one of Ex1 to Ex45, wherein the cavity has a length between 20 millimetres and 30 millimetres, a width between 7 millimetres and 10 millimetres, and a thickness between 2.5 millimetres and 4 millimetres.
Ex47. An aerosol-generating article according to any one of Ex1 to Ex46, wherein the aerosol-generating substrate positioned within the cavity comprises an aerosol-generating material.
Ex48. An aerosol-generating article according to Ex47, wherein the aerosol-generating material is in the form of shredded aerosol-generating material.
Ex49. An aerosol-generating article according to Ex48, wherein the shredded aerosol-generating material comprises one or more of: strips and strands of aerosol-generating material, such as strips and strands of tobacco or homogenised tobacco material.
Ex50. An aerosol-generating article according to Ex47, wherein the aerosol-generating material is in the form of a corrugated sheet of aerosol-generating material.
Ex51. An aerosol-generating article according to Ex50, wherein the corrugated sheet of aerosol-generating material comprises a plurality of parallel corrugations defining a plurality of channels between the sheet of aerosol-generating material and one or more walls of the cavity.
Ex52. An aerosol-generating article according to Ex51, wherein the plurality of channels are plurality of longitudinally extending channels.
Ex53. An aerosol-generating article according to any one of Ex51 or Ex52, wherein the plurality of channels define at least a portion of the airflow passage extending between the air inlet and air outlet of the aerosol-generating article.
Ex54. An aerosol-generating article according to any one of Ex47 to Ex53, wherein the aerosol-generating material comprises one or more aerosol-formers, such as one or both of glycerine and propylene glycol.
Ex55. An aerosol-generating article according to any one of Ex47 to Ex54, wherein the aerosol-generating substrate positioned within the cavity has a bulk density of less than or equal to 0.5 milligrams per cubic millimetre.
Ex56. An aerosol-generating article according any one of Ex47 to Ex54, wherein the aerosol-generating substrate positioned within the cavity has a packing density greater than or equal to 0.3.
Ex55. An aerosol-generating article according to any one of Ex47 to Ex55, wherein the aerosol-generating substrate positioned within the cavity has a packing density less than or equal to 0.9.
Ex56. An aerosol-generating article according to any one of Ex47 to Ex55, wherein the aerosol-generating substrate positioned within the cavity has a density less than or equal to 0.9 grams per cubic centimetre.
Ex57. An aerosol-generating article according to any one of Ex47 to Ex56, wherein the aerosol-generating substrate positioned within the cavity has a mass between 50 milligrams and 500 milligrams.
Ex58 an Aerosol-generating Article According to Any One of Ex1 to Ex57, Wherein the Air inlet is defined by the frame.
Ex59. An aerosol-generating article according to any one of Ex1 to Ex58, wherein the air inlet has an equivalent diameter between 0.1 millimetres and 3 millimetres.
Ex60. An aerosol-generating article according to any one of Ex1 to Ex59, wherein the air inlet has a width of between 0.3 millimetres and 3 millimetres.
Ex61. An aerosol-generating article according to any one of Ex1 to Ex60, wherein the air inlet has a thickness of between 0.3 millimetres and 3 millimetres.
Ex62. An aerosol-generating article according to any one of Ex1 to Ex61, wherein the air outlet is defined by the frame.
Ex63. An aerosol-generating article according to any one of Ex1 to Ex62, wherein the air outlet has an equivalent diameter between 0.1 millimetres and 3 millimetres.
Ex64. An aerosol-generating article according to any one of Ex1 to Ex63, wherein the air outlet has a width of between 0.3 millimetres and 3 millimetres.
Ex65. An aerosol-generating article according to any one of Ex1 to Ex64, wherein the air outlet has a thickness of between 0.3 millimetres and 3 millimetres.
Ex66. An aerosol-generating article according to any one of Ex1 to Ex65, wherein a ratio between the length and the thickness of the aerosol-generating article, and between the width and the thickness of the aerosol-generating article is between 2:1 and 15:1.
Ex67. An aerosol-generating article according to any one of Ex1 to Ex66, wherein a ratio between the length and the width of the aerosol-generating article is between 1:1 and 10:1.
Ex68 An aerosol-generating article according to any one of Ex1 to Ex67, wherein the aerosol-generating article has a length between 15 millimetres and 45 millimetres, for example between 25 millimetres and 30 millimetres.
Ex69. An aerosol-generating article according to any one of Ex1 to Ex68, wherein the aerosol-generating article has a width between 3 millimetres and 17 millimetres, for example between 9 millimetres and 11 millimetres.
Ex70. An aerosol-generating article according to any one of Ex1 to Ex69, wherein the aerosol-generating article has a thickness between 1 millimetres and 5.5 millimetres, for example between 3 millimetres and 3.5 millimetres.
Ex71. An aerosol-generating article according to any one of Ex1 to Ex70, wherein the aerosol-generating article has resistance to draw between 0 millimetres H₂O and 9.9 millimetres H₂O.

Examples will now be further described with reference to the figures in which:

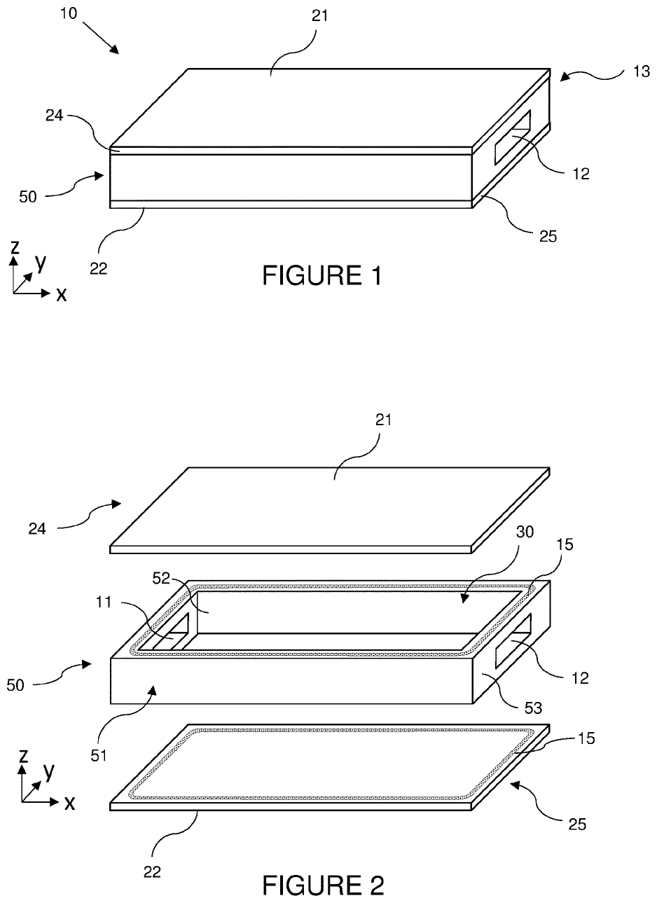

FIG. 1 shows a perspective view of an aerosol-generating article according to the present disclosure;

FIG. 2 shows an exploded perspective view of the aerosol-generating article of FIG. 1;

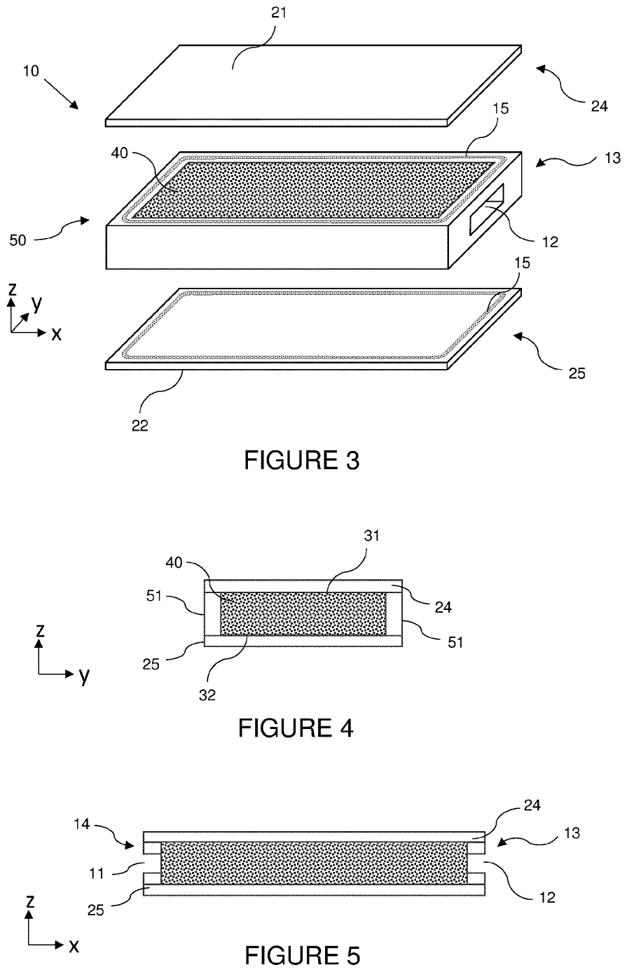

FIG. 3 shows an exploded perspective view of an aerosol-generating article according to the present disclosure;

FIG. 4 shows a transverse cross-sectional view of the aerosol-generating article of FIG. 3;

FIG. 5 shows a longitudinal cross-sectional view of the aerosol-generating article of FIG. 3;

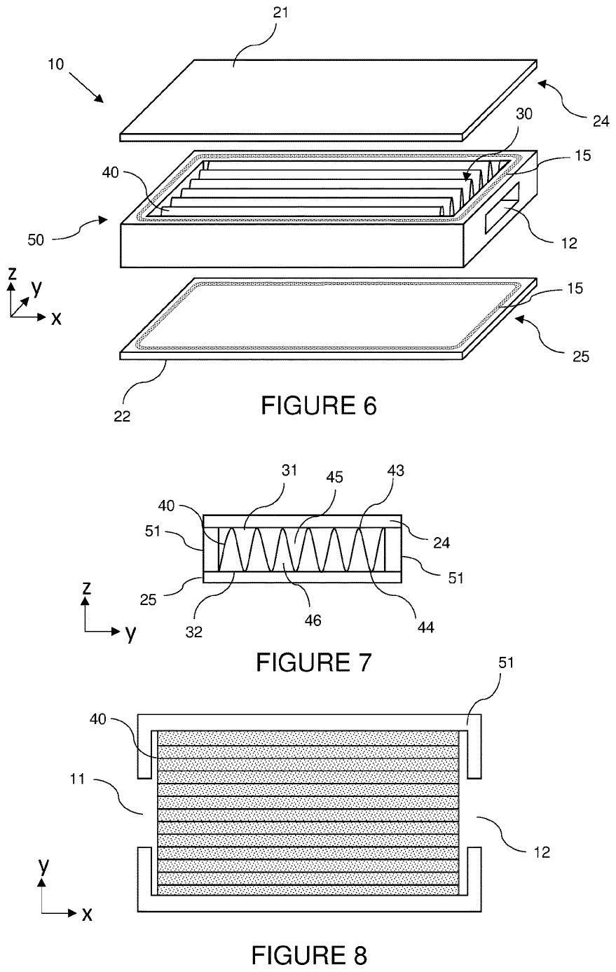

FIG. 6 shows an exploded perspective view of an aerosol-generating article according to the present disclosure;

FIG. 7 shows a transverse cross-sectional view of the aerosol-generating article of FIG. 6;

FIG. 8 shows a lateral cross-sectional view of the aerosol-generating article of FIG. 6;

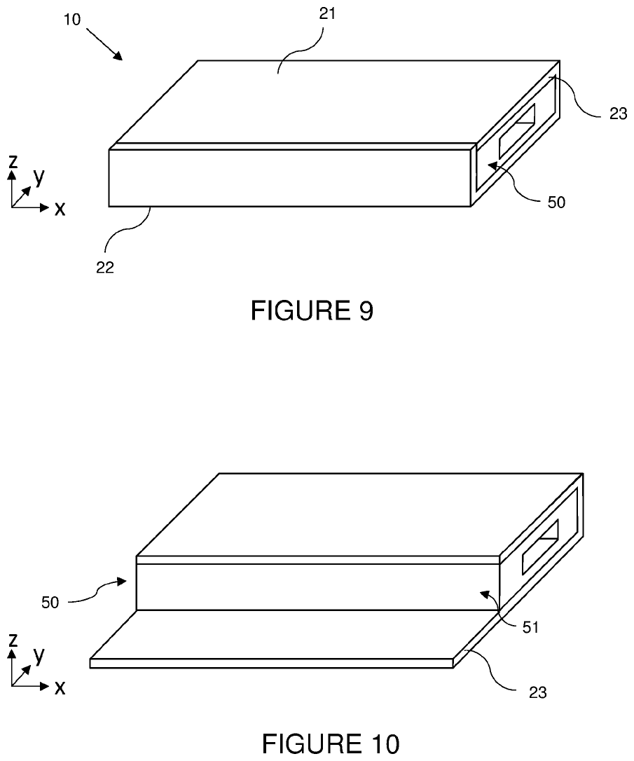

FIG. 9 shows a perspective view of an aerosol-generating article according to the present disclosure;

FIG. 10 shows a perspective view of the aerosol-generating article of FIG. 9;

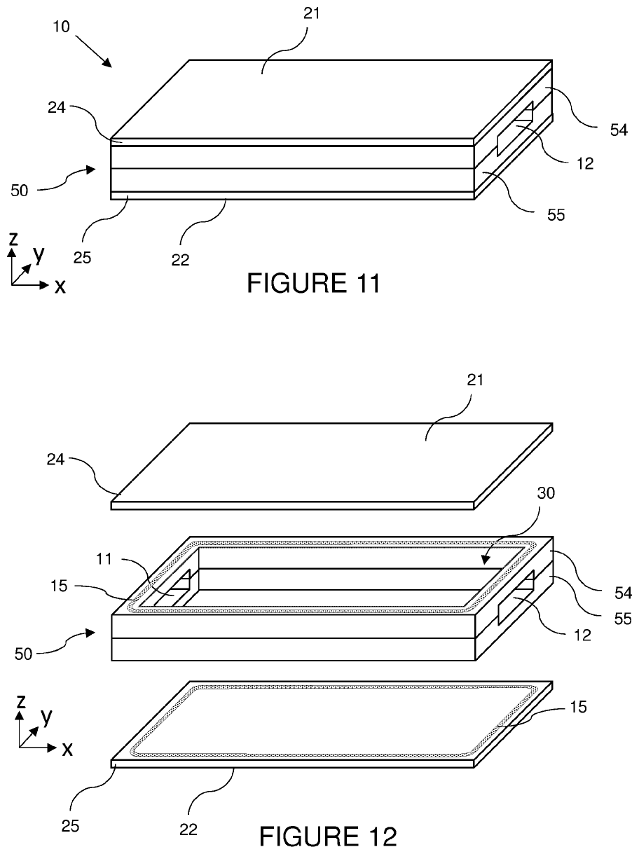

FIG. 11 shows a perspective view of an aerosol-generating article according to the present disclosure;

FIG. 12 shows an exploded perspective view of the aerosol-generating article of FIG. 11;

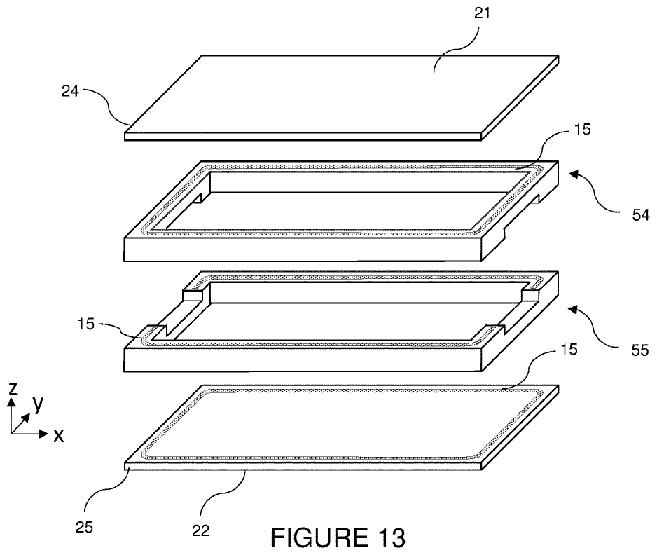

FIG. 13 shows an exploded perspective view of the aerosol-generating article of FIG. 11;

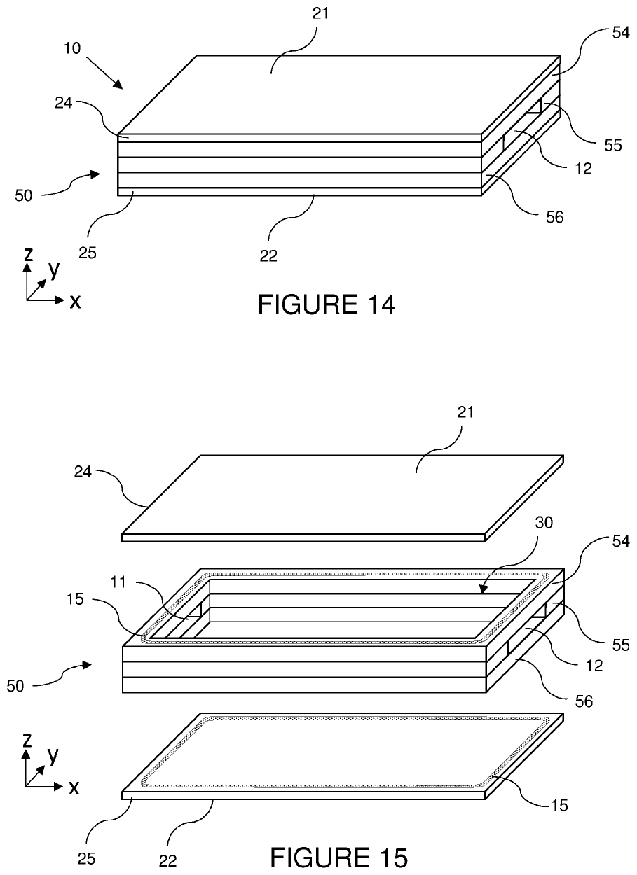

FIG. 14 show a perspective view of an aerosol-generating article according to the present disclosure;

FIG. 15 shows an exploded perspective view of the aerosol-generating article of FIG. 14;

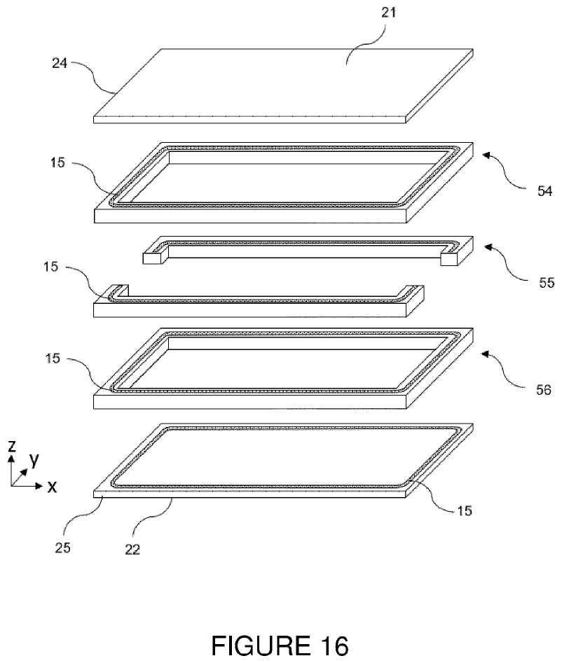

FIG. 16 shows an exploded perspective view of the aerosol-generating article of FIG. 14;

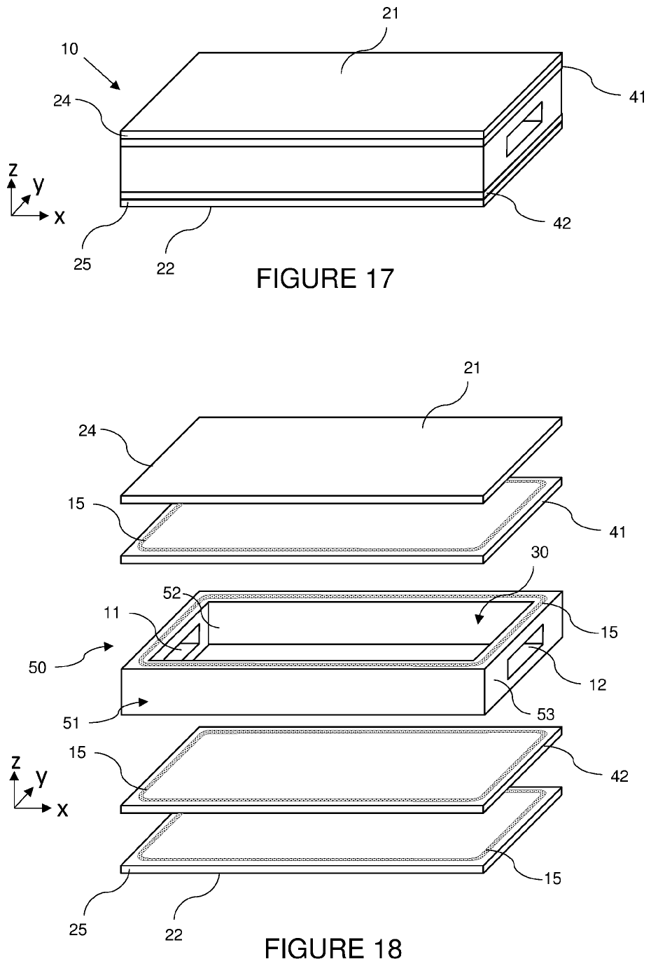

FIG. 17 shows a perspective view of an aerosol-generating article according to the present disclosure;

FIG. 18 shows an exploded perspective view of the aerosol-generating article of FIG. 17;

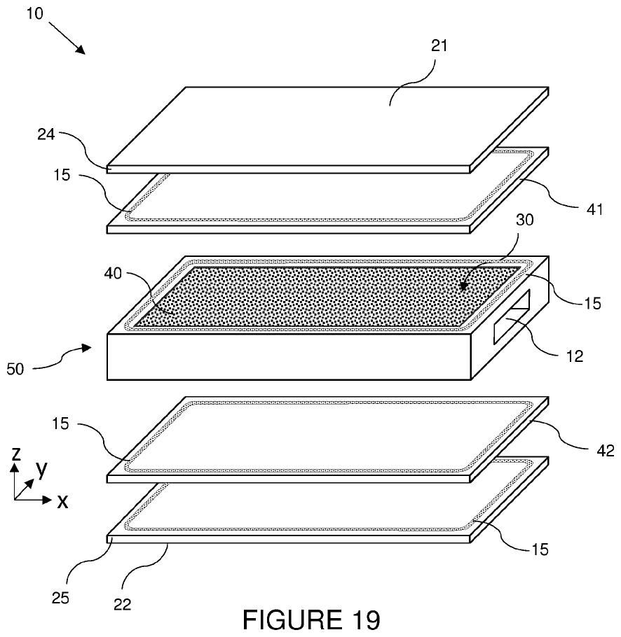

FIG. 19 shows an exploded perspective view of an aerosol-generating article according to the present disclosure;

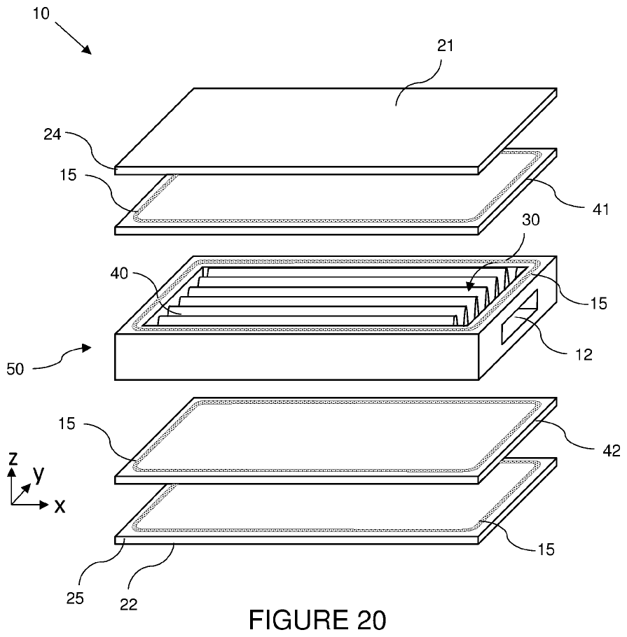

FIG. 20 shows an exploded perspective view of an aerosol-generating article according to the present disclosure;

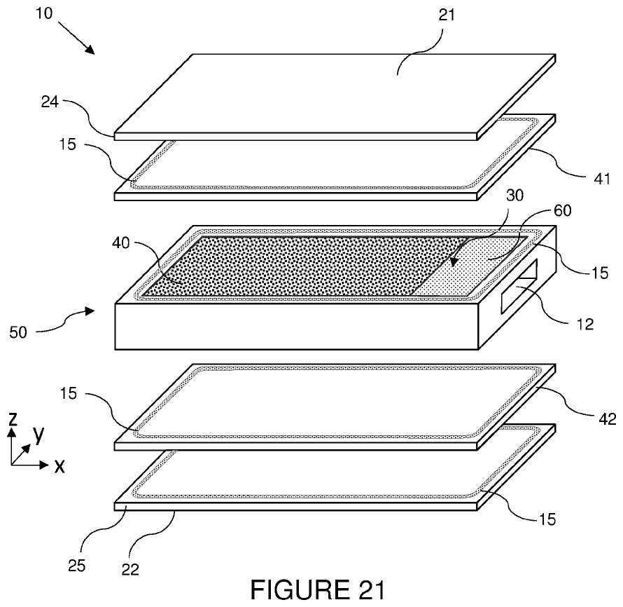

FIG. 21 shows an exploded perspective view of an aerosol-generating article according to the present disclosure;

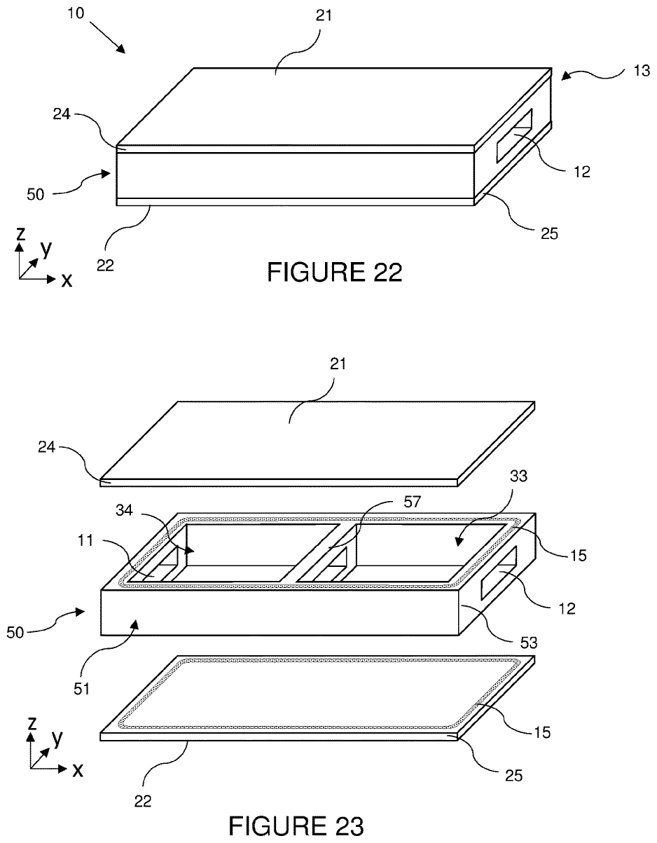

FIG. 22 shows a perspective view of an aerosol-generating article according to the present disclosure;

FIG. 23 shows an exploded perspective view of the aerosol-generating article of FIG. 22;

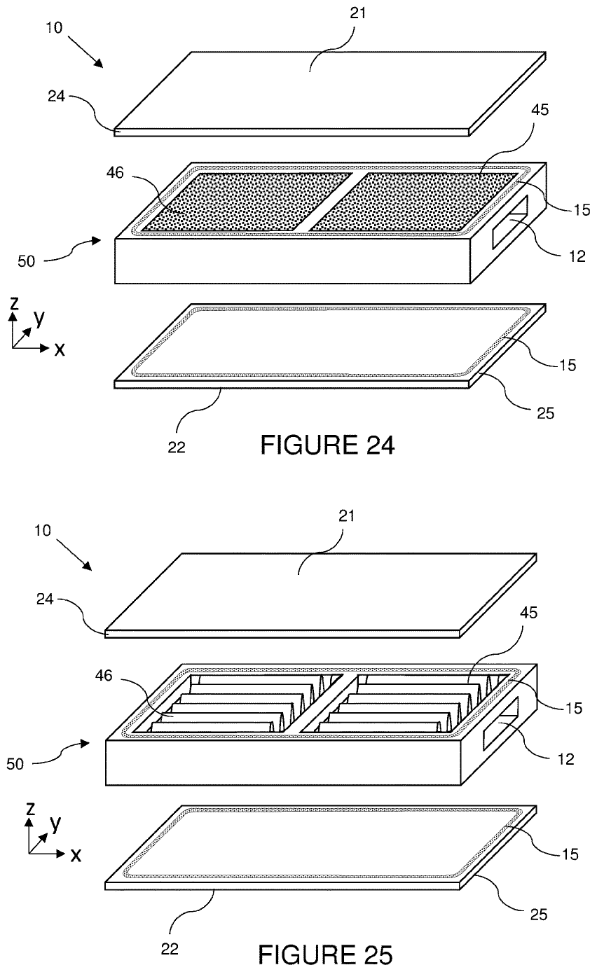

FIG. 24 shows an exploded perspective view of an aerosol-generating article according to the present disclosure;

FIG. 25 shows an exploded perspective view of an aerosol-generating article according to the present disclosure;

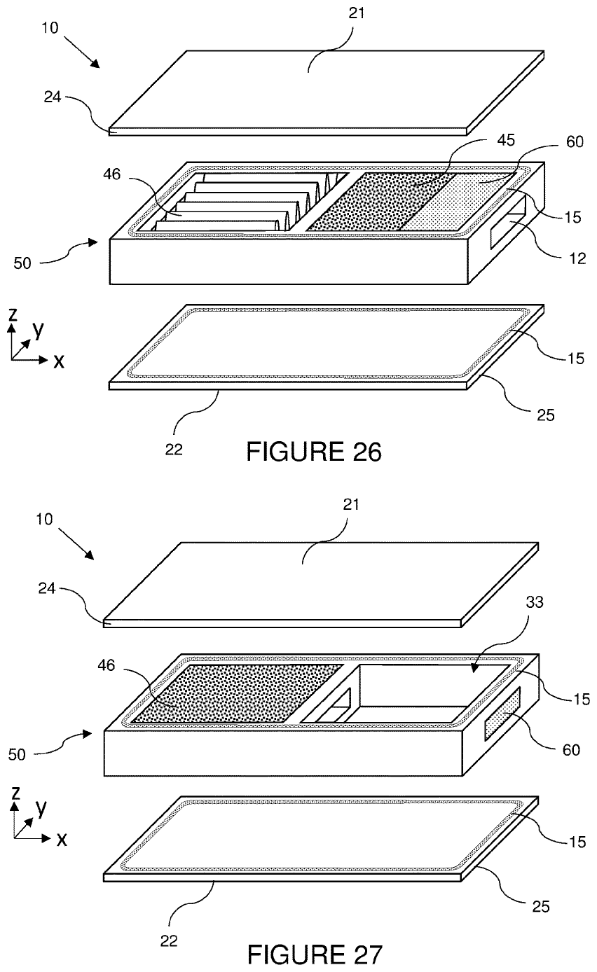

FIG. 26 shows an exploded perspective view of an aerosol-generating article according to the present disclosure;

FIG. 27 shows an exploded perspective view of an aerosol-generating article according to the present disclosure;

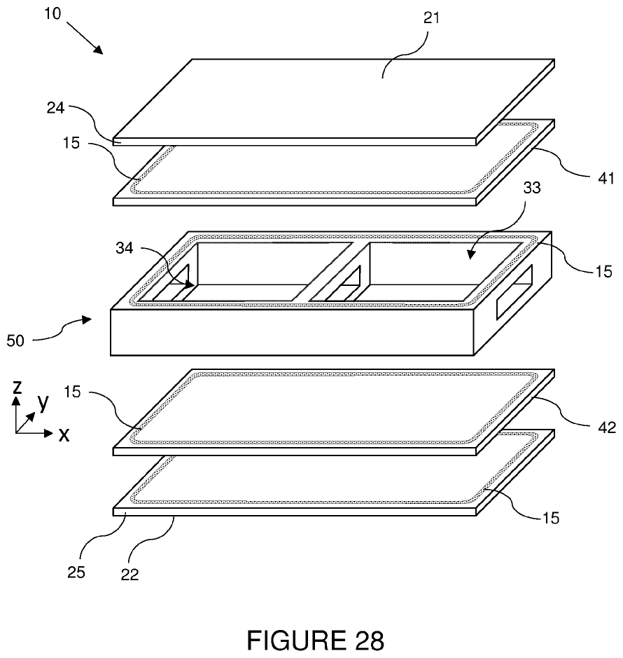

FIG. 28 shows an exploded perspective view of an aerosol-generating article according to the present disclosure;

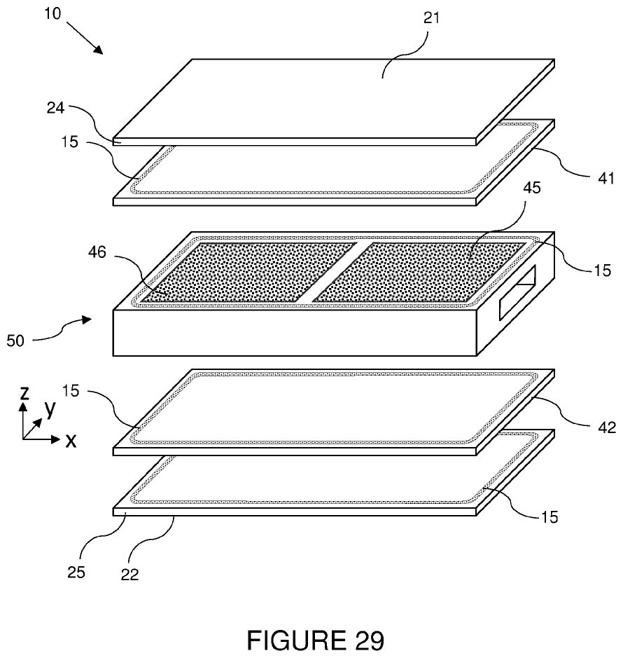

FIG. 29 shows an exploded perspective view of an aerosol-generating article according to the present disclosure;

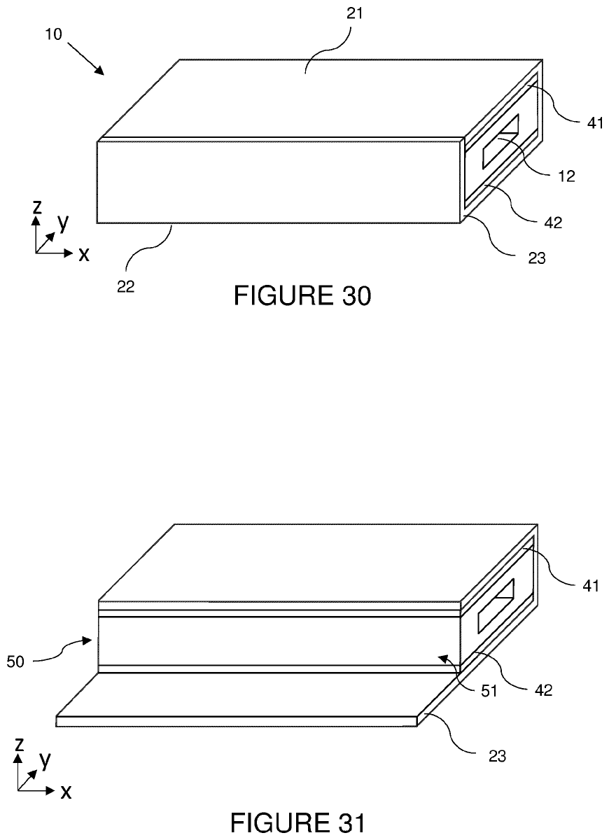

FIG. 30 shows a perspective view of an aerosol-generating article according to the present disclosure;

FIG. 31 shows a perspective view of the aerosol-generating article of FIG. 30;

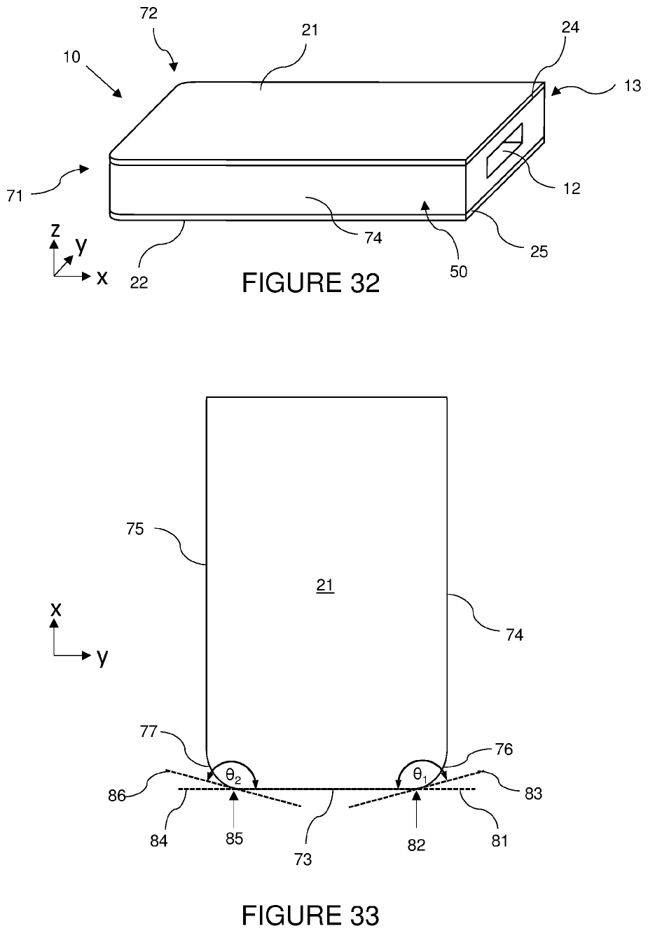

FIG. 32 shows a perspective view of an aerosol-generating article according to the present disclosure;

FIG. 33 shows a plan view of the aerosol-generating article of FIG. 32;

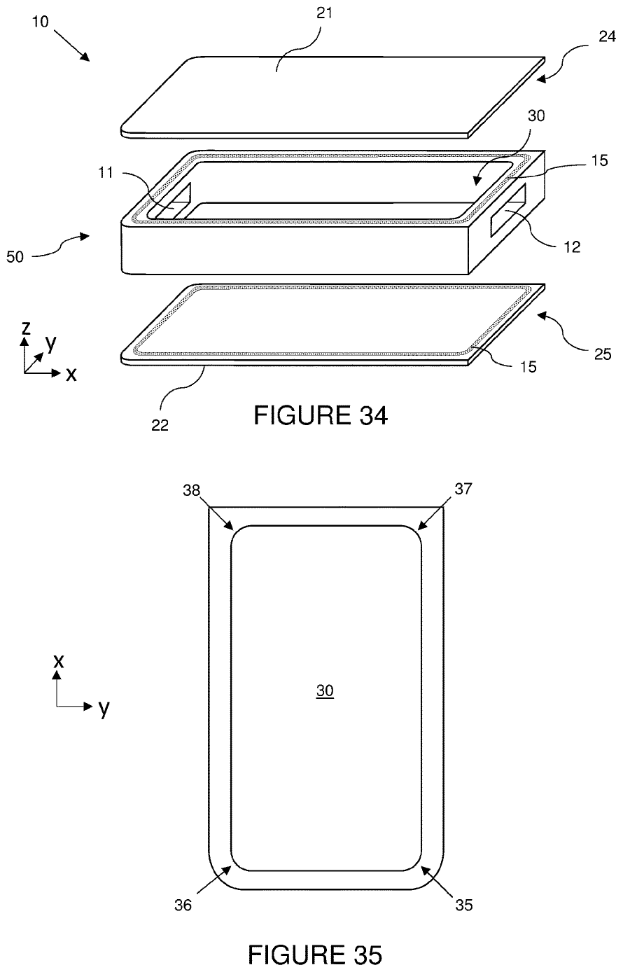

FIG. 34 shows an exploded perspective view of the aerosol-generating article of FIG. 32;

FIG. 35 shows a cross-sectional view of the aerosol-generating article of FIG. 32;

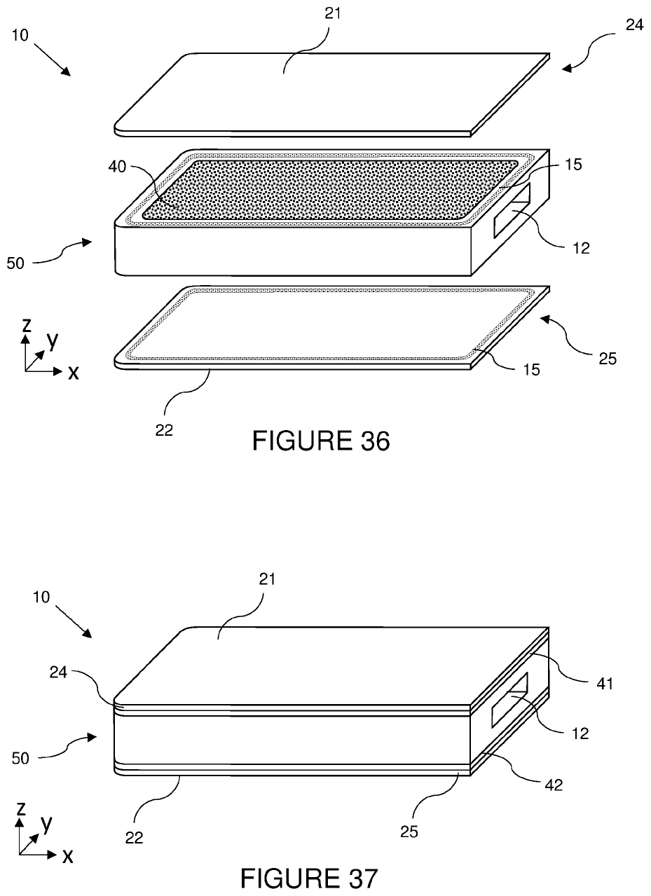

FIG. 36 shows an exploded perspective view of an aerosol-generating article according to the present disclosure;

FIG. 37 shows a perspective view of an aerosol-generating article according to the present disclosure;

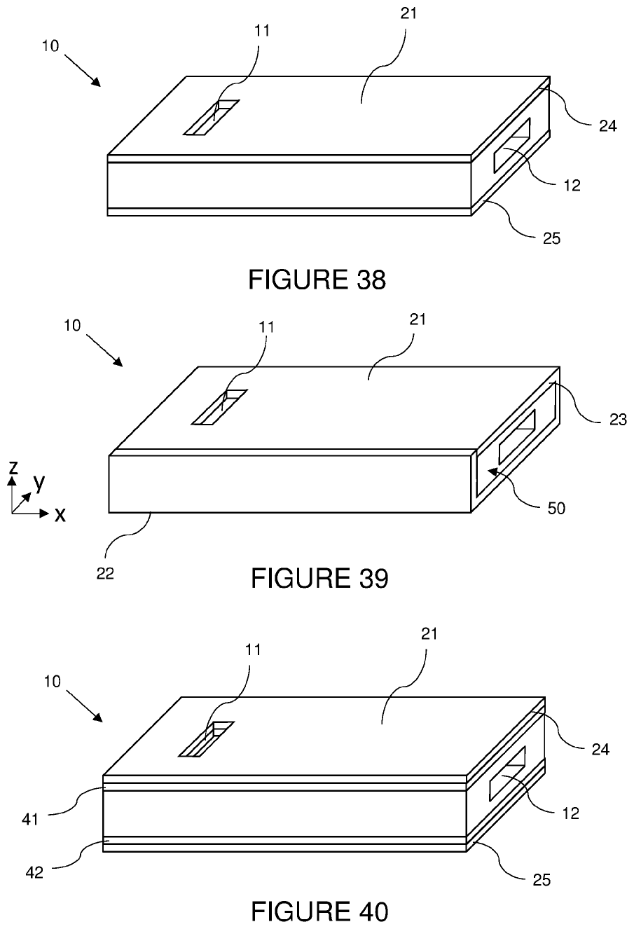

FIG. 38 shows a perspective view of an aerosol-generating article according to the present disclosure;

FIG. 39 shows a perspective view of an aerosol-generating article according to the present disclosure;

FIG. 40 shows a perspective view of an aerosol-generating article according to the present disclosure;

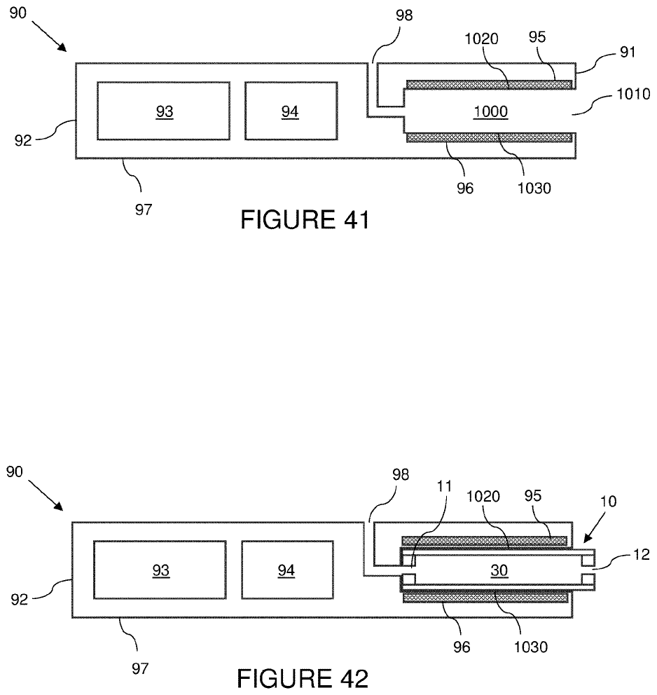

FIG. 41 shows a schematic cross-sectional view of an aerosol-generating device according to the present disclosure;

FIG. 42 shows a schematic cross-sectional view of the aerosol-generating device of FIG. 41 in engagement with an aerosol-generating article of the present disclosure;

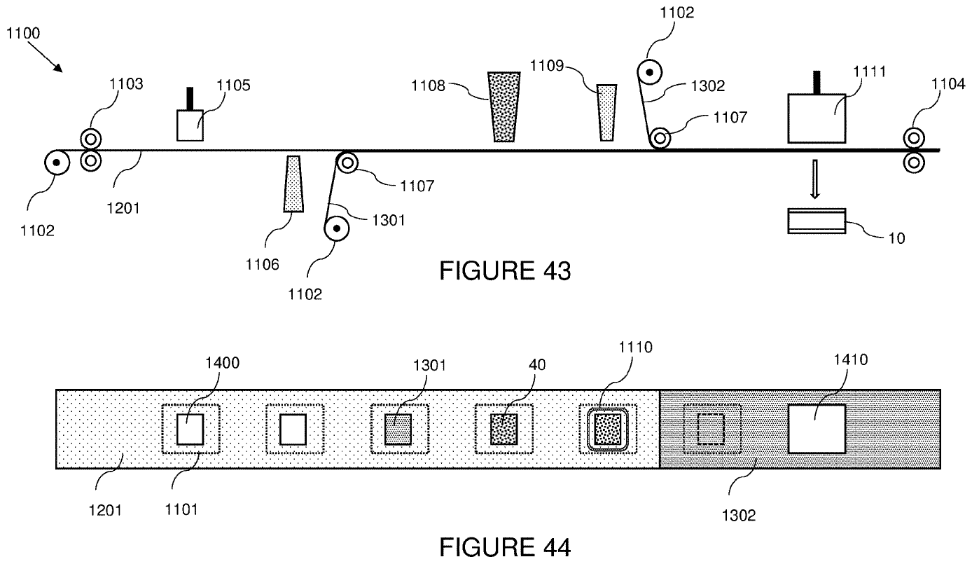

FIG. 43 shows a method of manufacturing an aerosol-generating article according to the present disclosure;

FIG. 44 shows a plan view of the method of manufacturing of FIG. 43;

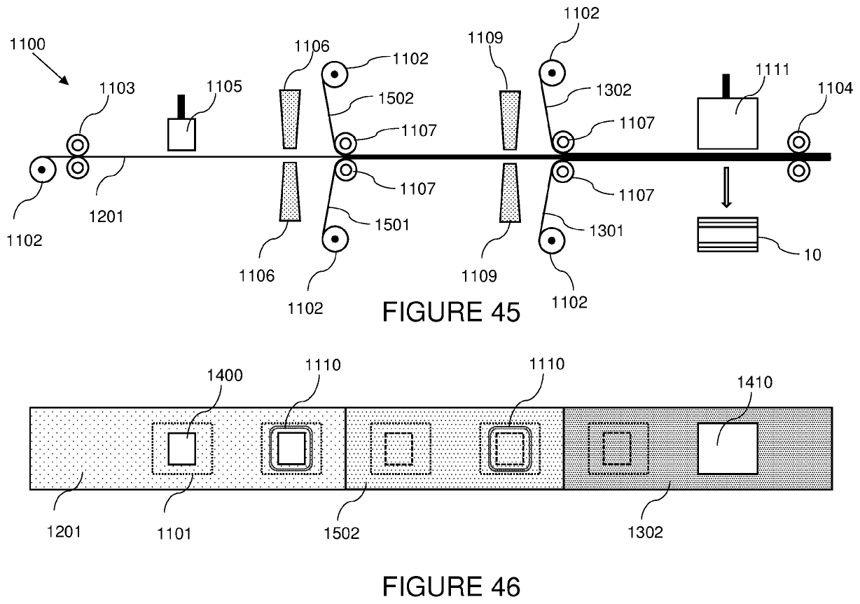

FIG. 45 shows a method of manufacturing an aerosol-generating article according to the present disclosure;

FIG. 46 shows a plan view of the method of manufacturing of FIG. 45;

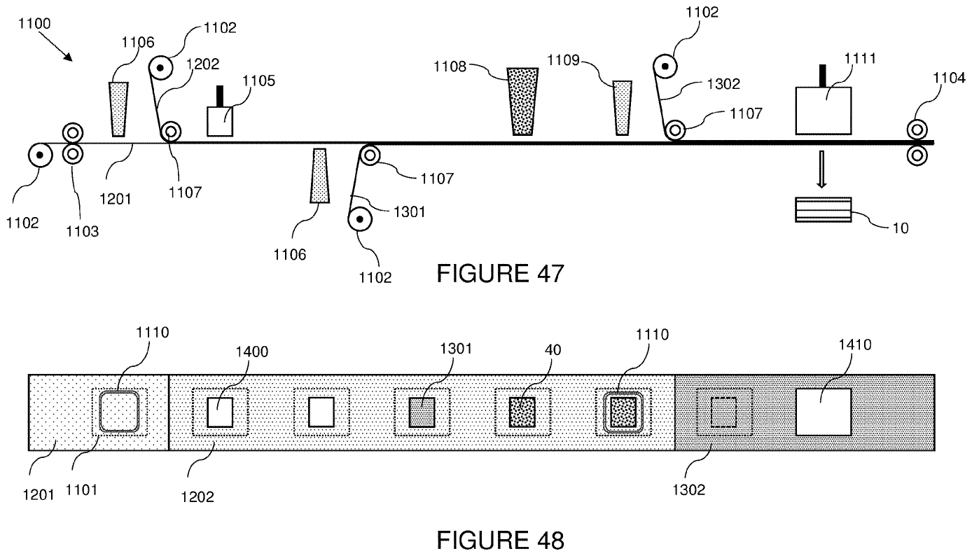

FIG. 47 shows a method of manufacturing an aerosol-generating article according to the present disclosure;

FIG. 48 shows a plan view of the method of manufacturing of FIG. 47;

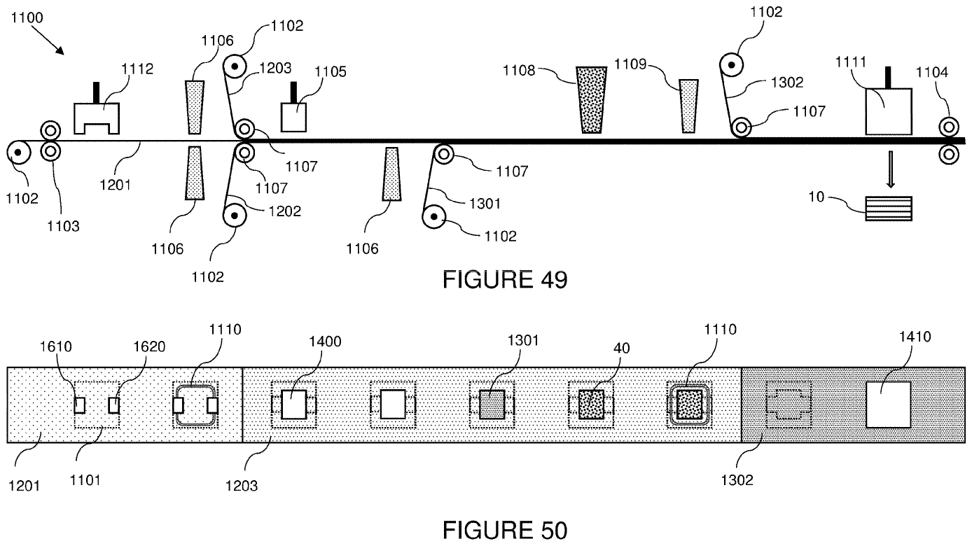

FIG. 49 shows a method of manufacturing an aerosol-generating article according to the present disclosure; and

FIG. 50 shows a plan view of the method of manufacturing of FIG. 49.

FIG. 1 shows an aerosol-generating article 10 comprising a first planar external layer 24 forming a first planar external surface 21, a second planar external layer 25 forming a second planar external surface 22, and a frame 50 positioned between the first planar external layer 24 and the second planar external layer 25. The first planar external layer 24 and the second planar external layer 25 both comprise an aerosol-generating substrate comprising an aerosol-generating material, namely tobacco. However, it will be understood that in some embodiments only one of the first planar external layer 24 and the second planar external layer 25 may comprise an aerosol-generating substrate. Alternatively, or additionally, the aerosol-generating substrate may be positioned elsewhere within the aerosol-generating article 10.

The aerosol-generating article 10 has a length extending in the x-direction, a width extending in the y-direction and a thickness extending in the z-direction. The aerosol-generating article 10 has a length of 30 millimetres, a width of 10 millimetres, and a thickness of 3.1 millimetres.

The first planar external surface 21 and the second planar external surface 22 extend in the x-direction and the y-direction. That is, the first planar external surface 21 and the second planar external surface 22 extend in the x/y plane. The first planar external surface 21 is positioned parallel to the second planar external surface 22 and the first planar external surface 21 is spaced from the second planar external surface 22 in the z-direction or transverse direction. The distance between the first planar external surface 21 and the second planar external surface 22 in the z-direction or transverse direction corresponds to the thickness of the aerosol-generating article 10.

The aerosol-generating article 10 is substantially flat aerosol-generating article or substantially planar aerosol-generating article. In particular, the thickness of the aerosol-generating article 10 is less than 50 percent of both the length and the width of the aerosol-generating article. That is, the thickness is less than 15 millimetres (less than 50 percent of the length of the aerosol-generating article 10) and less than 5 millimetres (less than 50 percent of the width of the width of the aerosol-generating article 10). The aerosol-generating article 10 has a generally rectangular cuboid shape and a laminated structure formed by the first planar external layer 24, the frame 50 and the second planar external layer 25. The first planar external layer 24, the frame 50 and the second planar external layer 25 are bonded together with an adhesive, in particular guar gum, as discussed in more detail below in relation to FIG. 2.

FIG. 2 shows an exploded view of the aerosol-generating article 10 of FIG. 1.

The frame 50 has a length of 30 millimetres, a width of 10 millimetres, and a thickness of 2.7 millimetres. The frame 50 is made from cardboard and defines a frame aperture extending through the thickness of the frame 50. The frame aperture at least partially forms a cavity 30. The cavity 30 has length of 26 millimetres, a width of 6 millimetres, and a thickness of 2.7 millimetres. Therefore, the cavity 30 has a volume of about 421.2 cubic millimetres. In this embodiment, the cavity 30 is substantially empty.

The frame 50 has a frame inner surface 52 extending in the z-direction or the transverse direction between the first planar external surface 21 and the second planar external surface 22. The frame inner surface 52 defines a cavity outer wall. The frame 50 has a frame outer surface 53 extending in the z-direction or the transverse direction between the first planar external surface 21 and the second planar external surface 22. The frame outer surface 53 at least partially defines one or more external surfaces of the aerosol-generating article, such as the front wall 13 and the back wall 14. The frame outer surface 53 encircles, and is concentric with, the frame inner surface 52. Thus, the frame 50 has a cross-section in the x/y plane that is annular in shape, in particular the cross-section is a rectangular annulus shape.

The frame 50 comprises a peripheral wall 51 that circumscribes the cavity 30. In more detail, the peripheral wall 51 is defined by the frame inner surface 52 and the frame outer surface 52. The peripheral wall 51 has a radial thickness, as measured between the frame inner surface 52 and the frame outer surface 53 in the x/y plane, of about 2 millimetres.

The first planar external layer 24 and the second planar external layer 25 have a thickness of 200 micrometres and are in physical contact with the frame 50. The first planar external layer 24 and the second planar external layer 25 are bonded to the frame with an adhesive 15. The first planar external layer 24 overlies an end of the cavity 30 and forms a first cavity end wall 31. The second planar external layer 25 overlies an opposite end of the cavity 30 and forms a second cavity end wall 32. That is, the frame 50, the first planar external layer 24 and the second planar external layer 25 collectively define the cavity 30.

The air inlet 11 and the air outlet 12 are defined by, and extend through, the peripheral wall 51 of the frame 50. The air inlet 11 and the air outlet 12 each have a rectangular cross-section, a width of 2 millimetres, and a thickness of 0.9 millimetres. An airflow passage extends between the air inlet 11 and the air outlet 12 through the cavity 30.

The frame forms at least 95 percent of a perimeter of any cross-section, in an x/y plane, of the aerosol-generating article that extends through the frame. For example, the frame forms 100 percent of the perimeter of a cross-section, in an x/y plane, of the aerosol-generating article 10 taken between the first planar external layer 24 and the air outlet 12. On the other hand, the frame forms 95 percent of the perimeter of a cross-section, in an x/y plane, of the aerosol-generating article that extends through the air inlet 11 and the air outlet 12. This is because the perimeter of such a cross-section is formed by the frame, a width of the air inlet 11 and a width of the air outlet 12.

FIG. 3 shows an exploded view of an aerosol-generating article that is similar to the aerosol-generating article 10 of FIG. 1 except that the first planar external layer 24 and the second planar external layer 25 do not comprise an aerosol-generating substrate. Instead, an aerosol-generating substrate 40 is positioned within the cavity 30. The aerosol-generating substrate 40 comprises an aerosol-generating material in the form of tobacco cut filler and has an aerosol-former content of 5 percent by weight on a dry weight basis. As shown, the aerosol-generating substrate 40 fills the entire volume of the cavity 30. In the example of FIG. 3, the aerosol-generating substrate 40 has a packing density of about 0.87, a density of about 0.3 grams per cubic centimetre, and a mass of about 110 milligrams. In another example, the aerosol-generating substrate 40 may have a different packing density, a different density and a different mass. For example, aerosol-generating substrate may have a packing density of 0.64, a density of 0.35 grams per cubic centimetre, and a mass of about 95 milligrams.

FIGS. 4 and 5 show transverse and longitudinal cross-sectional views of the aerosol-generating article of FIG. 3, respectively.

FIG. 6 shows an exploded view of an aerosol-generating 10 that is similar to the aerosol-generating article 10 of FIG. 3 except that the aerosol-generating substrate 40 is in the form of a sheet of aerosol-generating material, in particular a corrugated sheet of homogenised tobacco material. FIGS. 7 and 8 show transverse and lateral cross-sectional views of the aerosol-generating article 10 of FIG. 6, respectively.

The corrugated sheet of homogenised tobacco material comprises a plurality of parallel corrugations having a plurality of substantially parallel peaks 43 and troughs 44. The plurality of parallel corrugations are defined by a corrugation profile which, as seen in FIG. 7, is sinusoidal. The plurality of parallel corrugations have a corrugation wavelength of about 0.92 millimetres. The corrugation amplitude is approximately the same as the thickness of the cavity, as shown by the peaks 43 and troughs 44 coinciding with the first cavity end wall 31 and the second cavity end wall 32, respectively.

The plurality of parallel corrugations form a plurality of channels 45 between the sheet of aerosol-generating material and the first cavity end wall 31, and a plurality of channels 46 between the sheet of aerosol-generating material and the second cavity end wall 32. The plurality of channels extend in a longitudinal direction of the aerosol-generating article 10 and form at least a portion of the airflow passage extending between the air inlet 11 and the air outlet 12.

FIG. 9 shows an aerosol-generating article 10 similar to the aerosol-generating article 10 of FIGS. 1, 3 and 6 except that the aerosol-generating article 10 of FIG. 9 comprises an outer wrapper 23 defining the first planar external surface 21 and the second planar external surface 22 instead of the first planar external layer 24 and the second planar external layer 25. FIG. 10 shows, for illustration purposes, the aerosol-generating article 10 of FIG. 9 in which the outer wrapper 23 has been unwrapped to expose a portion of the peripheral wall 51 of the frame 50. The outer wrapper 23 is cigarette paper.

FIG. 11 shows an aerosol-generating article 10 similar to the aerosol-generating article 10 of FIG. 1 except that the frame 50 of the aerosol-generating article 10 of FIG. 11 comprises a first frame layer 54 and a second frame layer 55. FIG. 12 shows an exploded view of the first planar external layer 24, the frame 50 and the second planar external layer 25 of the aerosol-generating article 10 of FIG. 11. FIG. 13 shows a yet further exploded view of the first planar external layer 24, the first frame layer 54, the second frame layer 55, and the second planar external layer 25 of the aerosol-generating article 10 of FIG. 11

The first planar external layer 24 is in physical contact with the first frame layer 54 and are bonded together with an adhesive 15. The first frame layer 54 is in physical contact with the second frame layer 55 and are bonded together with an adhesive 15. The second planar external layer 25 is in physical contact with the second frame layer 55 and are bonded together with an adhesive 15.

The aerosol-generating article 10 has the same dimensions as the aerosol-generating article 10 of FIG. 1. The frame 50 has the same dimensions as the frame 50 of FIG. 1. The thickness of the frame 50 is equal to the sum of the thickness of the first frame layer 54 and the second frame layer 55, which both have the same thickness. The air inlet 11 and air outlet 12 are formed by both the first frame layer 54 and the second frame layer 55.

FIG. 14 shows an aerosol-generating article 10 similar to the aerosol-generating article 10 of FIG. 1 except that the frame 50 of the aerosol-generating article 10 of FIG. 14 comprises a first frame layer 54, a second frame layer 55 and a third frame layer 56 positioned between the first frame layer 54 and the second frame layer 55. FIG. 15 shows an exploded view of the first planar external layer 24, the frame 50 and the second planar external layer 25 of the aerosol-generating article 10 of FIG. 14. FIG. 16 shows a yet further exploded view of the first planar external layer 24, the first frame layer 54, the second frame layer 55, the third frame layer 56 and the second planar external layer 25 of the aerosol-generating article 10 of FIG. 14.

The first planar external layer 24 is in physical contact with the first frame layer 54 and are bonded together with an adhesive 15. The first frame layer 54 is in physical contact with the second frame layer 55 and are bonded together with an adhesive 15. The second frame layer 55 is in physical contact with the third frame layer 56 and are bonded together with an adhesive 15. The second planar external layer 25 is in physical contact with the third frame layer 56 and are bonded together with an adhesive 15.

The aerosol-generating article 10 has the same dimensions as the aerosol-generating article 10 of FIG. 1. The frame 50 has the same dimensions as the frame 50 in FIG. 1. The thickness of the frame 50 is equal to the sum of the thickness of the first frame layer 54, the second frame layer 55 and the third frame layer 56. The air inlet 11 and air outlet 12 extend through the second frame layer 55.

FIG. 17 shows an aerosol-generating article 10 similar to the aerosol-generating article 10 of FIG. 1 except that the aerosol-generating article 10 of FIG. 17 further comprises a first aerosol-generating substrate layer 41 and a second aerosol-generating substrate layer 42. FIG. 18 shows an exploded view of the aerosol-generating article 10 of FIG. 17. The first aerosol-generating substrate layer 41 and the second aerosol-generating substrate layer 42 are formed from a sheet of aerosol-generating material. In particular, a sheet of homogenised tobacco material having an aerosol-former content of 5 percent by weight on a dry weight basis. The first aerosol-generating substrate layer 41 and the second aerosol-generating substrate layer 42 each have a length equal to the length of the aerosol-generating article 10, a width equal to the width of the aerosol-generating article 10 and a thickness of 200 micrometres. That is, the aerosol-generating article 10 has a length of 30 millimetres, a width of 10 millimetres, and a thickness of 3.5 millimetres.

The first aerosol-generating substrate layer 41 and the second aerosol-generating substrate layer 42 are in physical contact with the frame 50 and are bonded to the frame with an adhesive 15. The first aerosol-generating substrate layer 41 overlies an end of the cavity 30 and forms a first cavity end wall 31. The second aerosol-generating layer 42 overlies an opposite end of the cavity 30 and forms a second cavity end wall 32. That is, the frame 50, the first aerosol-generating substrate layer 41 and the second aerosol-generating substrate layer 42 collectively define the cavity 30.

The first planar external layer 24 is in physical contact with the first aerosol-generating substrate layer 41 and are bonded together with an adhesive 15. The second planar external layer 25 is in physical contact with the second aerosol-generating substrate layer 42 and are bonded together with an adhesive 15.

The frame 50 is depicted as a unitary component. However, the frame may be a two layer frame as shown in FIG. 11 or a three layer frame as shown in FIG. 14.

FIG. 19 shows an exploded view of an aerosol-generating article 10 that is similar to the aerosol-generating article 10 of FIG. 17 except that an aerosol-generating substrate 40 is positioned within the cavity 30 as described in relation to FIG. 3. The aerosol-generating substrate 40 comprises an aerosol-generating material in the form of tobacco cut filler and has an aerosol-former content of 5 percent by weight on a dry weight basis. As shown, the aerosol-generating substrate 40 fills the entire volume of the cavity 30.

FIG. 20 shows an exploded view of an aerosol-generating 10 that is similar to the aerosol-generating article 10 of FIG. 19 except that the aerosol-generating substrate 40 is in the form of a sheet of aerosol-generating material, in particular a corrugated sheet of homogenised tobacco material as described in relation to FIG. 6.

FIG. 21 shows an exploded view of an aerosol-generating article 10 that is similar to the aerosol-generating article 10 of FIG. 19 except that the aerosol-generating article 10 further comprises a filter element 60 positioned within the cavity 30.

The filter element 60 is positioned immediately upstream of the air outlet 12. The filter element 60 is made from cellulose acetate. The filter element 60 has a thickness and a width approximately the same as the thickness and width of the cavity 30, respectively. The filter element 60 has a length of about 6 millimetres. The aerosol-generating substrate 40 fills the remaining volume of the cavity 30.

FIG. 22 shows an aerosol-generating article 10 that is similar to the aerosol-generating article 10 of FIG. 1 except that the aerosol-generating article 10 of FIG. 22 comprises a first cavity 33 and a second cavity 34. FIG. 23 shows an exploded view of the aerosol-generating article 10 of FIG. 22.

The first cavity 33 is substantially empty and the second cavity 34 is substantially empty. The first cavity 33 has length of 12 millimetres, a width of 6 millimetres, and a thickness of 2.7 millimetres. The second cavity 34 has length of 12 millimetres, a width of 6 millimetres, and a thickness of 2.7 millimetres.

The frame 50 defines a frame first aperture extending through the thickness of the frame 50 and the frame first aperture at least partially forms the first cavity 33. The frame 50 defines a frame second aperture extending through the thickness of the frame 50 and the frame second aperture at least partially forms the second cavity 34.

The frame 50 comprises dividing wall 57 which separates the first cavity 33 and the second cavity 34. The dividing wall 59 defines an aperture extending from the first cavity 33 to the second cavity 34. The aperture of the dividing wall 59 defines at least a portion of the airflow passage between the air inlet 11 and the air outlet 12.

The first planar external layer 24 overlies an end of the first cavity 33 and the second planar external layer 25 overlies an opposite end of the first cavity 33. That is, the frame 50, the first planar external layer 24 and the second planar external layer 25 collectively define the first cavity 33. The first planar external layer 24 overlies an end of the second cavity 34 and the second planar external layer 25 overlies an opposite end of the second cavity 34. That is, the frame 50, the first planar external layer 24 and the second planar external layer 25 collectively define the second cavity 34.

FIG. 24 shows an exploded view of an aerosol-generating article 10 that is similar to the aerosol-generating article 10 of FIG. 22 except that a first cavity aerosol-generating substrate 45 is positioned within the first cavity 33 and a second cavity aerosol-generating substrate 46 is positioned within the second cavity 34.

The first cavity aerosol-generating substrate 45 comprises an aerosol-generating material in the form of tobacco cut filler and has an aerosol-former content of 5 percent by weight on a dry weight basis. The first cavity aerosol-generating substrate 45 fills the entire volume of the first cavity 33. The second cavity aerosol-generating substrate 46 comprises an aerosol-generating material in the form of tobacco cut filler and has an aerosol-former content of 5 percent by weight on a dry weight basis. The second cavity aerosol-generating substrate 46 fills the entire volume of the second cavity 34. FIG. 25 shows an exploded view of an aerosol-generating article 10 that is similar to the aerosol-generating article 10 of FIG. 24 except that the first cavity aerosol-generating substrate 45 is in the form of a sheet of aerosol-generating material, in particular a corrugated sheet of homogenised tobacco material, and the second cavity aerosol-generating substrate 46 is in the form of a sheet of aerosol-generating material, in particular a corrugated sheet of homogenised tobacco material.

FIG. 26 shows an exploded view of an aerosol-generating article 10 that is similar to the aerosol-generating article 10 of FIG. 22 except that a first cavity aerosol-generating substrate 45 is positioned within the first cavity 33, a filter element 60 is positioned within the first cavity 33, and a second cavity aerosol-generating substrate 46 is positioned within the second cavity 34.

The filter element 60 is positioned immediately upstream of the air outlet 12. The filter element is made from cellulose acetate. The filter element 60 has a thickness and a width approximately the same as the thickness and width of the first cavity 33, respectively. The filter element 60 has a length of about 4 millimetres.

The first cavity aerosol-generating substrate 45 comprises an aerosol-generating material in the form of tobacco cut filler and has an aerosol-former content of 5 percent by weight on a dry weight basis. The first cavity aerosol-generating substrate 45 fills the remaining volume of the first cavity 33. The second cavity aerosol-generating substrate 46 is identical to the second cavity aerosol-generating substrate 46 described in relation to FIG. 25.

FIG. 27 shows an exploded view of an aerosol-generating article 10 that is similar to the aerosol-generating article 10 of FIG. 22 except that a filter element 60 is positioned within the air outlet 12 and a second cavity aerosol-generating substrate 46 is positioned within the second cavity 34. The filter element 60 is made from cellulose acetate and has the same dimensions as the air outlet 12. The first cavity 33 is empty. The second cavity aerosol-generating substrate 46 is identical to the second cavity aerosol-generating substrate 46 described in relation to FIG. 24.

FIG. 28 shows an exploded view of an aerosol-generating article 10 that is similar to the aerosol-generating article 10 of FIG. 22 except that the aerosol-generating article 10 further comprises a first aerosol-generating substrate layer 41 and a second aerosol-generating substrate layer 42 as described in relation to 17.

The first aerosol-generating substrate layer 41 and the second aerosol-generating substrate layer 42 are formed from a sheet of aerosol-generating material. In particular, a sheet of homogenised tobacco material having an aerosol-former content of 5 percent by weight on a dry weight basis. The first aerosol-generating substrate layer 41 and the second aerosol-generating substrate layer 42 each have a length equal to the length of the aerosol-generating article 10, a width equal to the width of the aerosol-generating article 10 and a thickness of 200 micrometres. That is, the aerosol-generating article 10 has a length of 30 millimetres, a width of 10 millimetres, and a thickness of 3.5 millimetres.

The first aerosol-generating substrate layer 41 and the second aerosol-generating substrate layer 42 are in physical contact with the frame 50 and are bonded to the frame with an adhesive 15. The first aerosol-generating substrate layer 41 overlies an end of the first cavity 33 and the second aerosol-generating substrate layer 42 overlies an opposite end of the first cavity 33. That is, the frame 50, the first aerosol-generating substrate layer 41 and the second aerosol-generating substrate layer 42 collectively define the first cavity 33. The first aerosol-generating substrate layer 41 overlies an end of the second cavity 34 and the second aerosol-generating substrate layer 42 overlies an opposite end of the second cavity 34. That is, the frame 50, the first aerosol-generating substrate layer 41 and the second aerosol-generating substrate layer 42 collectively define the second cavity 34.

FIG. 29 shows an exploded view of an aerosol-generating article 10 similar to the aerosol-generating article 10 of FIG. 28 except that a first cavity aerosol-generating substrate 45 is positioned within the first cavity 33 and a second cavity aerosol-generating substrate 46 is positioned within the second cavity 34.

The first cavity aerosol-generating substrate 45 comprises an aerosol-generating material in the form of tobacco cut filler and has an aerosol-former content of 5 percent by weight on a dry weight basis. The first cavity aerosol-generating substrate 45 fills the entire volume of the first cavity 33. The second cavity aerosol-generating substrate 46 comprises an aerosol-generating material in the form of tobacco cut filler and has an aerosol-former content of 5 percent by weight on a dry weight basis. The second cavity aerosol-generating substrate 46 fills the entire volume of the second cavity 34.

FIG. 30 shows an aerosol-generating article 10 similar to the aerosol-generating article 10 of FIGS. 17 and 28 except that the aerosol-generating article 10 of FIG. 30 comprises an outer wrapper 23 defining the first planar external surface 21 and the second planar external surface 22 instead of the first planar external layer 24 and the second planar external layer 25. FIG. 31 shows, for illustration purposes, the aerosol-generating article 10 of FIG. 30 in which the outer wrapper 23 has been unwrapped to expose a portion of the peripheral wall 51 of the frame 50. The outer wrapper 23 is cigarette paper.

FIG. 32 shows an aerosol-generating article 10 similar to the aerosol-generating article 10 of FIG. 1 except that the aerosol-generating article 10 of FIG. 32 comprises a first external corner 71 and a second external corner 72 that are rounded. However, it would be understood that one or both of the first external corner 71 and the second external corner 72 could be chamfered. FIGS. 33 and 34 show a plan view and an exploded view of the aerosol-generating article 10 of FIG. 32, respectively.

The first external corner 71 extends from the first planar external surface 21 to the second planar external surface 22 and comprises a first corner surface 76 connecting a first end face 73 of the aerosol-generating article 10 and a first side face 74 of the aerosol-generating article 10. In more detail, the first end face 73 connects to the first corner surface 76 at a first corner transition region 82. A first corner internal angle 01 formed between a tangent 81 of the first end face 73 at the first corner transition region 82 and a tangent 83 of the first corner surface 76 at the first corner transition region 82 is between 90 degrees and 180 degrees.

The second external corner 72 extends from the first planar external surface 21 to the second planar external surface 22 and comprises a second corner surface 77 connecting the first end face 73 of the aerosol-generating article 10 and a second side face 75 of the aerosol-generating article 10. In more detail, the first end face 73 connects to the second corner surface 77 at a second corner transition region 85. A second corner internal angle 02 formed between a tangent 84 of the first end face 73 at the second corner transition region 85 and a tangent 86 of the second corner surface 77 at the second corner transition region 85 is between 90 degrees and 180 degrees.

FIG. 35 shows a cross-sectional view in the x/y plane of the aerosol-generating article 10 of FIG. 32 taken through the intersection between the first planar external layer 24 and the frame 50. The cavity 30 comprises a first corner 35, a second corner 36, a third corner 37 and a fourth corner 38 which each extend in the z-direction and are rounded.

FIG. 36 shows an exploded view of an aerosol-generating article that is similar to the aerosol-generating article 10 of FIG. 32 except that an aerosol-generating substrate 40 is positioned within the cavity 30. The aerosol-generating substrate 40 comprises an aerosol-generating material in the form of tobacco cut filler and has an aerosol-former content of 5 percent by weight on a dry weight basis. The aerosol-generating substrate 40 fills the entire volume of the cavity 30. In other embodiments, the aerosol-generating substrate 40 is in the form of a sheet of aerosol-generating material, in particular a corrugated sheet of homogenised tobacco material, as described in relation to FIG. 6.

FIG. 37 shows an aerosol-generating article 10 similar to the aerosol-generating article 10 of FIGS. 32 and 36 except that the aerosol-generating article 10 of FIG. 37 further comprises a first aerosol-generating substrate layer 41 and a second aerosol-generating substrate layer 42 as described in relation to FIG. 17.

FIG. 38 shows an aerosol-generating article 10 similar to the aerosol-generating article 10 of FIG. 1 except that the air inlet 11 is defined by the first planar external surface 21 and extends through the first planar external layer 24.

FIG. 39 shows an aerosol-generating article 10 similar to the aerosol-generating article 10 of FIG. 9 except that the air inlet 11 is defined by the first planar external surface 21 and extends through the outer wrapper 23.

FIG. 40 shows an aerosol-generating article 10 similar to the aerosol-generating article 10 of FIG. 17 except that the air inlet 11 is defined by the first planar external surface 21 and extends through the first planar external layer 24 and the first aerosol-generating substrate layer 41.

FIG. 41 shows a schematic cross-sectional view of an aerosol-generating device 90 configured for use with an aerosol-generating article 10 described herein. The aerosol-generating device 90 is an elongate aerosol-generating device extending between a proximal end 91 and a distal end 92. The aerosol-generating device 90 comprises a battery 93, a controller 94, a first heater 95 and a second heater 96 located within a housing 97. The controller 94 controls supply of power from the battery 93 to the first heater 95 and the second heater 96. A cavity 1000 is defined in the device 90, the cavity 1000 having an opening 1010 defined in the proximal end 91 of the device 90. The opening 1010 is rectangular in shape and is dimensioned to accommodate the transverse cross-section of the aerosol-generating article 10. The cavity 1000 comprises an upper planar surface 1020 and a lower planar surface 1030. The first heater 95 is located in the upper planar surface 1020 to heat the first planar external surface 21 of an aerosol-generating article 10 inserted into the cavity 1000, and the second heater 96 is located in the lower planar surface 1030 to heat the second planar external surface 22 of an aerosol-generating article 10 inserted into the cavity 1000. The device 90 comprises an air inlet 98 defining an air-flow path configured to allow air to flow into the cavity 1000 from outside the device.

FIG. 42 shows a schematic cross-sectional view of the aerosol-generating device 90 of FIG. 41 in engagement with the aerosol-generating article 10 of FIG. 1. There is little tolerance between the first planar external surface 21 and the second planar external surface 22 of the aerosol-generating article 10 and the internal surfaces 1020, 1030 of the cavity 1000. Thus, there is a snug fit between the aerosol-generating article 10 and the aerosol-generating device 90. When a consumer has inserted the aerosol-generating article 10 into the cavity 1000, the device can be operated. The first heater 95 heats the first planar external surface 21 of the aerosol-generating article 10 and the second heater 96 heats the second planar external surface 22 of the aerosol-generating article, and as a result the aerosol-generating substrate is heated. Volatile components of the aerosol-generating substrate are evaporated and condense in the cavity 30 of the aerosol-generating article 10 to form an aerosol. The consumer inhales the aerosol by drawing on the end of the aerosol-generating article 10 comprising the air outlet 12. Once the aerosol-generating substrate has been depleted of volatile components, the aerosol-generating article 10 is removed from the cavity 1000 and disposed of.

FIG. 43 depicts a schematic illustration of a method of manufacturing 1100 an aerosol-generating article 10 as described herein and, in particular, a method of manufacturing the aerosol-generating article 10 of FIG. 3. The method comprises punching and bonding a first sheet of frame material 1201, a first sheet of external layer material 1301 and a second sheet of external layer material 1302. FIG. 44 depicts a schematic plan view of the method of FIG. 43 but for illustration purposes the manufacturing equipment is not depicted. The dotted line 1101 in FIG. 44 is for illustration purposes and represents the eventual cross-sectional perimeter of the aerosol-generating article 10.

The first sheet of frame material 1201 is fed from a bobbin 1102 between a first pair of rollers 1103 and a second pair of rollers 1104. An aperture punching device 1105 punches a frame aperture 1400 through the first sheet of frame material 1201. The frame aperture 1400 will at least partially form the cavity 30 of the aerosol-generating article 10. An adhesive applying device 1106 applies an adhesive to a lower surface of the first sheet of frame material 1201. The first sheet of external layer material 1301 is fed from a bobbin 1102 via a roller 1107 and is bonded to the first sheet of frame material 1201 by the adhesive applied to the lower surface of the first sheet of frame material 1201. An aerosol-generating substrate dispensing device 1108 dispenses an aerosol-generating substrate 40 into the frame aperture 1400. An adhesive applying device 1109 applies an adhesive 1110 to an upper surface of the first sheet of frame material 1201. The second sheet of external layer material 1302 is fed from a bobbin 1102 via a roller 1107 and is bonded to the first sheet of frame material 1201 by the adhesive 1110 applied to the upper surface of the first sheet of frame material 1201. An aperture punching device 1111 punches an aperture 1410 through the first sheet of frame material 1201, the first sheet of external layer material 1301 and the second sheet of external layer material 1302 so as to eject an aerosol-generating article 10. The air inlet and air outlet may be formed before or after the aerosol-generating article 10 has been ejected.

In some embodiments, one or more of the first sheet of frame material 1201, the first sheet of external layer material 1301 and the second sheet of external layer material 1302 comprises an aerosol-generating substrate. Thus, the step of dispensing an aerosol-generating substrate 40 into the frame aperture 1400 may be skipped.

FIG. 45 depicts a schematic illustration of a method of manufacturing 1100 an aerosol-generating article 10 as described herein and, in particular, a method of manufacturing the aerosol-generating article 10 of FIG. 17. The method comprises punching and bonding a first sheet of frame material 1201, a first sheet of aerosol-generating material 1501, a second sheet of aerosol-generating material 1502, a first sheet of external layer material 1301 and a second sheet of external layer material 1302. FIG. 46 depicts a schematic plan view of the method of FIG. 45 but for illustration purposes the manufacturing equipment is not depicted. The dotted line 1101 in FIG. 46 is for illustration purposes and represents the eventual cross-sectional perimeter of the aerosol-generating article 10.

The first sheet of frame material 1201 fed from a bobbin 1102 between a first pair of rollers 1103 and a second pair of rollers 1104. An aperture punching device 1105 punches a frame aperture 1400 through the first sheet of frame material 1201. The frame aperture 1400 will at least partially form the cavity 30 of the aerosol-generating article 10.

An adhesive applying device 1106 applies an adhesive 1110 to a lower surface of the first sheet of frame material 1201 and to an upper surface of the first sheet of frame material 1201.

The first sheet of aerosol-generating material 1501 is fed from a bobbin 1102 via a roller 1107 and is bonded to the first sheet of frame material 1201 by the adhesive applied to the lower surface of the first sheet of frame material 1201. The second sheet of aerosol-generating material 1502 is fed from a bobbin 1102 via a roller 1107 and is bonded to the first sheet of frame material 1201 by the adhesive 1110 applied to the upper surface of the first sheet of frame material 1201.

An adhesive applying device 1109 applies an adhesive 1110 to a lower surface of the first sheet of aerosol-generating material 1501 and to an upper surface of the second sheet of aerosol-generating material 1502.

The first sheet of external layer material 1301 is fed from a bobbin 1102 via a roller 1107 and is bonded to the first sheet of aerosol-generating material 1501 by the adhesive applied to the lower surface of the first sheet of aerosol-generating material 1501. The second sheet of external layer material 1302 is fed from a bobbin 1102 via a roller 1107 and is bonded to the second sheet of aerosol-generating material 1502 by the adhesive 1110 applied to the upper surface of the second sheet of aerosol-generating material 1502.

An aperture punching device 1111 punches an aperture 1410 through the first sheet of frame material 1201, the first sheet of aerosol-generating material 1501, the second sheet of aerosol-generating material 1502, the first sheet of external layer material 1301 and the second sheet of external layer material 1302 so as to eject the aerosol-generating article 10. The air inlet and air outlet may be formed before or after the aerosol-generating article 10 has been ejected.

FIG. 47 depicts a schematic illustration of a method of manufacturing 1100 an aerosol-generating article 10 as described herein and, in particular, a method of manufacturing the aerosol-generating article 10 of FIG. 11 comprising an aerosol-generating substrate 40 positioned within the cavity 30. The method comprises punching and bonding a first sheet of frame material 1201, a second sheet of frame material 1202, a first sheet of external layer material 1301 and a second sheet of external layer material 1302. FIG. 48 depicts a schematic plan view of the method of FIG. 47 but for illustration purposes the manufacturing equipment is not depicted. The dotted line 1101 in FIG. 48 is for illustration purposes and represents the eventual cross-sectional perimeter of the aerosol-generating article 10.

The first sheet of frame material 1201 is fed from a bobbin 1102 between a first pair of rollers 1103 and a second pair of rollers 1104. An adhesive applying device 1106 applies an adhesive 1110 to an upper surface of the first sheet of frame material 1201. The second sheet of frame material 1202 is fed from a bobbin 1102 via a roller 1107 and is bonded to the first sheet of frame material 1201 by the adhesive 1110 applied to the upper surface of the first sheet of frame material 1201.

An aperture punching device 1105 punches a frame aperture 1400 through the first sheet of frame material 1201 and the second sheet of frame material 1202. The frame aperture 1400 will at least partially form the cavity 30 of the aerosol-generating article 10.

An adhesive applying device 1106 applies an adhesive to a lower surface of the first sheet of frame material 1201. The first sheet of external layer material 1301 is fed from a bobbin 1102 via a roller 1107 and is bonded to the first sheet of frame material 1201 by the adhesive applied to the lower surface of the first sheet of frame material 1201.

An aerosol-generating substrate dispensing device 1108 dispenses an aerosol-generating substrate 40 into the frame aperture 40. An adhesive applying device 1109 applies an adhesive 1110 to an upper surface of the second sheet of frame material 1202. The second sheet of external layer material 1302 is fed from a bobbin 1102 via a roller 1107 and is bonded to the second sheet of frame material 1202 by the adhesive 1110 applied to the upper surface of the second sheet of frame material 1202.

An aperture punching device 1111 punches an aperture 1410 through the first sheet of frame material 1201, the second sheet of frame material 1202, the first sheet of external layer material 1301 and the second sheet of external layer material 1302 so as to eject an aerosol-generating article 10. The air inlet and air outlet may be formed before or after the aerosol-generating article 10 has been ejected.

In some embodiments, one or more of the first sheet of frame material 1201, the second sheet of frame material 1202, the first sheet of external layer material 1301 and the second sheet of external layer material 1302 comprises an aerosol-generating substrate. Thus, the step of dispensing an aerosol-generating substrate 40 into the frame aperture 1400 may be skipped.

FIG. 49 depicts a schematic illustration of a method of manufacturing 1100 an aerosol-generating article 10 as described herein and, in particular, a method of manufacturing the aerosol-generating article 10 of FIG. 14 comprising an aerosol-generating substrate 40 positioned within the cavity 30. The method comprises punching and bonding a first sheet of frame material 1201, a second sheet of frame material 1202, a third sheet of frame material 1203, a first sheet of external layer material 1301 and a second sheet of external layer material 1302. FIG. 50 depicts a schematic plan view of the method of FIG. 49 but for illustration purposes the manufacturing equipment is not depicted. The dotted line 1101 in FIG. 50 is for illustration purposes and represents the eventual cross-sectional perimeter of the aerosol-generating article 10.

The first sheet of frame material 1201 is fed from a bobbin 1102 between a first pair of rollers 1103 and a second pair of rollers 1104. An aperture punching device 1112 punches an air inlet aperture 1610 and an air outlet aperture 1620 through the first sheet of frame material 1201.

An adhesive applying device 1106 applies an adhesive 1110 to a lower surface of the first sheet of frame material 1201 and to an upper surface of the first sheet of frame material 1201.

The second sheet of frame material 1202 is fed from a bobbin 1102 via a roller 1107 and is bonded to the first sheet of frame material 1201 by the adhesive applied to the lower surface of the first sheet of frame material 1201. The third sheet of frame material 1203 is fed from a bobbin 1102 via a roller 1102 and is bonded to the first sheet of frame material 1201 by the adhesive 1110 applied to the upper surface of the first sheet of frame material 1201.

An aperture punching device 1105 punches a frame aperture 1400 through the first sheet of frame material 1201, the second sheet of frame material 1202 and the third sheet of frame material 1203. The frame aperture will at least partially form the cavity 30 of the aerosol-generating article 10.

An adhesive applying device 1106 applies an adhesive to a lower surface of the second sheet of frame material 1202. The first sheet of external layer material 1301 is fed from a bobbin 1102 via a roller 1107 and is bonded to the second sheet of frame material 1202 by the adhesive applied to the lower surface of the second sheet of frame material 1202.

An aerosol-generating substrate dispensing device 1108 dispenses an aerosol-generating substrate 40 into the frame aperture 1400. An adhesive applying device 1109 applies an adhesive 1110 to an upper surface of the third sheet of frame material 1203. The second sheet of external layer material 1302 is fed from a bobbin 1102 via a roller 1107 and is bonded to the third sheet of frame material 1203 by the adhesive 1110 applied to the upper surface of the third sheet of frame material 1203.

An aperture punching machine 1111 punches an aperture 1410 through the first sheet of frame material 1201, the second sheet of frame material 1202, the third sheet of frame material 1203, the first sheet of external layer material 1301 and the second sheet of external layer material 1302 so as to eject the aerosol-generating article 10.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±10% of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-15. (canceled)

16. An aerosol-generating article for an aerosol-generating device to generate an aerosol, the aerosol-generating article comprising:
a first planar external surface;
a second planar external surface;
a cavity;
a frame positioned between the first planar external surface and the second planar external surface, the frame at least partially defining the cavity; and
one or more aerosol-generating substrates,
wherein at least one of the one or more aerosol-generating substrates has a mass of less than or equal to 500 milligrams, and
wherein the frame is made from paper, paperboard, or cardboard.

17. The aerosol-generating article according to claim 16, wherein the at least one of the one or more aerosol-generating substrates has a mass of less than or equal to 400 milligrams.

18. The aerosol-generating article according to claim 16, wherein the at least one of the one or more aerosol-generating substrates has a mass of between 50 milligrams and 500 milligrams.

19. The aerosol-generating article according to claim 18, wherein the at least one of the one or more aerosol-generating substrate has a mass of between 80 milligrams and 250 milligrams.

20. The aerosol-generating article according to claim 16, wherein the at least one of the one or more aerosol-generating substrates comprises an aerosol-generating substrate positioned within the cavity.

21. The aerosol-generating article according to claim 20, wherein the aerosol-generating substrate positioned within the cavity comprises tobacco cut filler.

22. The aerosol-generating article according to claim 20, wherein the aerosol-generating substrate positioned within the cavity has a mass of between 80 milligrams and 250 milligrams.

23. The aerosol-generating article according to claim 22, wherein the aerosol-generating substrate positioned within the cavity has a mass of between 80 milligrams and 200 milligrams.

24. The aerosol-generating article according to claim 16, wherein the one or more aerosol-generating substrates comprises a first aerosol-generating substrate layer positioned between the first planar external surface and the frame, and a second aerosol-generating substrate layer positioned between the second planar external surface and the frame.

25. The aerosol-generating article according to claim 24, wherein the first aerosol-generating substrate layer is a sheet of aerosol-generating material and the second aerosol-generating substrate layer is a sheet of aerosol-generating material.

26. The aerosol-generating article according to claim 24, wherein the first aerosol-generating substrate layer has a mass between 80 milligrams and 250 milligrams and the second aerosol-generating substrate layer has a mass between 80 milligrams and 250 milligrams.

27. The aerosol-generating article according to claim 26, wherein the first aerosol-generating substrate layer has a mass between 80 milligrams and 150 milligrams and the second aerosol-generating substrate layer has a mass between 80 milligrams and 150 milligrams.

28. The aerosol-generating article according to claim 16, further comprising a first planar external layer and a second planar external layer, wherein the first planar external layer defines the first planar external surface and the second planar external layer defines the second planar external surface.

29. The aerosol-generating article according to claim 16, wherein a thickness of the aerosol-generating article is less than 50 percent of both a length and a width of the aerosol-generating article.
